(19) United States
(12) Patent Application Publication
(10) Pub. No.: US 2004/0023191 A1
(43) Pub. Date: Feb. 5, 2004

(54) Adaptive instructional process and system to facilitate oral and written language comprehension

(76) Inventors: Carolyn J. Brown, Iowa City, IA (US); Jerry N. Zimmermann, Iowa City, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 10/090,532

(22) Filed: Mar. 4, 2002

Related U.S. Application Data
(60) Provisional application No. 60/273,154, filed on Mar. 2, 2001.

(51) Int. Cl. G09B 19/00

(52) U.S. Cl. 434/156

(57) ABSTRACT

The interactive, adaptive system (10) and method presented in this application promotes and supports the acquisition of language skills and facilitates the transfer of oral language to the written symbolic system. A developmental model drives the rules that systematically assess and inform instructional progression at the individual student level. The framework for the developmental model has the logical elements of curricular structure, skill level and auditory visual support level. Progression through the curriculum is dynamically determined depending on an individual's level of perception and performance.

### 1 BACKGROUND OF THE INVENTION

1.1 Field of the Invention

This invention relates to methods of instruction, and in particular, to methods of computerized instruction related to language and reading.

The comprehension of oral and written language depends on the student's ability to understand, recall, integrate and generalize the information that is heard or read. There are many developmental stages in the process of learning to comprehend spoken and printed language. A student's level of competency at each stage of the developmental process and the strategies he/she uses to comprehend information are often very difficult to assess. Even though the assessment is difficult, it is crucial to know what each student perceives and to know what strategies are most effective for an individual student to translate the meaning and the structure of oral language to print.

1.2 Problems in the Art

The affects of deficiencies in literacy on both individuals and the greater society can be substantial. Real problems exist because of deficiencies in oral and written language skills. Some reports estimate up to 40% of fourth grade students in the United States have deficient literacy skills.

As individual students make the transition from comprehending oral language to comprehending print, different experiences are necessary to support the individual learner. An ideal learning environment would provide individualized instruction that adapted to each student's learning strategies, provided unlimited explorations and the support necessary for each student to be successful at each stage of development. The problem is that in the traditional classroom milieu in which most students learn to read, such daily individualized instruction is not possible. Many children are failing to learn to read because they lack critical language and print experiences upon entry to school and do not have the foundations necessary to successfully transition from one developmental stage to the next. Many children, who may or may not have foundational skills, are failing to learn to read because of poor instructional practices. Students most at risk are those who lack critical foundations in language development and print experiences and who also have poor instruction. Early literacy development is acknowledged as one of the most serious problems in education today in the United States.

Language skills and progress with the same are difficult to assess. It is difficult to know what each student needs to progress. It is also difficult to know what strategies to invoke for different students. Existing methods do not seem to adequately address these difficulties, especially with respect to individualized shaping of development learning tools and approaches, which in turn allow good assessment of the progress of the student and what works best for each student.

Waterford Institute and Scientific Learning Corporation are companies which each produces interactive educational software for the explicit purpose of improving language and reading skills. Neither one incorporates an integrated approach nor do they use progression rules that are driven by a comprehensive developmental model that incorporates language units, skill and auditory visual support requirements. Neither of these approaches have rules to adjust progression based on providing the necessary support for a student to successfully complete a given level of the curriculum in which skill and auditory visual support are dynamically controlled by the student's performance.

As students acquire the skills necessary to transfer their understanding and use of oral language to the symbolic system of written text, it is imperative that the students are able to explore, manipulate and construct the parts and the meaning of oral and written language. This process must be internalized before generalization can occur. Success with the process of learning to read and write is critical to students' educational progress.

Students who come with different learning styles or strategies and/or students who have limited experience with oral and written language are at risk for learning to read and write in classrooms in which traditional instructional methods are employed.

It is not enough to expose students to a systematic curriculum. They must have success and confidence. They must be working at their developmental level.

### 2 SUMMARY OF THE INVENTION

2.1 Resolution of Problems in the Art

The underlying developmental model in the present invention, which integrates progressive curriculum, stages of perception, skill levels and auditory visual support, provides a method of instruction that supports all learners. This software application is not another electronic worksheet or activity book. This application provides students the opportunity to perceive the language and its parts at the appropriate developmental level. This facilitates the integration and internalization of the structure and meaning of language in both the oral and written expression.

While the process of learning language and learning to read occurs in a social, communicative context, the learner must progress individually through developmental stages. The use of technology, when appropriately designed and implemented, can serve as a unique and effective tool to provide individualized instruction. The components incorporated into the present invention, each address different types and stages of development in the reading process. By integrating these essential instructional practices into one application, the student is supported at the instructional level necessary to make successful transitions at each stage of development. The system informs the teacher about each student's developmental level, progression and use of learning strategies. Additionally, the assessment of performance in one component informs instruction in other components. Each of the targeted components is aligned with the best predictors for reading comprehension. The integrated system includes the curricular structure and activities, support systems and progression rules that provide individual instruction in at least the following areas:

a) comprehension of connected discourse;

b) acquisition of vocabulary knowledge;

c) acquisition of specific skills and knowledge necessary to facilitate perception of the structural elements of language;

d) understanding sound to symbol mapping; and

e) acquisition of skills and knowledge necessary to facilitate production of the structural elements of language, mapping sound to symbol representation in print.

The interactive, adaptive software presented in this application promotes and supports the acquisition of language skills and facilitates the transfer of oral language to the written symbolic system. A developmental model drives the rules that systematically assess and inform instructional progression at the individual student level. The framework for the developmental model has the logical elements of curricular structure, skill level and auditory visual support level. Progression through the curriculum is dynamically determined depending on an individual's level of perception and performance.

2.2 Fundamental Differences From Other Methods

Fundamental differences of aspects of the invention are:

(a) The rules driving progression through the curriculum of the software are driven by a performance criterion that is different from other applications. Rather than assuming progress through the curriculum should be determined by “mastery” of given concepts by a performance standard (e.g., percent correct), the level of support necessary for a student to attain success at a given level of the curriculum drives the progression through the curriculum.

(b) Movement through the curriculum continues at the skill and language level that the student can perceive and perform.

(c) The information transfer between components within the software to drive either placement or experiences within another component allow the system to integrate the decoding, structural strategies and the meaning-based strategies most appropriate for a given student.

(d) The information transfer between the software components drives placement or experiences within another component to integrate the perception and production of language units.

A proposed use for the software is as an instructional and assessment tool for use in classrooms or by individuals. The tool is developed to be integrated into the daily classroom instruction but can be used in other contexts. Each student has individual computer time (preferably daily) and the preferred implementation requires that four essential instructional practices be incorporated into the daily schedule. These four practices link to the four primary components of the software that are designed to facilitate the four best predictors of reading comprehension.

### 3 BRIEF DESCRIPTION OF THE DRAWINGS

FIG. 1 is a diagrammatic illustration of a system according to an exemplary embodiment of the invention.

FIGS. 2.1-2.14 are flow charts, annotated screen shots, and other supporting materials for Specification A, as further discussed below.

FIGS. 3.1-3.9.2 are flow charts, annotated screen shots, and other supporting materials for Specification B, as further discussed below.

FIGS. 4.1-4.12 are flow charts, annotated screen shots, and other supporting materials for Specification C, as further discussed below.

FIGS. 5.1-5.13 are flow charts, annotated screen shots, and other supporting materials for Specification D, as further discussed below.

FIGS. 6.1-6.20 are flow charts, annotated screen shots, and other supporting materials for Specification E, as further discussed below.

FIGS. 7.1-7.2 are flow charts, annotated screen shots, and other supporting materials for Specification F, as further discussed below.

FIGS. 8.1.1-8.4.2 is illustrative example of a database structure useful with the exemplary embodiment of the invention (see also Specification G).

### 4 DESCRIPTION OF EXEMPLARY EMBODIMENT(S) ACCORDING TO THE INVENTION

4.1 Overview

To assist in a better understanding of the invention, an exemplary embodiment according the invention will now be described in detail. It is to be understood that this embodiment is but one example of the forms the invention can take, and is not exclusive.

This embodiment will be discussed in the context of an interactive multimedia computer based learning system, particularly dedicated to teaching of language arts, including oral and written language skills for elementary age children. Other learning applications and age groups are possible.

4.2 Index of Illustrative Specifications

Frequent reference will be taken to the following illustrative detailed specifications (hereinafter sometimes called “specs”), which relate to the following subject matter respectively:

| | |
|---|---|
| Spec A | Story Activity Specification; |
| Spec B | Explore Words; |
| Spec C | Alphabet Specification; |
| Spec D | Teacher Application—Enroll as Related to Stories; |
| Spec E | Teacher Application—Reports as Related to Stories; |
| Spec F | Entry and Exit Sequences Specification; |
| Spec G | Database Structure. |

These specs provide more illustrative detail regarding aspects of how the exemplary embodiment can be put into practice.

4.3 Background/General Environment

Interactive learning software, known as Breakthrough to Literacy, Version 4.11., originally named Foundations in Reading and currently available commercially from Breakthrough to Literacy, Inc., of Coralville, Iowa, has several literacy learning activities. U.S. Pat. Nos. 6,186,794 and 6,206,700, issued to Breakthrough to Literacy, Inc., and incorporated by reference herein in their entirety, relate to the interactive rules and process embedded in the activities.

The embodiment of the present invention adds several activities to Version 4.11, including the foundational activities of “Listen to Stories”, “Explore Words”, “Explore Alphabet” and “Tell Stories”. U.S. Pat. Nos. 6,186,794 and 6,206,700 continue to relate to the interactive rules and process embedded in the “Explore Words” activity. Several versions of the product are sold to different grade levels. The different grade levels are differentiated by the books in the “Listen to Stories” and “Tell Stories” activities. “Explore Words”, representing a developmental model inclusive of approximately ages four to seven, remains intact in each grade version. “Explore Alphabet” has been extended and now also represents a developmental span and will remain intact in each grade version.

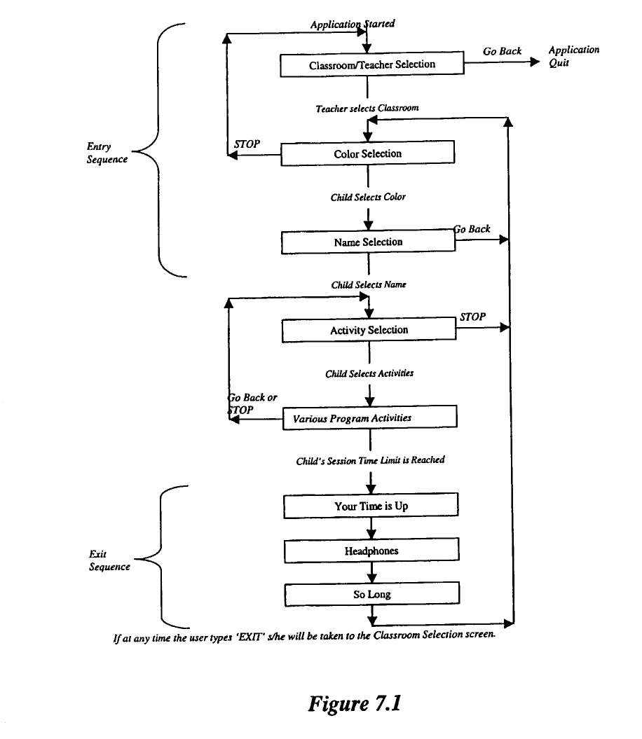

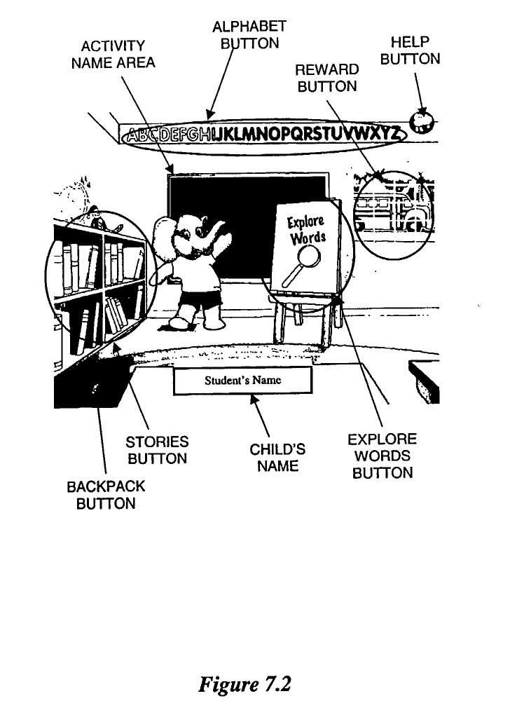

These new activities or extensions of activities, according to an embodiment of the present invention, will be contained under a new version of the software e.g. Breakthrough to Literacy, Version 6.0. Specs A-C relate to new activities Version 6.0 has a student application and a teacher application. The following instructional/assessment activities are available for the student: Stories (see Spec A), Explore Words (see Spec B), Explore Alphabet (see Spec C). There is also a motivational, reward activity for the student (See e.g. Spec. F, ¶¶ 438-439, and FIG. 7.2). Within the teacher application are the following components: Enroll (see Spec D), Reports (see Spec E), Transfer and Specials; Entry and Exit Sequence (Spec. F, FIG. 7.1). Version 6.0 is an enhanced version of the basic application Version 4.11 into which can be incorporated the features and methods of the present application, which will now be described in one embodiment.

4.4 Software Overview/Database Structure

4.4.1 Generally

The present invention contemplates numerous variations as to the particular type of hardware and software used to implement the learning system. The following example is provided to give one method of implementing the system, but the present invention contemplates that the software may be developed with any number of tools and for any type of computer system such as a particular environment may suggest, or such as may otherwise be convenient or expedient.

The system, in this embodiment, is designed in a manner conducive to cross platform development and deployment. Both Microsoft Windows-based computers and Apple MacOS-based computers are prevalent in schools and other educational environments. Therefore, using cross-platform development tools permits software to be created that can be used with either type of operating system. For example, the software can be written in C/C++ and can be compiled on an Apple MacOS computer using CodeWarrior. The software can also be compiled for a Microsoft Windows operating system using Microsoft Visual C/C++. In addition, the software can be written in JAVA or other language suitable for cross-platform use.

The present invention contemplates that numerous development tools may be available on either or both platforms to quicken the development process or otherwise improve the development process. For example, library files or other frameworks may be used. One such example of a framework is the proprietary framework developed by ImageBuilder Software of Portland, Oreg. One skilled in the art are familiar with similar tools or be accustomed to other tools that may speed the development process.

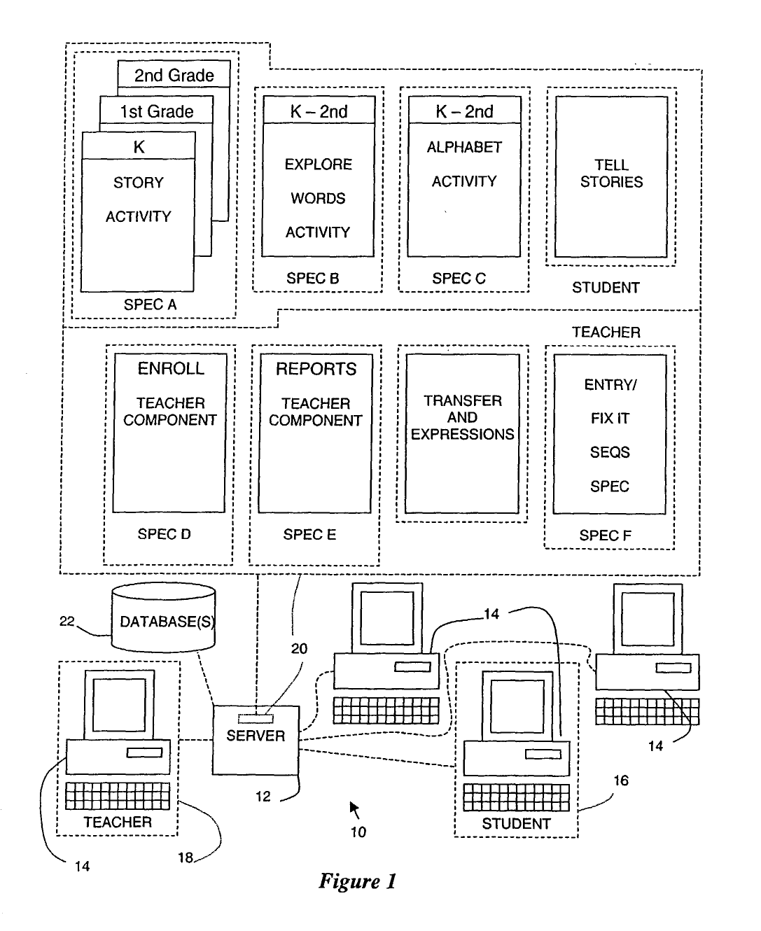

FIG. 1 illustrates at a high level a system (generally indicated at reference number 10) that uses software (generally indicated at reference number 20) according to the present invention. Software 20 could be loaded on a central computer 12 (“sever”) and be accessible by multiple users from multiple computers 14. Database(s) 22 could be accessible by software 20. Database(s) 22 could have pre-loaded indexed digital information. Examples are test, pictures, and audio files. Students 16 could access the software 20 (it can be password protected) through a computer 14 (e.g. PC) and conduct a learning activity or skill level. Data related to a student's session could be stored in a database 22. Teachers or tutors 18 could optionally access the student's work to monitor or assess it. The assessment could be used for such things as to change or direct the activities or curriculum of the student, or the level at which the student is working. Some of the pertinent parts or components of the software are also illustrated at FIG. 1. Some relationships between certain of these parts or components and the specifications are noted.

4.4.2 Student Software

The student software is that portion of the software that a student may access and run. The student software has the capabilities of providing multimedia content. For example, the student software may play audio content and show pictorial content, as well as textual content. The present invention contemplates that other types of multimedia or sensory content may also be used.

The construction and organization of the student software may vary according to the particular development tools convenient to a particular person. One such organization of the student software is to maintain one database for each type of content, have a database for results of monitoring/testing of students, and have an executable program that interacts with the databases. In this particular implementation, there may be a database of multimedia audio, one or more scripted stories (the scripted stories including comprehension questions), and a database of pictorial content. Each scripted story may be compiled. The scripted stories make references to particular pictures in the pictorial database and audio in the audio database. The executable program then calls the scripted stories, to show the story and accompanying multimedia and comprehension questions in the order and manner required by the script. Using scripts to facilitate the creation of the stories simplifies the process of creating the software as the code associated with the executable program does not need to be recomplied for each story, only the story scripts need to be re-compiled for different stories. The present invention contemplates that numerous other methods of reducing development time may be used, such as may be known in the art.

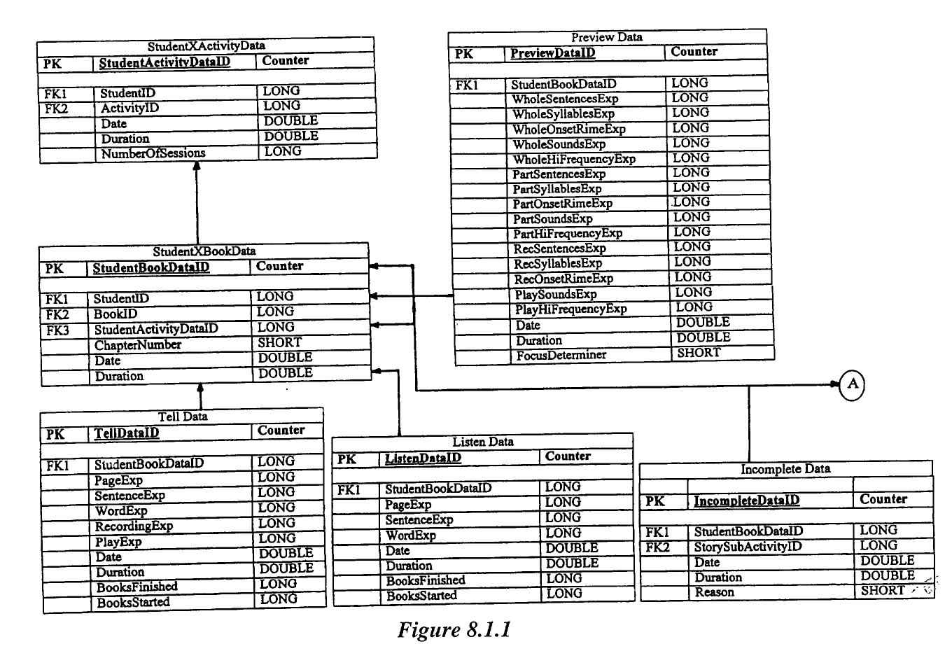

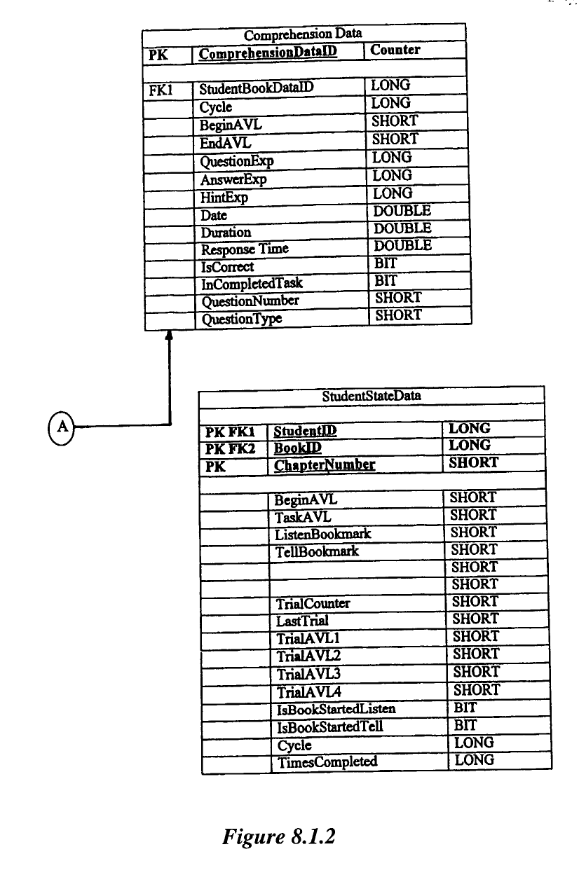

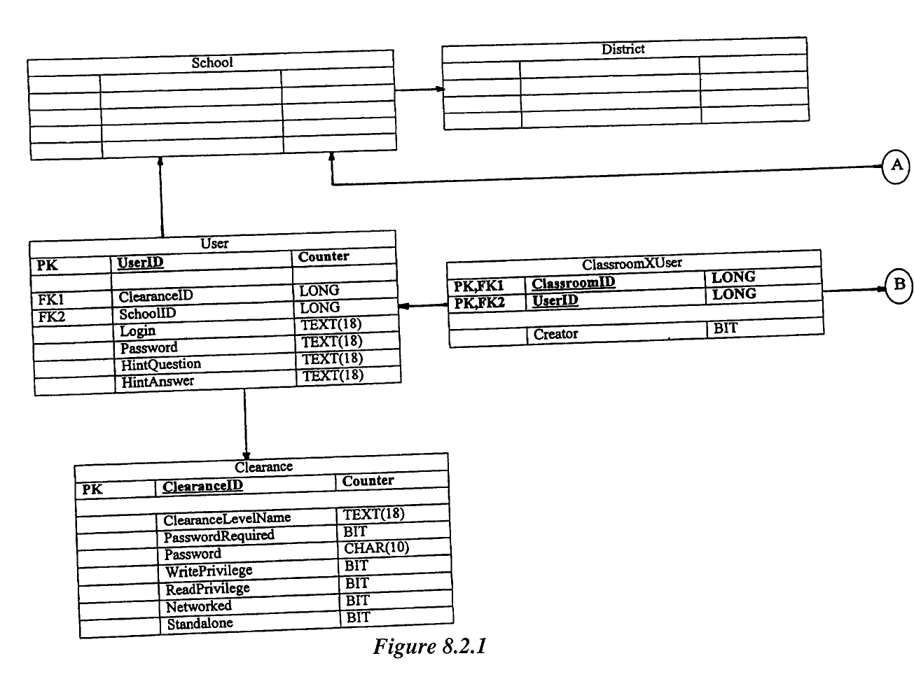

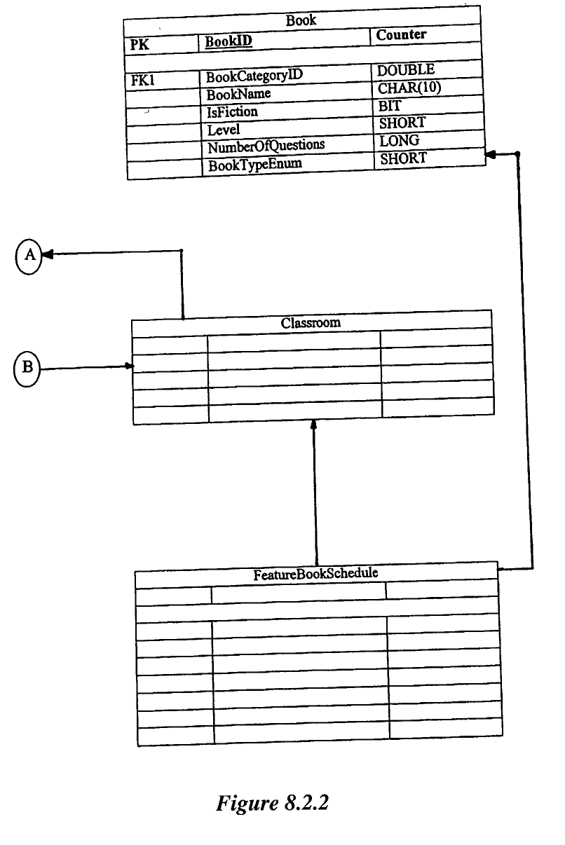

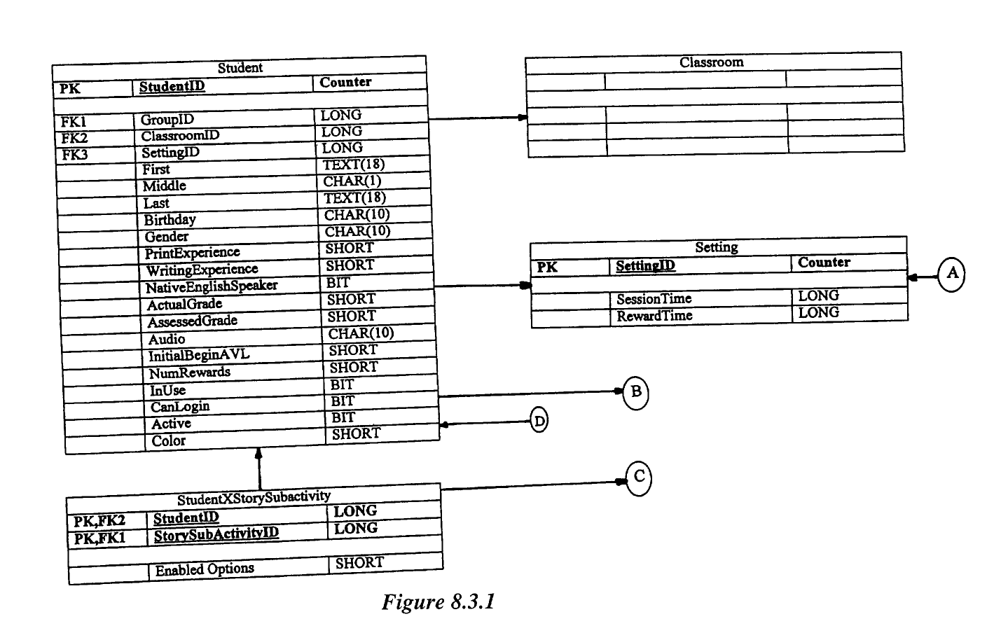

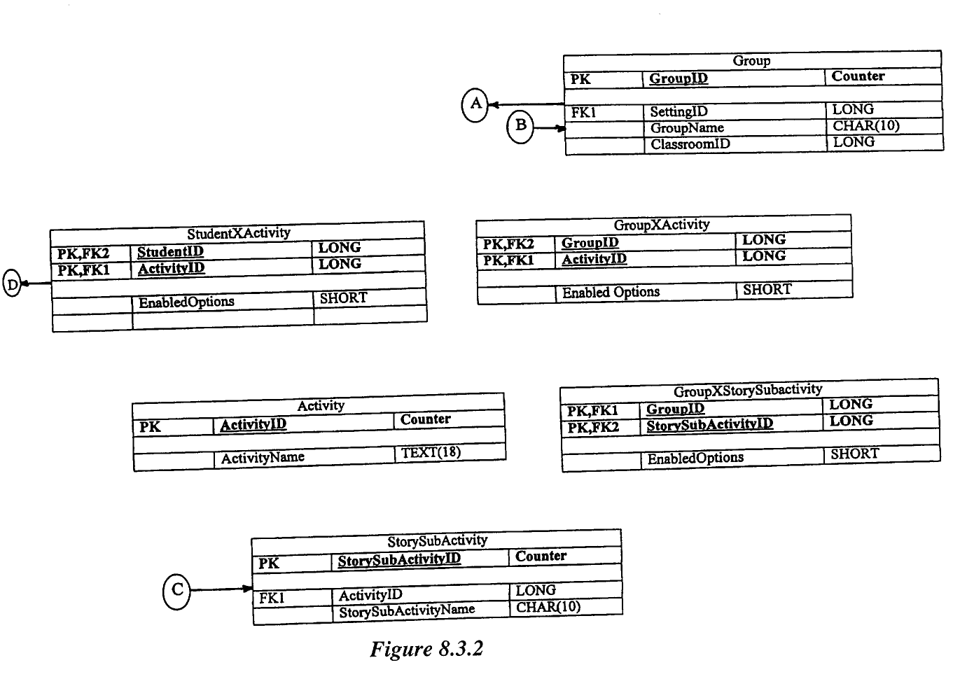

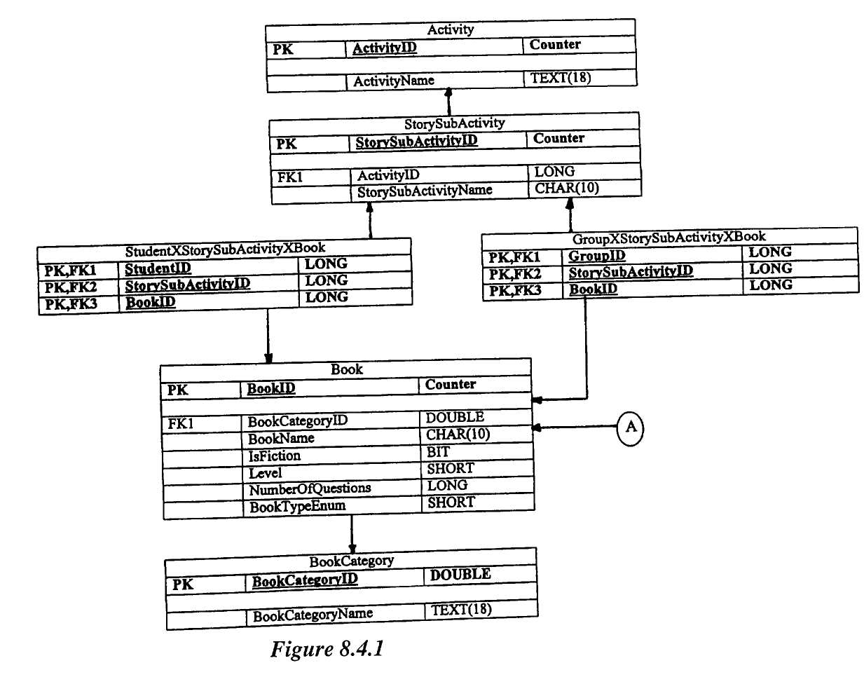

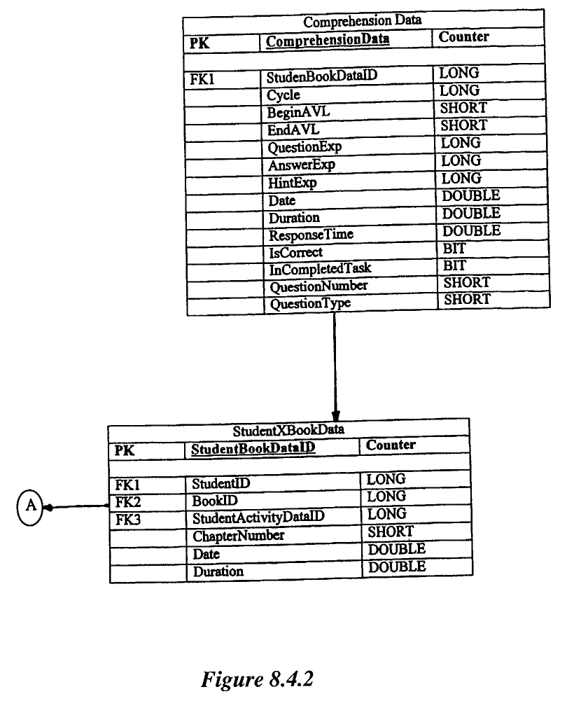

The executable program also is capable of storing information related to a particular student's use of the software. For example, in the comprehension component, this information includes, the number of times a student has been asked a particular question, the time spent on the question, the response time on the question, the beginning level associated with the student when the question was asked, the ending level associated with the student when the question was completed. In addition, this information may include the number of times the student accessed the hint associated with the question, the number of times the student requested additional information associated with the question, and the number of times the student requested additional information associated with the answer. This information may be stored in a comprehension data table, one example of which is shown at FIGS. 8.1.1 to 8.4.2 with further description at Spec G. The database may contain other information such as is shown in the database documentation of Spec G. This information may include identification information associated with the student, and student settings such as password and related information. Additional data from components other than Stories will also be included. For Example, in the Explore Words component, information recorded may include, the number of times a student repeats a question, the number of times the student requests picture, auditory and/or text information for the whole utterance for either the question or the responses, the number of times the student requests picture, auditory and/or text information for the parts of an utterance for either the question or the responses, the amount of time the student spends on a trial, the beginning and ending levels associated with the student for each question/trial, the number of responses the student had to choose between, and the skill and details about the curriculum content for the lesson the student is working on. The executable program may access the database through ODBC or JDBC data connectivity or other method or standard such as may be convenient or expedient or otherwise suggested by a particular use or environment.

4.4.3 Teacher Application

The teacher application is also written in a computer language or with a software development tool that is conducive to creating software for multiple platforms. For example, the teacher application may be written in JAVA. The teacher application may provide the teacher with the ability to create reports related to a student or group of students. The teacher application may also allow a teacher to change the levels associated with a student, or the lessons or stories that may be accessed by the student. The teacher application is also capable of accessing the database shown in Spec G in order to create reports or monitor a student. When written in JAVA, the teacher application may use the JDBC type of database connectivity to access the database, or other type of connectivity such as may be convenient or expedient or otherwise suggested by a particular use or environment.

4.5 Interaction of Student with Software Application

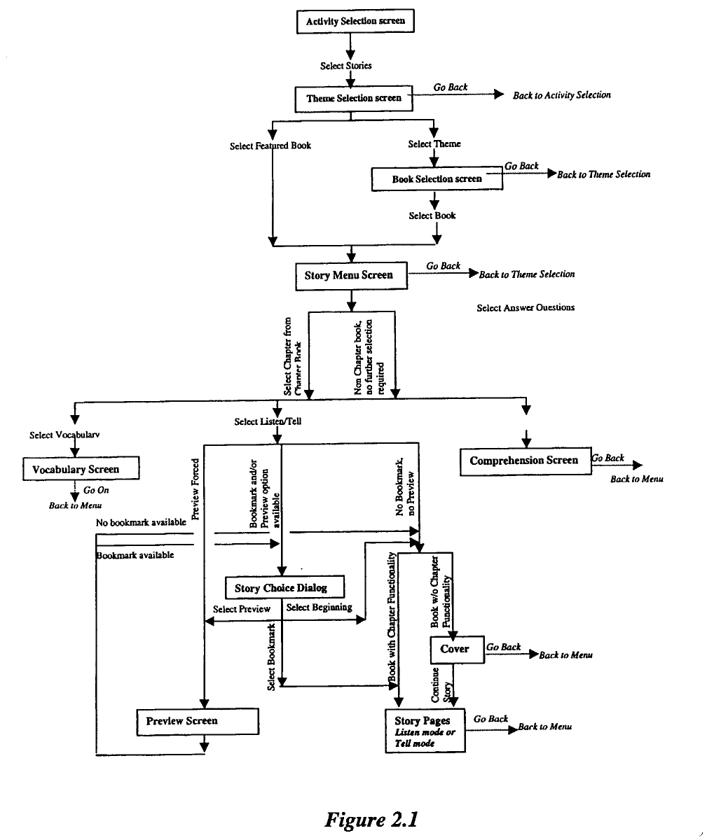

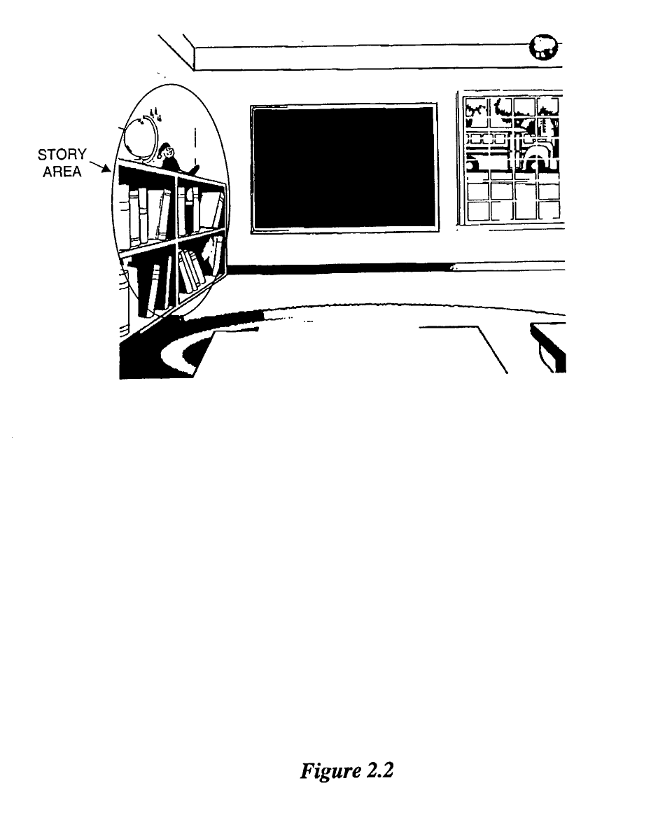

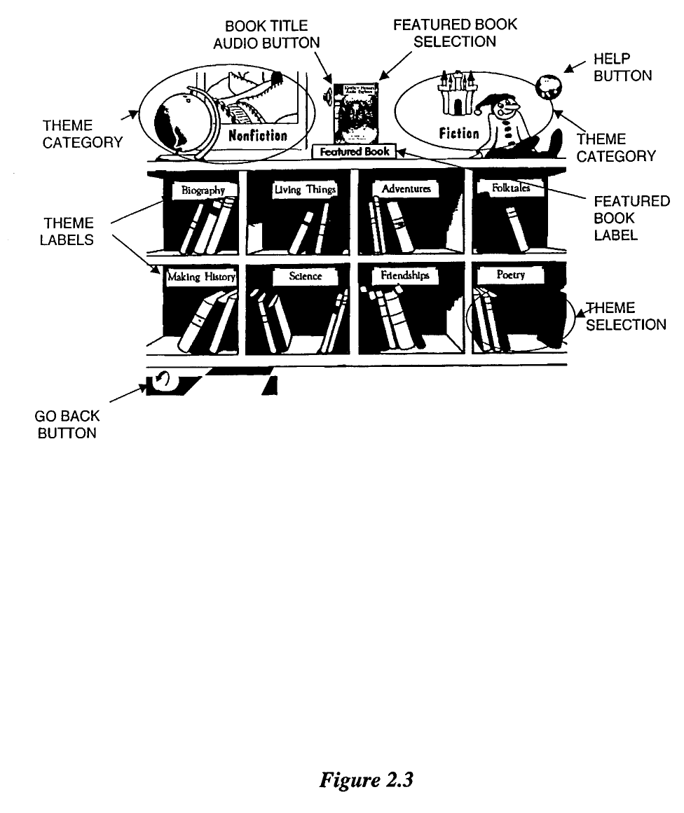

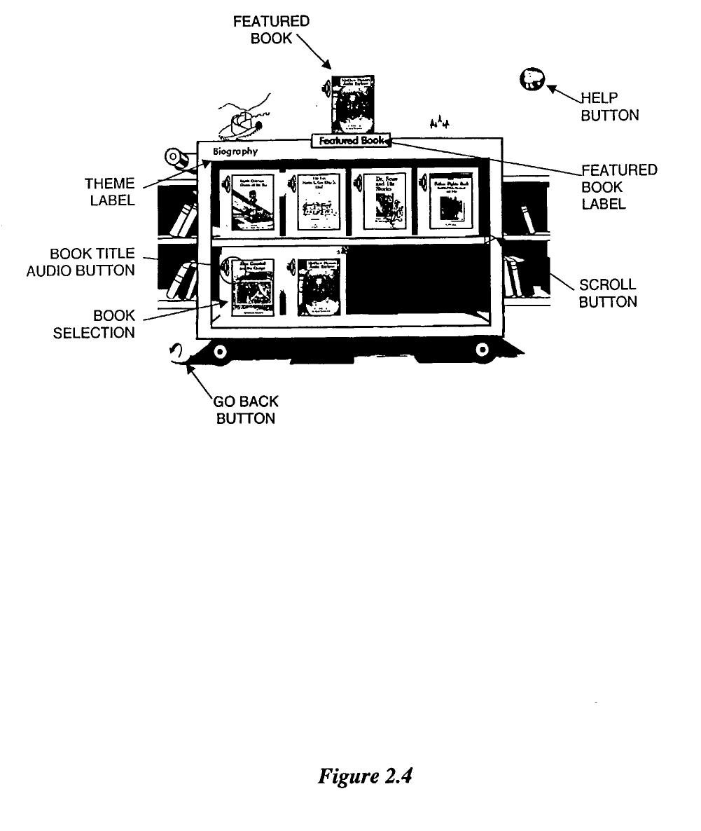

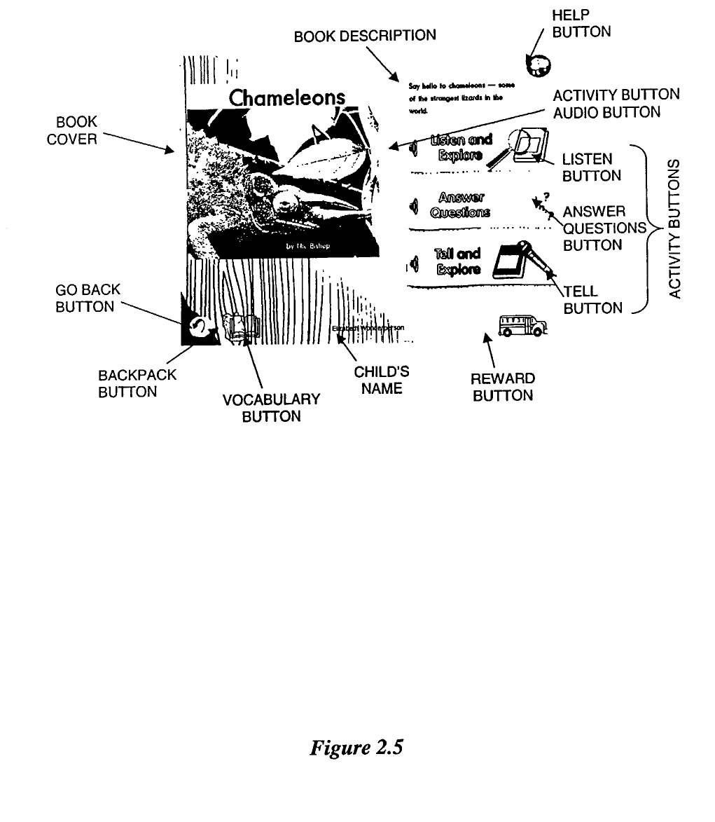

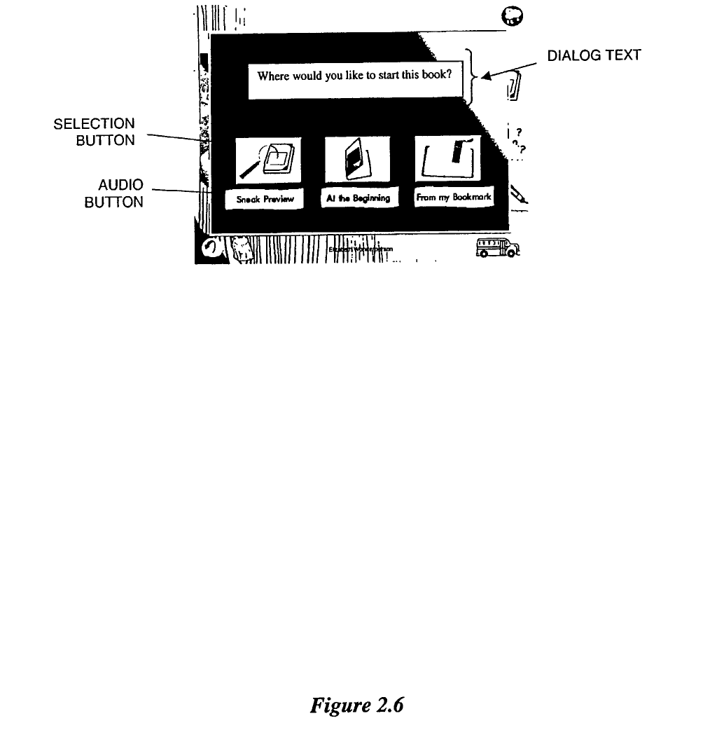

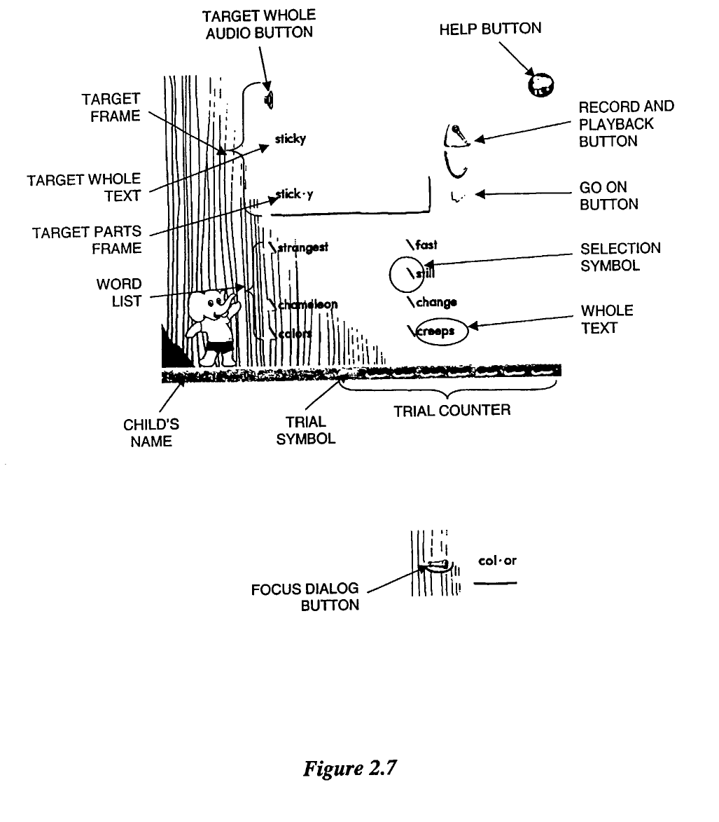

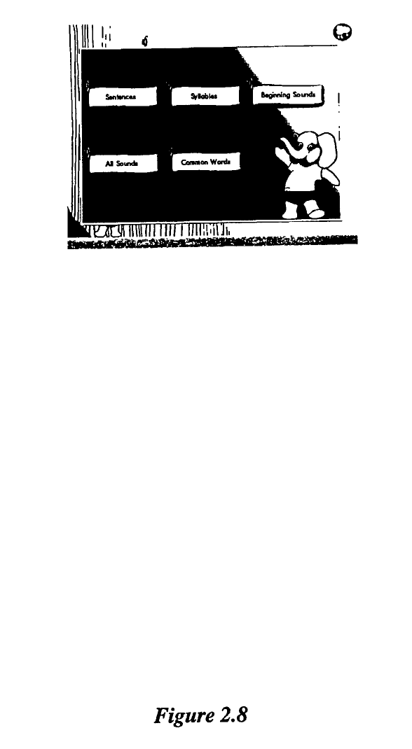

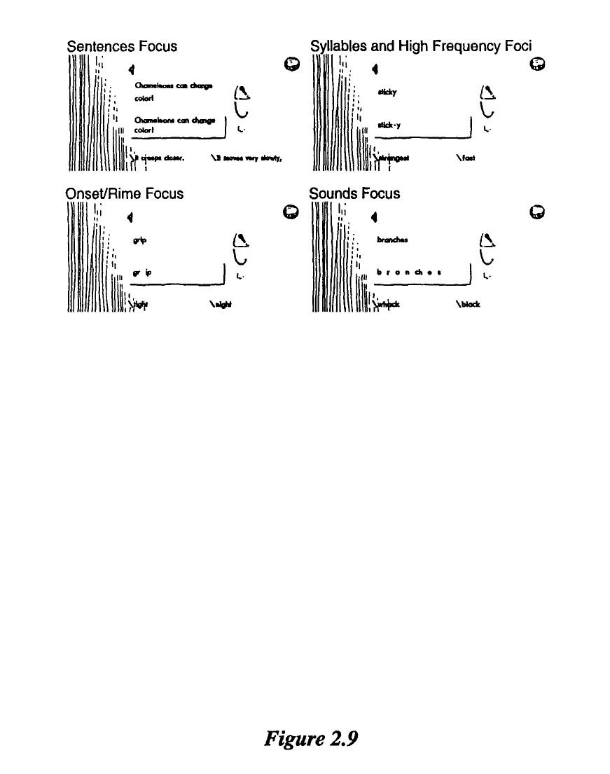

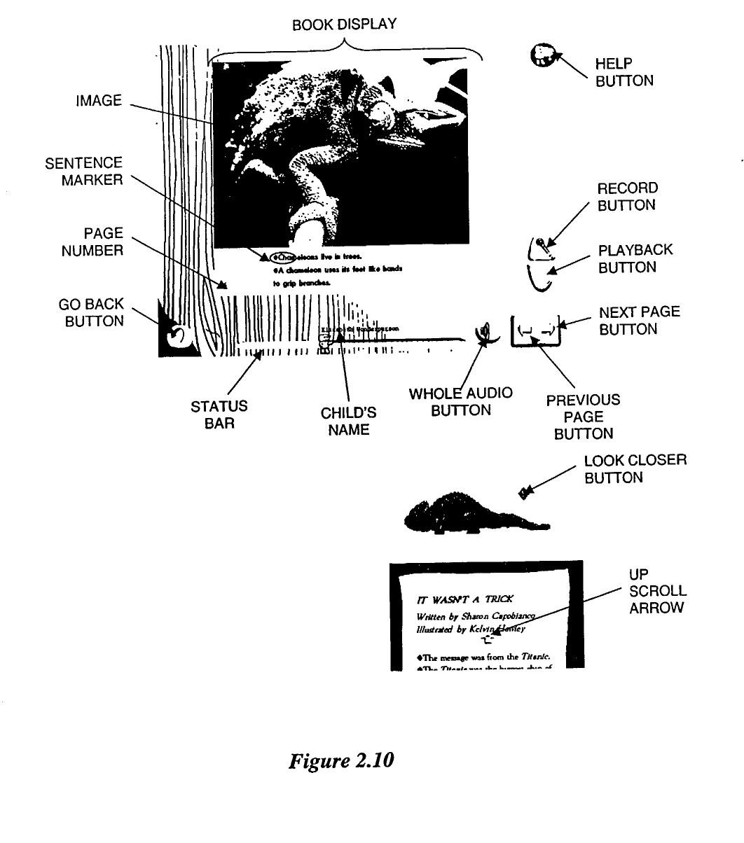

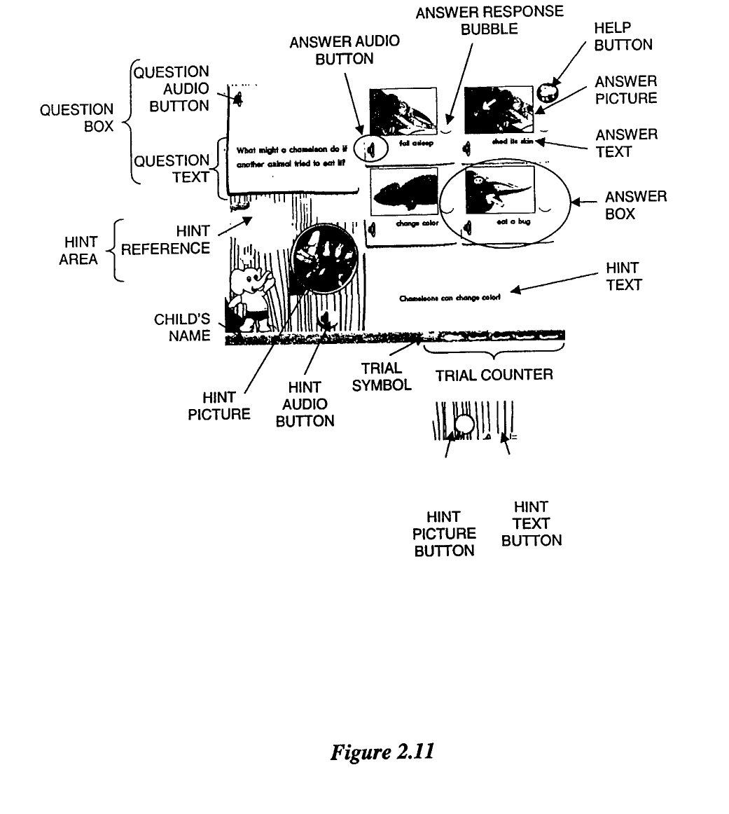

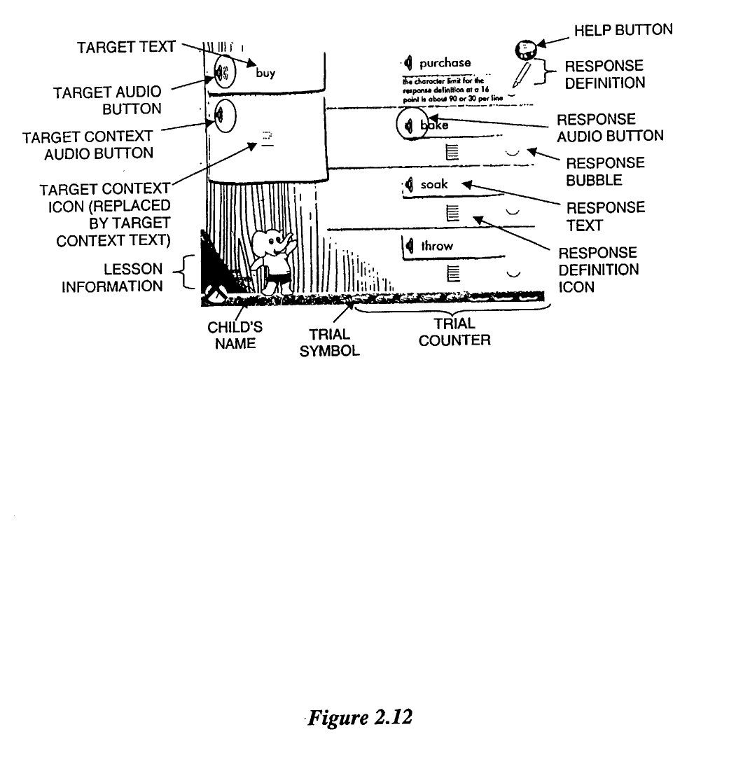

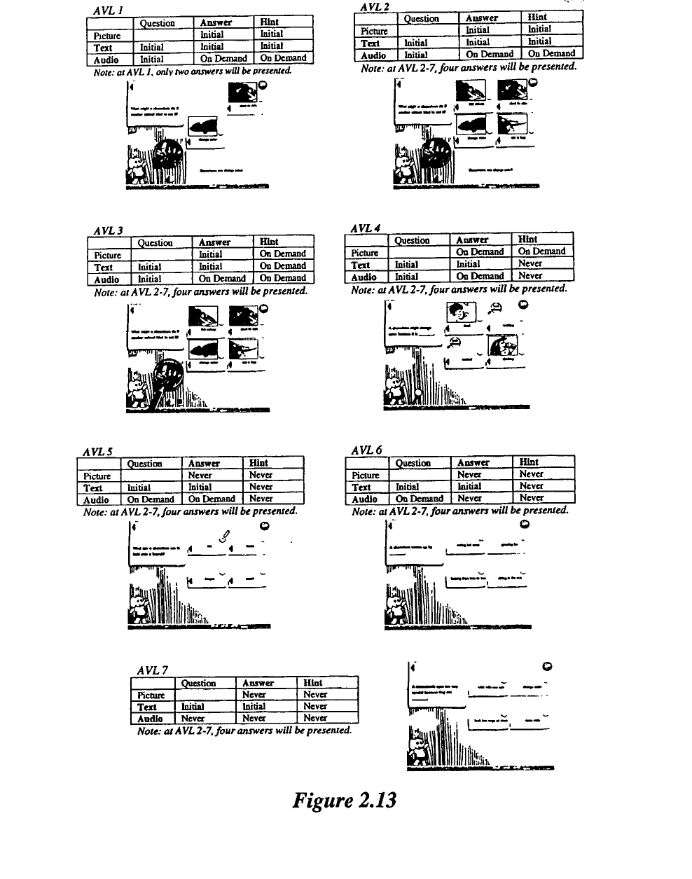

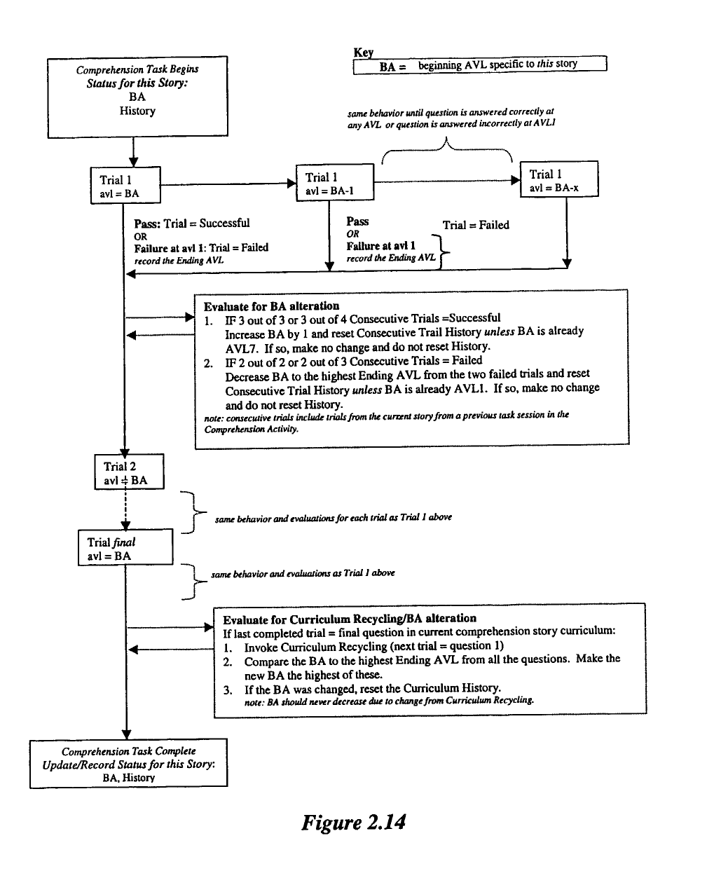

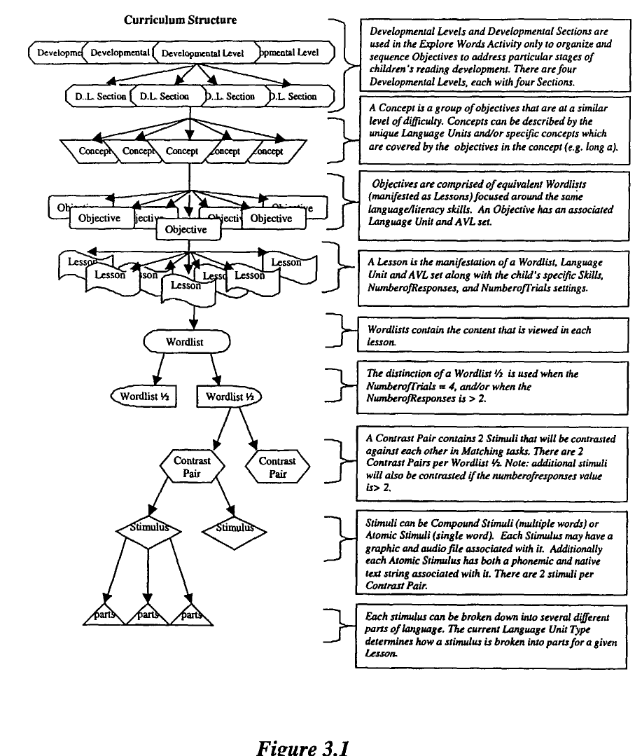

Each student interacts individually with the computer screen by listening through headphones or through a speaker and manipulating a mouse to make selections. A flow chart of the navigation through screens is shown at FIG. 2.1 for the Story Activity Specification (see Spec A, ¶ 64). The first screen that the student sees is the Color Select screen. The student navigates through the Color Select screen (selection of appropriate color of backpack) and Name Select screen to get to the Activity Select Screen (see Entry Sequence at FIG. 7.1 and Spec. F). Based on time in the system or teacher choice, the student will have access to certain activities. By clicking the bookshelf, the student will have access to the Story Activity. By clicking the easel (See Spec F, and FIG. 7.1, if available), the student will have access to the Explore Words Activity (see Spec B). By the clicking the alphabet frieze (FIG. 7.1, if available), the student will have access to the Explore Alphabet Activity (see Spec C). Examples of these activities are described in detail in Specs A-C. Further description is provided below.

4.5.1 Child (Student) Application:

### Story Activities (see Spec A)

### Standard Features of Interactive Story Books

The student can select either Nonfiction or Fiction categories from the library shelves depicted (Theme Select Screen, FIG. 2.1). The books available in that category are depicted on the library cart (Story Select Screen, FIGS. 2.2 to 2.4.). The child may also select a “feature book” selected for the class by the teacher. The student selects the desired book to initiate the Story Menu Screen. Within “Listen and Explore” and “Tell and Explore” activities, the student is able to listen to stories, record speech, and interact with text. A student can hear the book read aloud, page forward and backward, request that fall pages be re-read, repeat individual sentences and words and record spoken language. Functionality is shown in the Story Activity Specification (Spec A)

### Unique Features

Several aspects of the Stories Activities present special features and are found in the sub-activities labeled, “Answer Questions” (Comprehension), “Preview” and “Vocabulary”. These sub-activities appear on the Story Menu Screen or within the menu choice for Listen or Tell Stories after certain requirements have been met by the student for the selected book. (See Spec A, e.g. ¶¶ 72-73 (e.g. includes definition of #oftimesread value), ¶¶ 112 and FIG. 2.5 (shows menu with Answer Questions and Vocabulary options pictured), ¶ 127-128 and FIG. 2.11 (describes when Comprehension is available—broadly), and FIG. 2.12 (describes when Vocabulary is available) of the Story Activity Specification).

4.5.2 Comprehension of Connected Discourse

The purpose of the “Answer Questions” activity is to assess and facilitate the comprehension of connected discourse. The activity becomes available after the student has read the selected book, which is leveled by reading difficulty, a minimum number of times (determined by age or teacher choice). Questions are asked about the selected book. Different levels of auditory and visual support are available for the question being asked and for the answers available. The spoken version of the question becomes available depending on the student's performance. The level of pictured, auditory and print support for the answers and additional “hint” information is also dependent on the student's performance. The questions are one of two types, factual recall or inferential reasoning. (See e.g Spec A ¶¶ 134-194) (explain the components in relation to the AVLs) and FIG. 2.13 (has an AVL table) in the Story Activity Specification (see Spec A) for the description of the Auditory Visual Levels for the Comprehension Sub-Activity).

As mentioned earlier, there are many developmental stages in the process of learning to comprehend spoken and printed language. A student's level of competency at each stage of the developmental process and the strategies he/she uses to comprehend information are often very difficult to assess. When assessing reading comprehension, it is also very difficult to know whether failure results from the student's lack of understanding of the meaning of the words even though they were appropriately translated from print, from a failure to translate the printed word or from a failure to make appropriate inferences about the content or context.

Traditionally, reading mastery is measured by a student's ability to perform a task at a given level of difficulty. For example, a student's performance is measured by the percent of words read fluently and for the percent correct attained during comprehension of text at a given level of reading difficulty. While the teacher can compare individual students to a standard norm for age or grade level, she has limited information about how the student learns or what support is necessary to maximize comprehension of language. The unique approach taken in the instructional method incorporated in this embodiment is to identify the level of support (oral, pictured or printed information) and identify learning strategies that are necessary for a student to successfully comprehend information at different levels of difficulty.

The goal is to facilitate the student's comprehension of connected text by providing the student with the necessary support to understand each question and select the appropriate answer. The adaptive software algorithms are designed to find the necessary level of support for each student to comprehend information while systematically weaning the student from the pictured and auditory support. As the student becomes more competent to rely on text alone, the auditory and picture clues are systematically removed. However, the progression rules that drive the level of auditory and visual support, are designed to provide the necessary support for the student to successfully answer each question. See e.g. Spec A, ¶¶ 166-202 and FIGS. 2.13 and 2.14 in the Story Activity Specification for the adaptive levels of auditory visual support. Spec A explains what happens after selecting correct or incorrect answer and provides the progression rules for the activation of auditory-visual support of the question and answers to insure the student's success.

Preview Words is embedded in the “Listen to Stories and Explore” and “Tell Stories and Explore” Activities. The purpose of Preview Words is to provide the student an opportunity to see words in isolation before viewing those words in the connected text to facilitate decoding strategies. What is unique to this software is that the “Explore Words” component (see Spec B) identifies the current language unit the student perceives in the lessons and transfers this information to the Preview activity. The target story words are then presented by student specific perceptual levels of language unit. The student can explore the target story words in language units that are consistent with his/her experiences in the structural component, “Explore Words”. The teacher does have the ability, if desired, to overwrite the computer placement and provide the student with opportunities to explore the target story words in others language parts also.

4.5.3 Acquisition of Vocabulary Knowledge

The purpose of the “Vocabulary” activity is to assess and facilitate the acquisition of vocabulary knowledge in oral and printed language. The vocabulary activity is available to the student as either an instructional task alone or as a pre- and post-test in addition to the instructional task. The teacher makes decisions about the availability and type of vocabulary activity. (See e.g. Spec A, ¶ 170 of the Story Activity Specification for details regarding vocabulary.) The vocabulary activity is always associated with a given book and is accessible on the story menu screen.

Vocabulary knowledge is one of the best predictors for reading comprehension. It is well documented that the most significant barrier to reading comprehension is a deficiency in vocabulary knowledge. The facility for understanding and using words is enhanced by having opportunities to understand words in context and by having experiences with words or concepts that have similarities and differences.

Students who have good facility with language and vocabulary development are more likely to expand their word usage and integrate meaning from oral and print contexts than those students who have limited language experiences and vocabulary knowledge. Making the transition from learning new words in oral language to learning new words from the printed text is critically important to expanding vocabulary and conceptual development.

Providing all students, independent of prior knowledge, with opportunities for vocabulary growth is an essential component of learning to read for meaning. The vocabulary activity described in the Story Activity Specification (e.g. Spec A, [symbol] 169-194) is designed to facilitate students'acquisition of new vocabulary by identifying either synonyms or antonyms of a target word. The context for the word usage in the book is provided as well as the definitions of the potential answers. Different levels of auditory and visual support are available for the target word and context and for the answers and associated definitions. The level of auditory support for the target and the answers becomes available depending on the student's performance. (See Spec A, [symbol] 175-202 (text description of components in relation to AVLs) and [symbol] 193 (tables of AVLs) in the Story Activity Specification for the description of the Auditory Visual Levels for the Vocabulary Sub-Activity).

The goal is to facilitate the student's acquisition and usage of new vocabulary words in oral and printed contexts. Again, the adaptive software algorithms are designed to find the necessary level of support for each student to comprehend information while systematically weaning the student from the auditory support. As the student becomes more competent to rely on text alone, the auditory support is systematically removed. However, the progression rules that drive the level of auditory and visual support, are designed to provide the necessary support for the student to successfully answer each question. See Spec A, [symbol] 175-194 in the Story Activity Specification for the adaptive levels of auditory visual support. See, e.g., Spec A, [symbol] 192-202 (progression rules and behavior with correct and incorrect answers) provide the rules for the activation of auditory-visual support of the question and answers to insure the student's success.

4.5.4 Acquisition of Specific Skills and Knowledge Necessary to Facilitate Perception of the Structural Elements of Language.

The purpose of the “Explore Words” and “Alphabet” activities (see Specs B and C) is to assess and facilitate (1) the perception of the structural units of language, (2) the ordering of the structural elements of language and (3) the automatic word recognition of text. Language units represent the way in which the structure of language can be perceived and represented: words in sentences, syllables in words, onsets and rimes in words, sounds in words and letters which represent the sounds.

Students must be able to perceive the phonemes or the sounds of the language before they can map these sounds to the alphabetic symbols, the graphic representation of text. It is well known that phonemic awareness (perception of individual sounds of the language) is one of the best predictors of reading achievement. Literature also documents that phonemic awareness occurs after students become aware of larger units of language. Perceptual awareness of the larger units of language (known as phonological awareness) is the awareness of words in a sentence and syllables in a word.

The curricular structure of the software according to the present exemplary embodiment represents a developmental model that systematically progresses from phonological awareness (perception of words in sentences and syllables in words) to phonemic awareness to phonics (mapping sounds to symbols). An aspect of the software is the set of rules that progress the individual through the developmental curriculum at the appropriate skill level and with the necessary auditory visual support for the individual to be successful at each level. Again, a differentiating feature is that the performance feedback is described not as “percent correct” or “mastery” at a given level of the curriculum; rather the self-adjusting rules identify what auditory visual support is necessary for the student to successfully perform at a dynamically changing skill level as language units change in the curriculum. This approach assumes that the continued experience with language and language structure at successive levels of the curriculum facilitates the translation of oral language to print. This is a fundamental difference from standard instructional models. This principle, consistent with natural language and logic acquisition, drives the rules, the progression and learning approach.

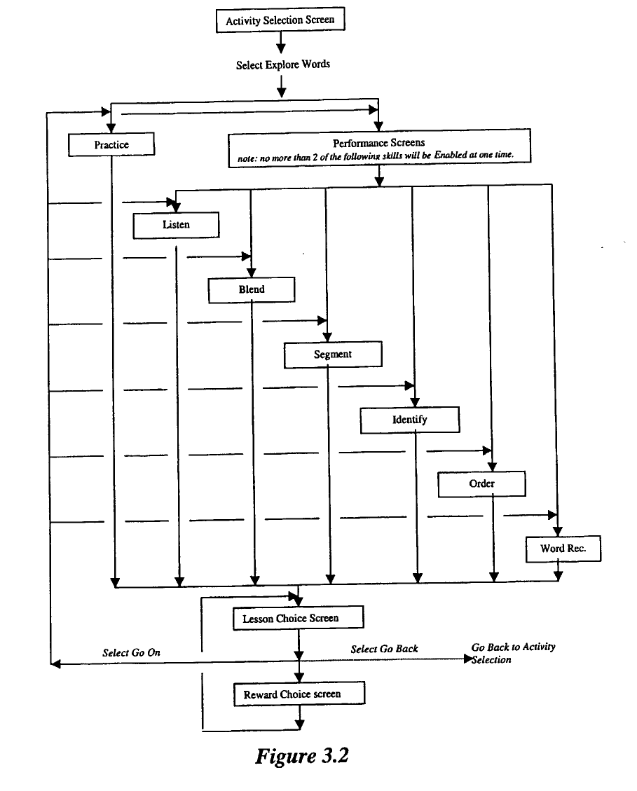

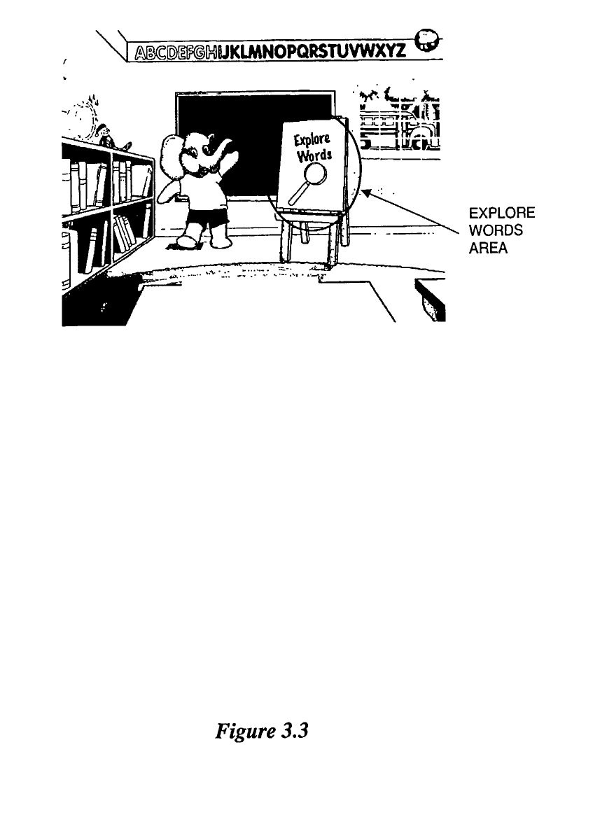

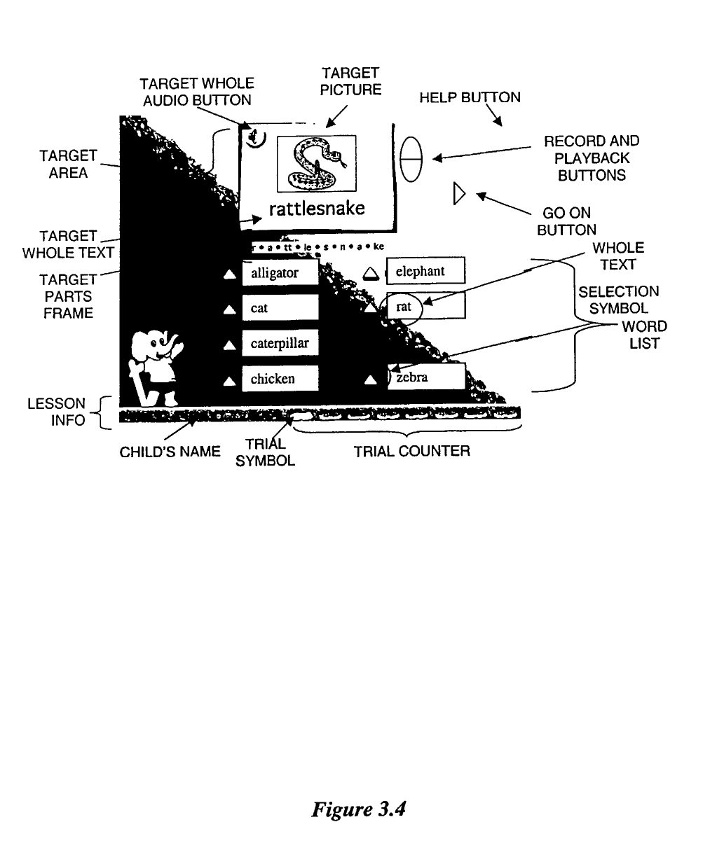

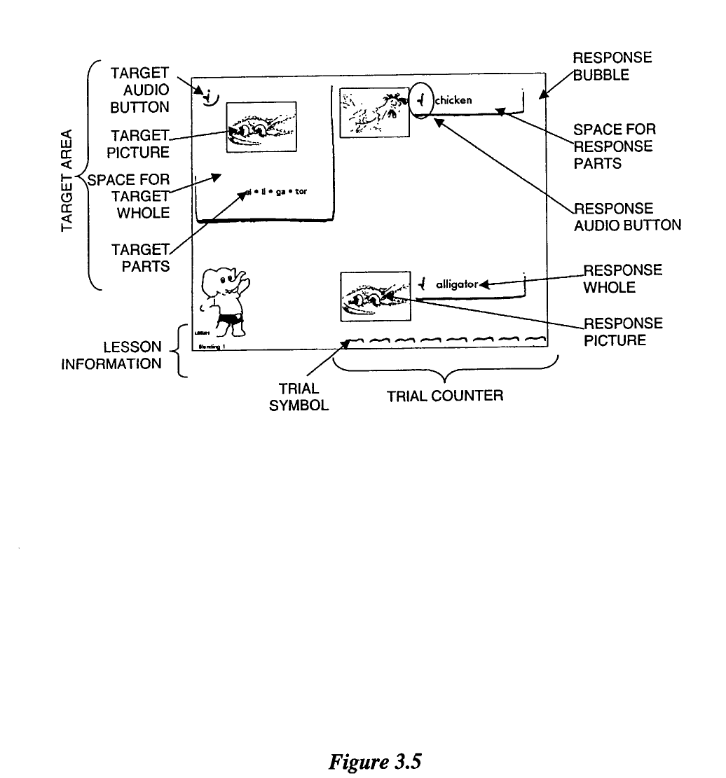

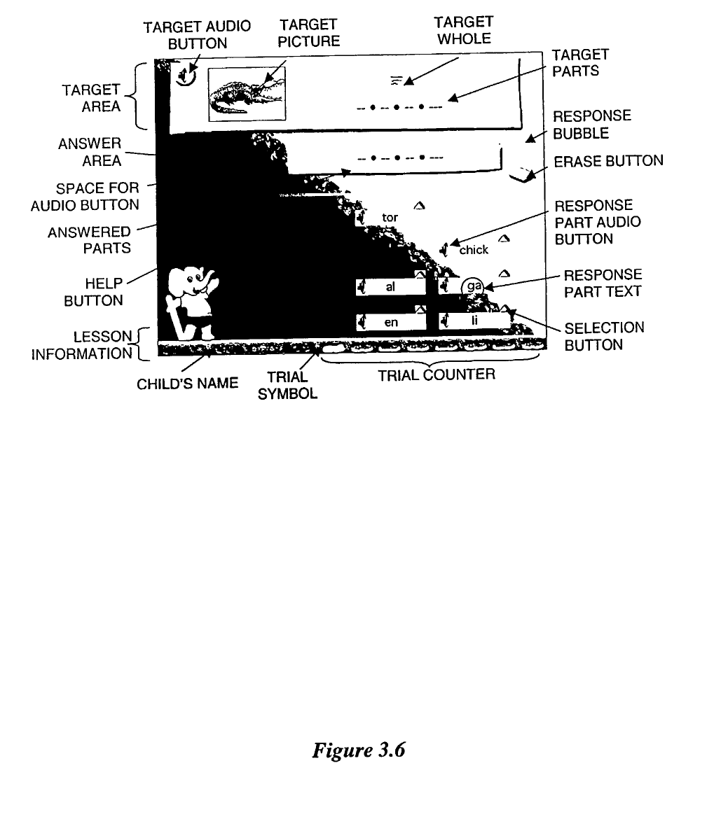

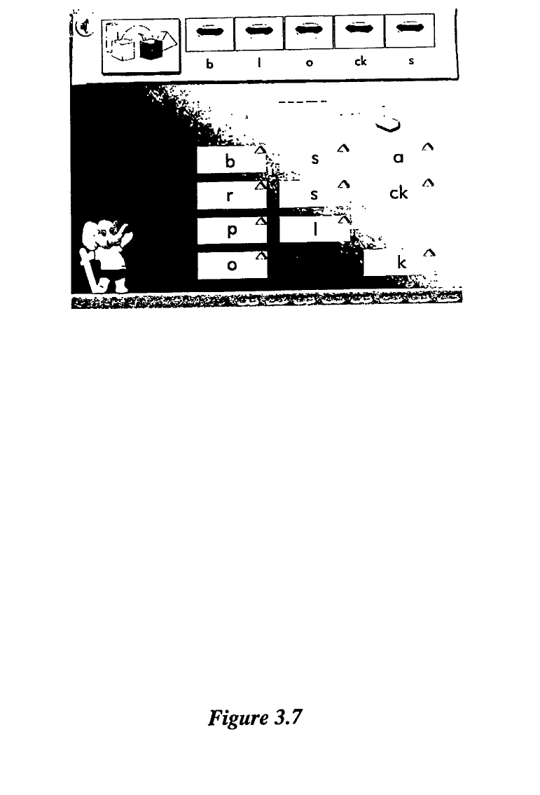

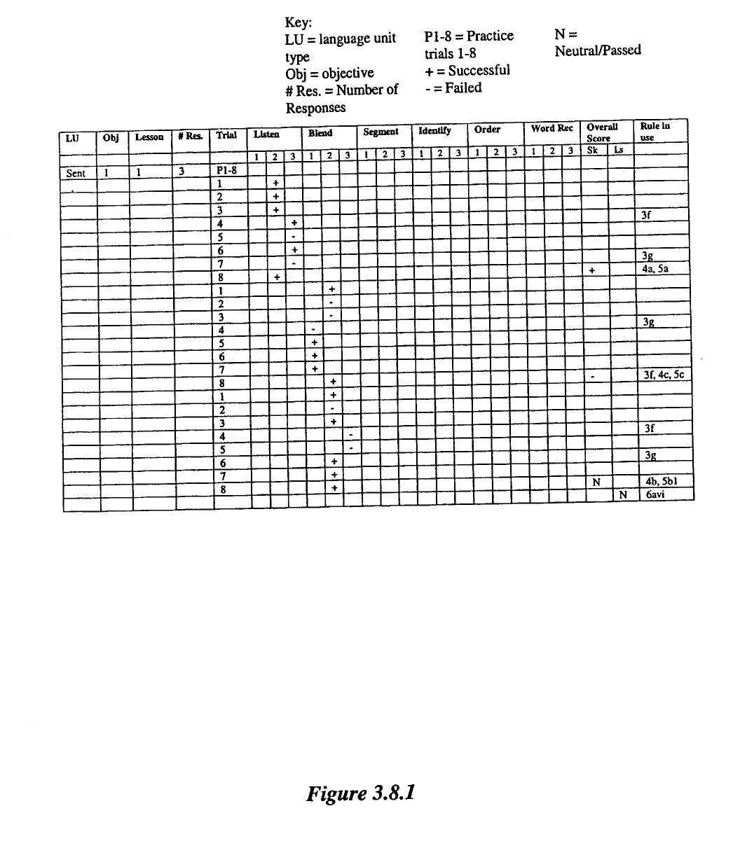

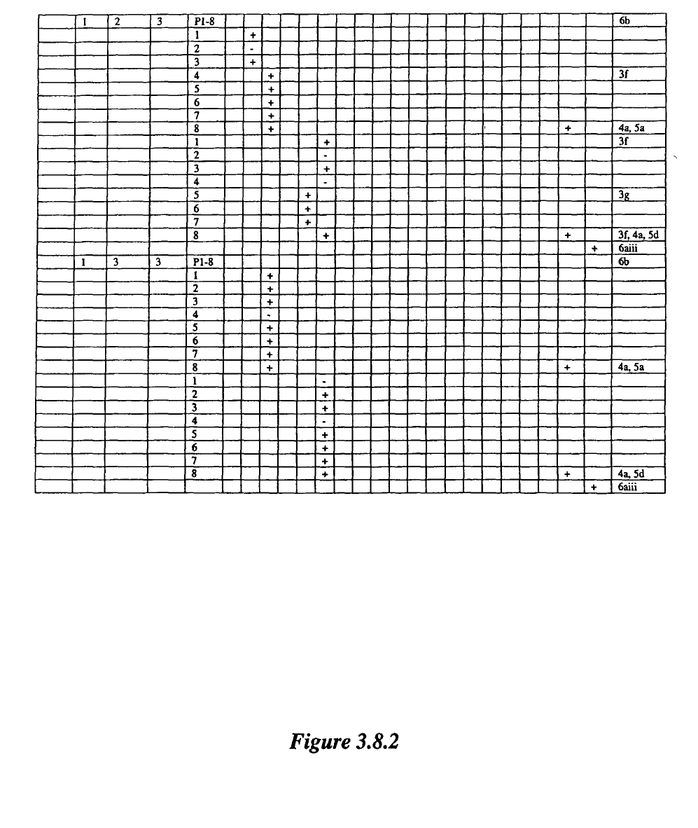

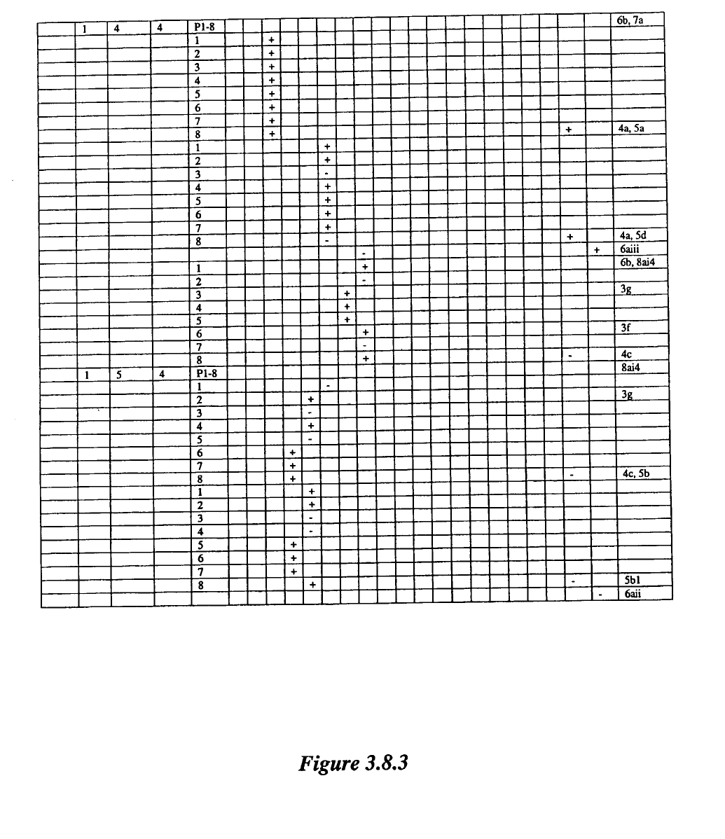

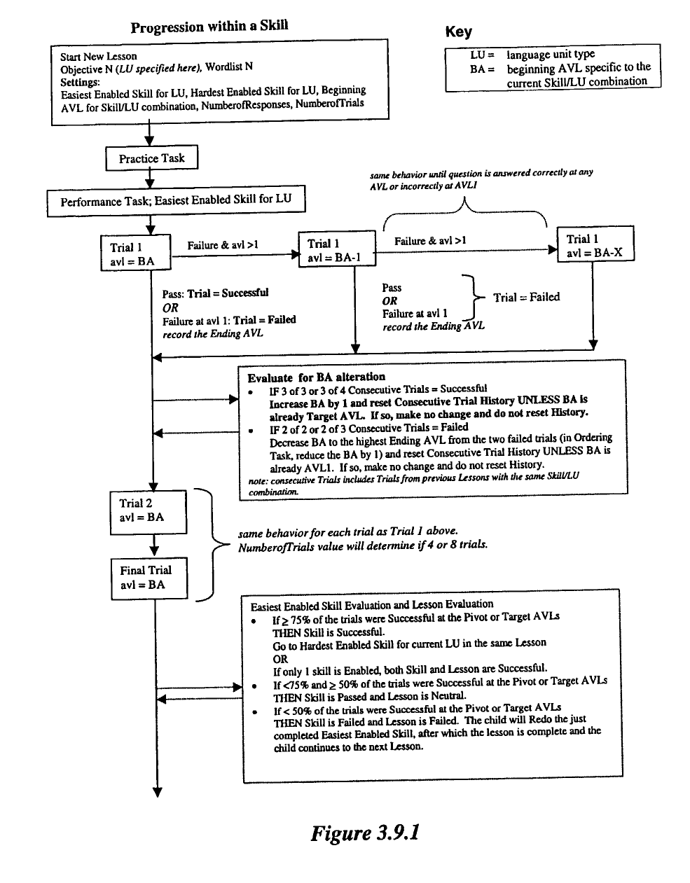

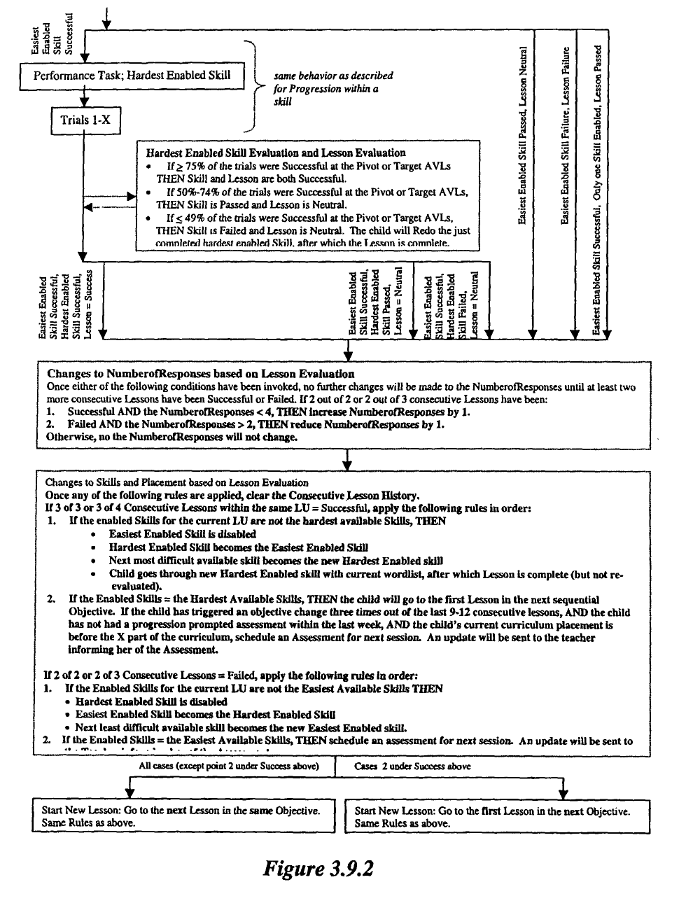

The current rules and skills in the Explore Words Activity (see Spec B) have been extended in several ways from U.S. Pat. Nos. 6,186,794 and 6,206,700. First, algorithms have been modified in the Explore Words activities that were disclosed in U.S. Pat. Nos. 6,186,794 and 6,206,700, so that the assessment and instructional change occurs at the trial level rather than the task level. See Spec B of the Explore Words Specification. Second, the general framework of the Explore Words activity has been extended to incorporate two new skills (Identify and Order). Third, the skill labeled “Blend and Segment Skill” has been separated into two separate skills, “Blending” and “Segmenting.” See e.g. Spec B, [symbol] 203 and FIG. 3.2 of the Explore Words Specification. Fourth, the number of responses is dynamically altered by the student's performance. In U.S. Pat. Nos. 6,186,794 and 6,206,700, only two responses were available. In the current application, the student is provided 2-4 answers depending on performance. See, e.g., Spec B and FIGS. 3.8.1 to 3.8.3. of the Explore Words Application for rules governing the number of responses available in a given lesson. Fifth, the present program tracks the skills associated with given language units embedded in the objectives as the student progresses through the curriculum. In U.S. Pat. Nos. 6,186,794 and 6,206,700, the progression of the skills was linked to movement through the objectives independent of the language unit. Sixth, the progression can trigger an automatic assessment to ensure proper placement of the child in the curriculum.

A lesson has both static and dynamic components. The wordlist and the specification of language unit, which represent the linear progression of the curriculum, are static for a given lesson. The auditory-visual levels necessary for success and the skill levels are dynamic. Two skills are paired for a given lesson. The skills made available as the student traverses through the curricular structure are driven by progression rules given on Spec B, e.g. ¶¶ 238, 284, and FIGS. 3.8.1 to 3.8.3. of the Explore Words Specification.

The student first sees a practice screen that allows exploration of the whole word or sentence and the word or sentence broken into the language units appropriate for that lesson. Upon completion of exploration, the student advances to a Performance screen to assess a given skill at a given language unit. Matching screens are used for each of the skills in the “Explore Words” Activity except for the “Ordering” skill.

Listening, Blending, Segmenting, and Word Recognition skills are similar to those described in U.S. Pat. Nos. 6,186,794 and 6,206,700. The student is required to match a target to one of the 2-4 available answers. The “Identify Skill” requires the child to focus on a particular language unit provided in the target question and identify the match of the focus unit with one of the 2-4 answers.

4.5.5 Acquisition of Skills and Knowledge Necessary to Facilitate Ordering of the Structural Elements of Language, Leading to the Perceptual Mapping of the Sound to Symbol Representation and the Production of that Mapping in Print.

Critical to translating oral language to the printed word is the student's knowledge of the alphabet. The student must know the names of the alphabet letters and the sounds associated with those letter names. Additionally, the student must know the names and sounds for the lower and upper case representations of letters. The Alphabet Recognition Activity (Spec C) is designed to provide the student opportunities that facilitate the student's recognition of upper and lower case letters and sounds. Similar to the Explore Words Activity (Spec B), the alphabet tasks are designed to provide practice opportunities and matching assessments which assess the student's knowledge of the alphabet. As in the tasks described earlier, the matching task is designed to provide the auditory visual support necessary for the child to be successful. Additionally, the child is able to request an assessment at any time during the activity to measure progress. See Spec C (description of take a test) and in the Alphabet Specification for details.

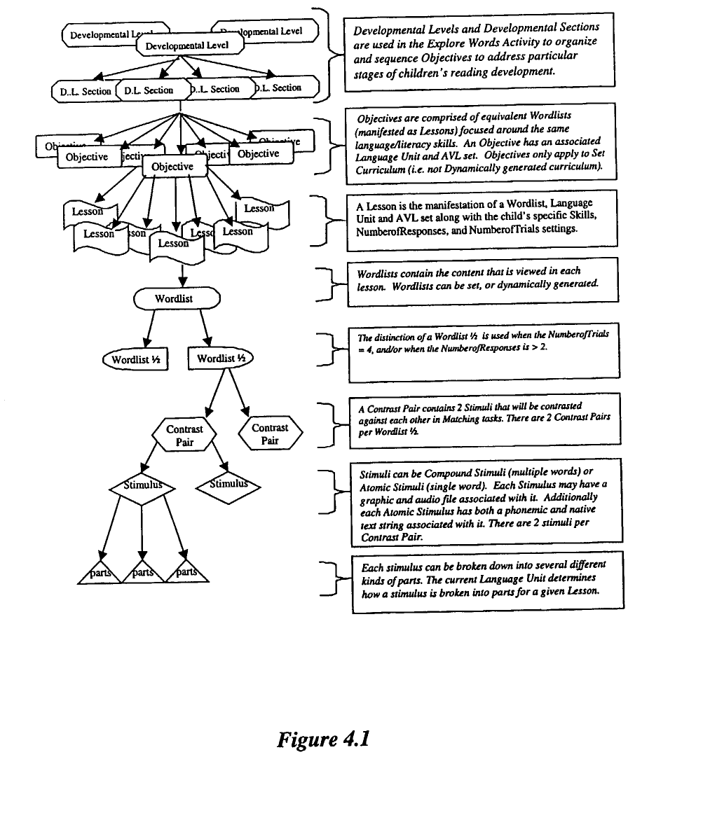

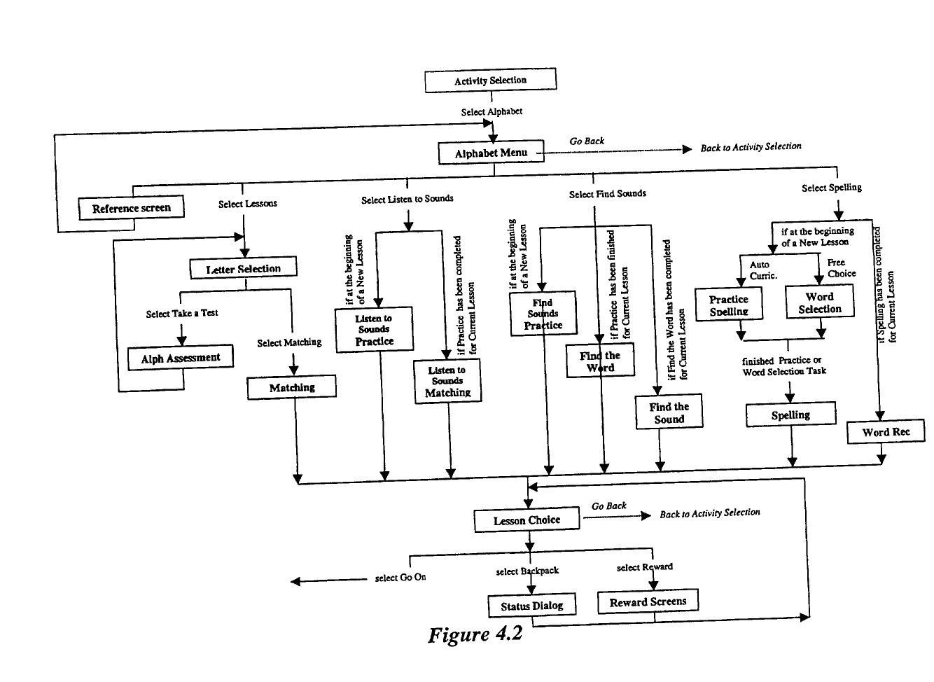

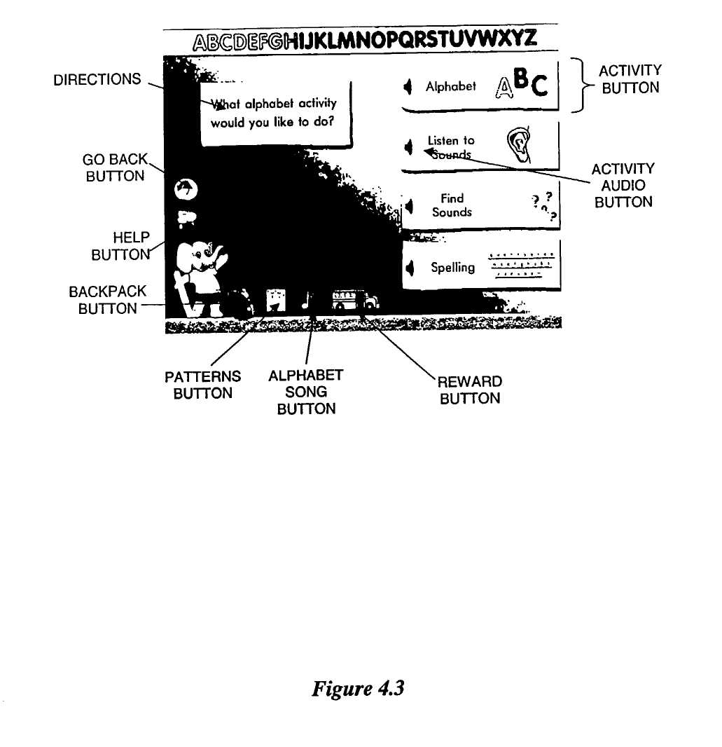

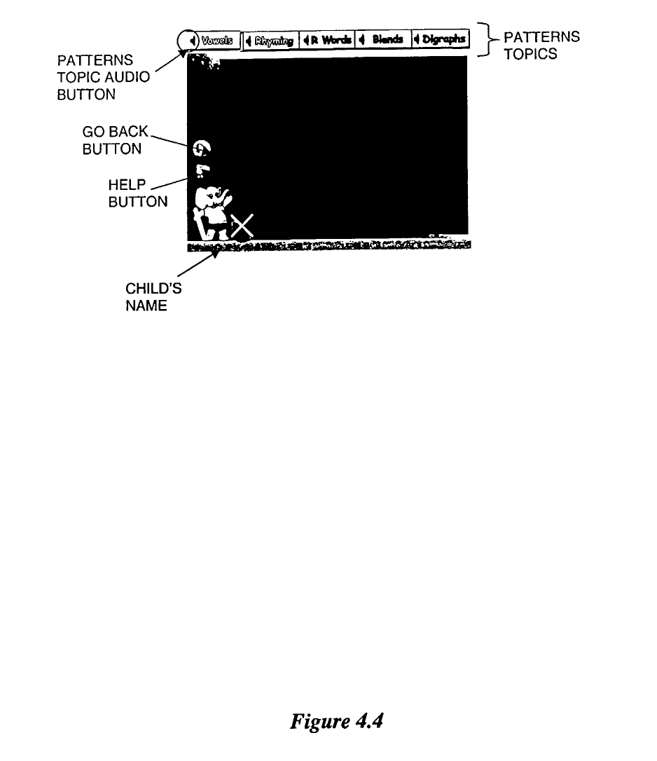

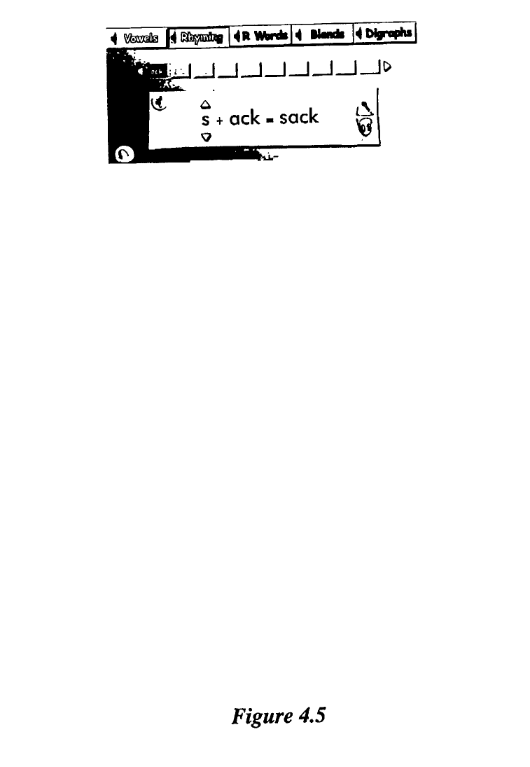

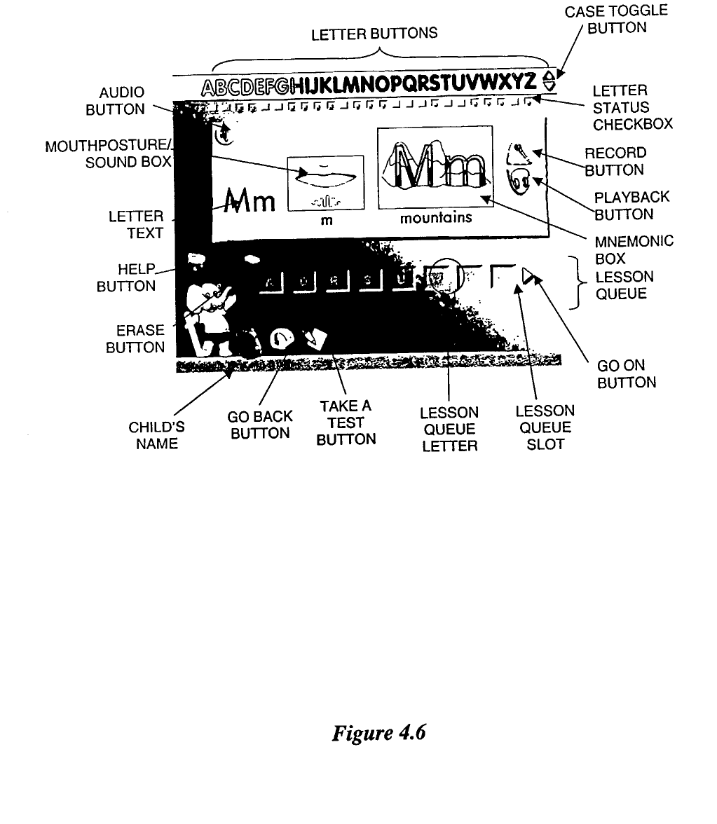

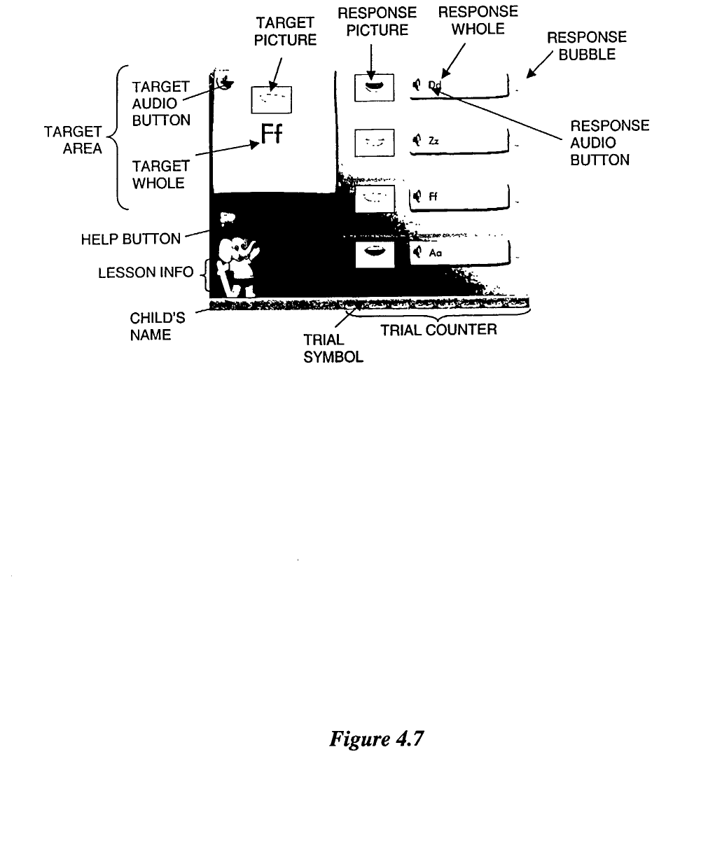

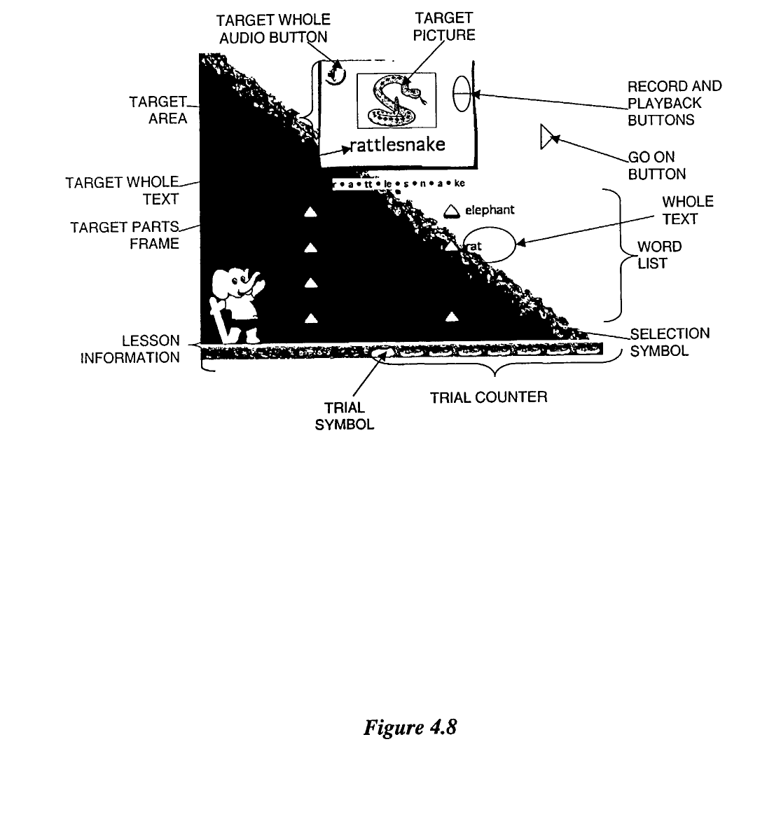

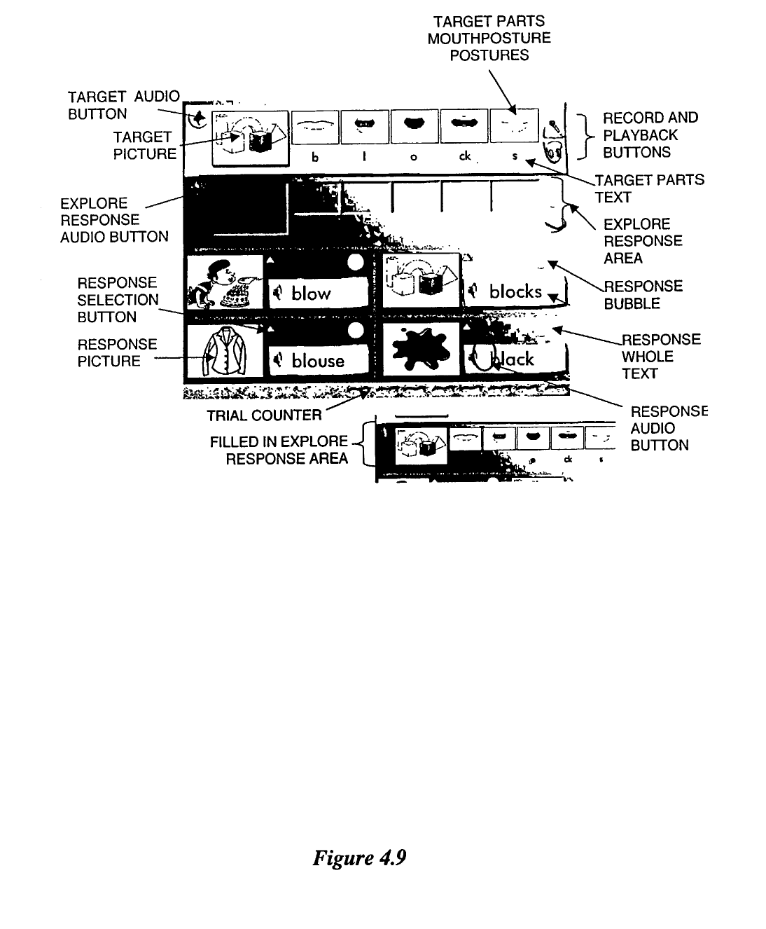

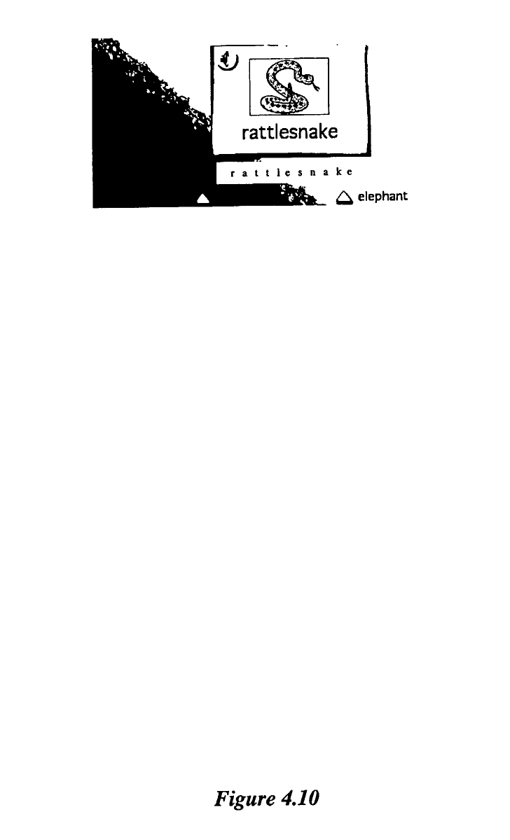

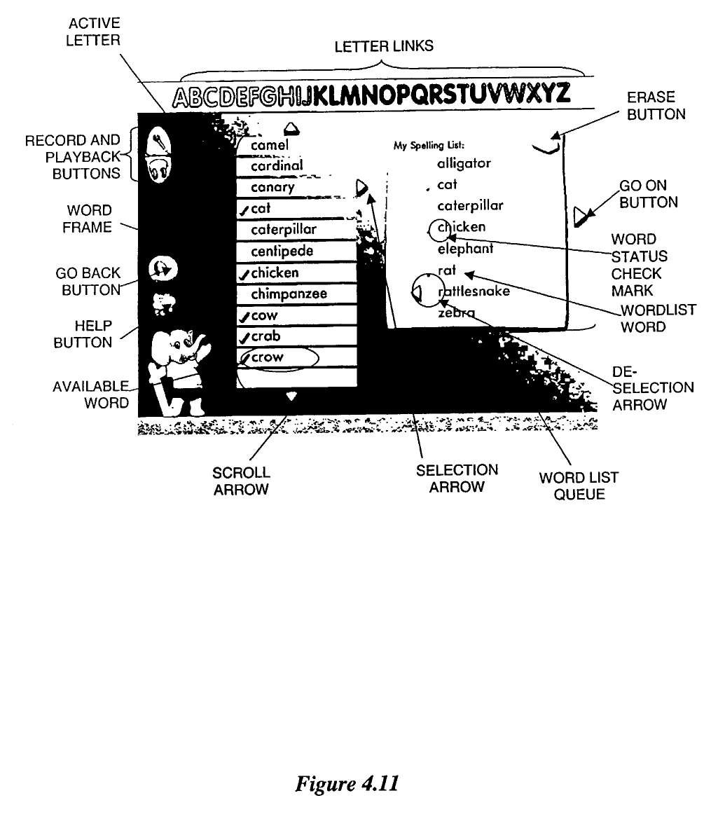

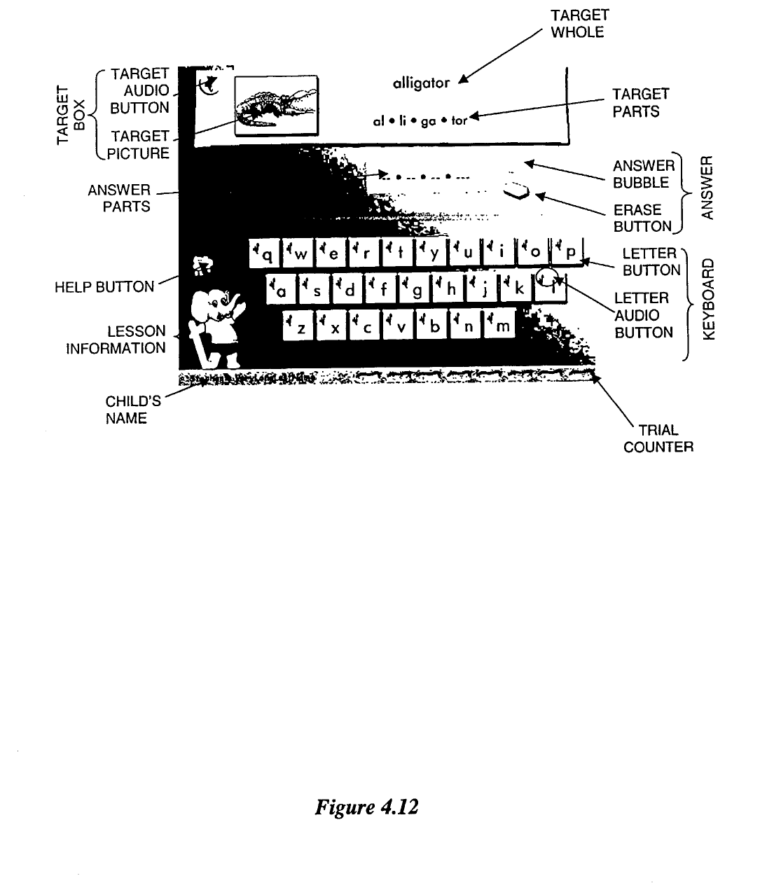

Once students have learned the alphabet, they must learn the connection between the production of the sounds within words and how those individual sounds map to the alphabet. The Listen to Sounds Task in the “Explore Alphabet” component explicitly facilitates the student's connection between the production of the phoneme and the printed letter that is associated with that sound or phoneme. The explicit connection is pictured by mouth postures which represent the placement of the lips and opening of the jaw during the production of a specific phoneme. See Spec C, [symbol] 414-426 and FIG. 4.10 in the Explore Alphabet specification. After the practice screen the student moves to the matching screen where the “listen to Sounds” activity is presented. The student is provided a target and is required to find the match to the target by selecting 1 of the 2-4 answer selections. Auditory-visual support information is proved as needed to allow the student to make the connection. See, e.g. AVL support tables and progression rules in Spec C.

The successful translation and transfer of oral to written language requires that students perceive the individual language units and that they can construct the order in which they are produced. For example, a child must be able to perceive the individual sounds within the word “cat”, to attain phonemic awareness, a critical prerequisite to efficient decoding. To translate and transfer the perception of language to the production of written language, the student must be able to order the sounds in the appropriate sequence. Students are able to order the larger units of language (words and syllables) before ordering the sequence of sounds Additionally, students progress through developmental stages of “spelling”. Initially they are able to order the units they perceive which are linked to the actual utterance rather than the correct ordering of letters, (spelling). In the English language, there is not a one-to-one correspondence of the sound to symbol relationship. Several letters can combine to make one perceptual unit. These rules must be systematically learned by the student to translate the oral to the written and reciprocally, the written to the oral. The present software application systematically exposes the student to the ordering of the perceptual units and to the ordering of the conventional spelling of the letters.

The purpose of the “Ordering” skill in the “Explore Words” activity (see Spec B) is to facilitate the appropriate ordering of the language units that the student can perceive with appropriate auditory visual support. This skill facilitates the transfer of the perception of oral language to the production of writing language.

The screen display shown in FIG. 3.6 of the Explore Words Specification describes the interaction between the student and the user interface. The top portion of the screen displays the target word and answer area and the bottom portion of the screen displays the available language units from which the student makes selections. The student's task is to select and appropriately order the language units to produce the whole word from left to right. The amount of auditory and visual support necessary for the student to perform the task is dynamically provided. Feedback is provided about performance throughout the trial. The rules governing the Auditory visual levels for the “ordering skill” are found in FIG. 3.7 (correct/incorrect answer behavior) of the Explore Words Specification. This “Ordering” skill is unique from standard “spelling” programs because the students have experience with the language unit that they can perceive, which may be words, syllables, or onsets and rimes, in addition to the sound language unit. It is also unique because students are expected to order the perceptual units of language, that is, what the combination of sounds produces, not the order of individual letters in this task. It is also unique because the students are provided immediate feedback about perception as they are producing the order of the language units. See e.g. FIG. 3.6 that describes the feedback available to the student during the ordering of the language units.

The purpose of the “Spelling” activity in the “Explore Alphabet” Activity is to facilitate the appropriate ordering of the letters necessary to spell words. The screen display shown in “Explore Alphabet Specification” at FIG. 4.13 of Spec C is functionally similar to the “Order Skill” screen. The primary difference is that the language units displayed in the answer area are always letters displayed on a keyboard. There are two spelling activities in this software application. One is a set curriculum that advances the student through a progressively more difficult set of lessons. The other is designed so the student can select the words in the spelling list. Once again, the levels of support which are necessary for student to correctly spell words drive the progression rules. This is fundamentally different in evaluation and progression through a spelling curriculum from one that is based on mastery.

### 5 SPEC A

### Story Activity Specification Including Preview, Comprehension and Vocabulary

5.1 Definitions

Navigation/Selection Screens—Navigation/Selection screens include the Activity Selection, Theme Selection, Book Selection, Story Menu and the Story Choice Dialog.

Story Screens—the Story Screens include the Cover, and Story Pages.

Initial Functionality—Initial Functionality refers to any behavior that happens automatically when a screen is displayed. This may include Available visual components, Initial Audio and button availability.

Normal Functionality—Normal Functionality refers to all behavior after the Initial Functionality is complete (usually marked by the completion of any Initial Audio).

Initial Audio—Initial Audio refers to any audio that is played automatically when a Story Screen is displayed in Listen Mode or when the Whole Audio button is selected in any Mode. Initial Audio is assigned on a Sentence level as a property of the Assets.

Listen Mode—Listen Mode is one of 2 modes that a Story can be presented in. The two modes have the same functionality, audio on demand and layout, with just a few differences: in Listen Mode, Initial Audio is available for every Story screen and Recording functionality is never available.

Tell Mode—Tell Mode is one of 2 modes that a Story can be presented in. The two modes have the same functionality, audio on demand and layout, with just a few differences: in Tell Mode, Initial Audio is available only for the Cover, and Recording functionality is always available.

BookStarted flag—the BookStarted flag is set for a book or chapter when the child goes to the first page of that book or chapter. The BookStarted flag is used to determine the NumberofTimesRead for each book or chapter. The BookStarted flag is turned off when the final page of the same book or chapter is reached. Note, for Reports we need to be able to total the number of times a book was read all the way to the end AND the number of times a book was started but not finished. The BookStartedflag is specifically for determining the number of times a book has been read all the way to the end.

NumberofTimesRead—the NumberofTimesRead value is based on the number of times a child reaches the final page in a book/chapter when the BookStarted flag was set. The NumberofTimesRead value is used in Reports, and to determine when the Tell Mode and Comprehension Task become available for a given book/chapter.

Chapter Functionality—Chapter functionality refers to a variation of functionality that applies to Chapter and Collection books only. In summary, these books act just like a non-chapter book, except that each Chapter is treated as its own book (Preview, Tell, and Comprehension are enabled on a chapter by chapter basis, Bookmarks and BookStarted flags are set per chapter) and can be Linked to directly.

Note: a book can contain chapters but not be assigned Chapter Functionality. In Second grade only two books will have Chapter Functionality: Rescue and Dinosaur Detectives.

Chapter Book—a Chapter book is a book that is assigned Chapter Functionality. It differs from a Collection book in that the chapters must be read sequentially. Functionally, this distinction affects which chapters are Accessible at any given time.

Note: In the Second Grade product we do not have any of these kinds of books. However, we will in the Third Grade product.

Collection Book—a Collection book is a book that is assigned Chapter Functionality. It differs from a Chapter book in that the chapters within the collection do not need to be read sequentially. Functionally, this distinctions means all Chapters are Accessible.

Note: both of the books with Chapter Functionality in the Second Grade Product are Collection Books Rescue and Dinosaur Detectives).

Active Chapter: the Active Chapter is relevant only in a book with Chapter Functionality. It is whichever chapter the child has selected on the Story Menu. The Active Chapter determines which Activity buttons will be displayed, and drives any resulting Preview Wordlists, Story Choice options and Comprehension questions.

Accessible Chapter: this term is only relevant for books with Chapter Functionality. It refers to any chapter a child can access from the Story Menu. There are rules to determine when a chapter is Accessible:

Any chapter that has been read ≧1 time is Accessible (to have ‘read’ a chapter, the child must reach the final page in the chapter).

Chapter 1 is always Accessible.

The lowest unread chapter is always Accessible.

Every chapter in a Collection book is Accessible.

Incomplete Book: this term refers to a book for which we choose not to use the entire book in the program. This may happen because only part of the book is conducive to layout on the computer, or because the book is very long. Incomplete Books have slightly different functionality on the Table of Contents page (if one exists for the book). In the Second Grade Product, the book A Wetland Home is the only Incomplete Book.

TextWithParts—TextWithParts refers to any text that has selectable words. Selecting one of these words will play the audio for only the individual word selected. All TextWithParts will be preceded by a Sentence Marker so that the entire TextWithParts can also be played. Note that TextWithParts can be comprised of a single word, a phrase, or a sentence.

TextWithNoParts—TextWithNoParts refers to any text in the Story Book Display that does not have selectable words. Selecting any of these words will play the audio for the entire TextWithNoParts. Note that TextWithNoParts can be comprised of a single word, a phrase, a sentence or a paragraph. TextWithNoParts will not be preceded by a Sentence Marker.

Highlight—Some text will be Highlighted when selected. Information about Highlighting will be conveyed in the assets.

Final Page—The Final Page is the last page available for a book/chapter. The functionality of the Final Page is identical to the functionality of a regular Story Page with a few exceptions related to the Next Page button, Inactivity and Time Out functionality.

Book Level—The Book Level is a level of difficulty assignment given to each book. The Book Level is reported on in Reports. In the future, it may be used to help determine which books are available to a child.

ActualGrade—The ActualGrade reflects the grade where a child is physically placed at school. In the current product, the ActualGrade is determined by the product in use (e.g. all children using the 2^{nd} Grade product have ActualGrades=2^{nd} Grade). In the future, the ActualGrade for each child will be a value set in Enroll.

Assessed Grade—The Assessed Grade is a score or level for the child to indicate where s/he is performing or perceiving. It is determined by the child's age, teacher observations and the results from the child's Initial Assessment. The child's Assessed Grade will determine some functionality for a child. Additionally, the Assessed Grade can be modified due to subsequent assessments or teacher observations. Currently, functionality differences in the Story Module will be driven only by what grade product the child is using. In the future (e.g. if the same product spans several grades) a child's Assessed Grade will determine some of the Story Module functionality.

Vocabulary Specific Terms

Instructional Task—the Instructional Vocabulary Task is a version of the Vocabulary Task that focuses on teaching the child vocabulary knowledge for specific words in each book.

Assessment Task—the Assessment Vocabulary Task is a version of the Vocabulary Task that focuses on finding out if the child understands the meaning of the vocabulary words for a book with the support of Audio and/or Print alone.

Preview Specific Terms

Preview Task—the Preview Task is an activity that allows the child to preview selected words/sentences/phrases from a book before actually reading the story. The Preview task can be Off, Forced or Optional for any child. The Preview Task begins when the Preview screen is loaded, and ends when the Preview screen is exited.

Preview Wordlist—there are up to 5 Preview Wordlists per story/chapter, each with a different focus. The Preview Focus determines which Wordlist(s) will be available to the child at any given time and is determined by settings in Enroll and (in some cases) dynamic choices made by the child or program.

Preview Focus—there are 5 different Preview Foci; Sentences, Syllables, Onset/Rime, Sounds and High Frequency. The foci determines how a word/sentence/phrase is broken into parts.

Focus Determiner—the Focus Determiner indicates ‘who’ determines the Preview Focus. There are 3 options for the Focus Determiner: TeacherSelectsFocus, ProgramSelectsFocus or ChildSelectsFocus. The Preview screen display changes depending on the Focus Determiner.

Comprehension Specific Terms

Comprehension Activity: the Comprehension Activity refers to the activity in the program that asks questions about a particular book.

Comprehension Task: the Comprehension Task begins when the child selects the Comprehension Activity from the Story Menu and ends when the child is returned to the Story Menu or the Activity Selection screen. A pre-determined number of comprehension questions (trials) are available during each Comprehension Task. A child can choose to do more than one Comprehension Task in a session.

Current Story: the Current Story is whichever Story the child selected before going to the Story Menu. The questions presented in the Comprehension Activity will all be related to the Current Story.

Active Chapter: the Active Chapter is relevant only in a book with Chapter Functionality. It is whichever Chapter the child selected on the Story Menu before going into the Comprehension Activity. The questions presented in the Comprehension Activity will all be related to the Active Chapter.

Trial: each Comprehension Task is made up of Trials . . . each Trial represents a single question, although that question may be asked more than once before the Trial is complete.

A Trial begins when a question is presented for the first time in a Comprehension Task.

A Trial ends either when the question is answered correctly at any AVL or the question is answered incorrectly at AVL 1.

AVLs: AVL stands for audio visual level. There are 7 different AVLs in the Comprehension Activity. To fully define an AVL, the audio, pictorial and textual information must be described for the Question, Answers and Hint components of the Comprehension Activity. Furthermore, the audio, pictorial and textual information must be specified as one of the following:

Initial—AVL information that is designated as Initial will be presented to the child automatically at the beginning of each new Trial presentation. This information is presented to the child before s/he is allowed to answer the comprehension question.

On Demand—AVL information that is designated as On Demand will be presented to the child only if s/he requests it.

Never—AVL information that is designated as Never will never be presented to the child.

See “Comprehension AVL's, infra.

Initial Beginning AVL: the Initial Beginning AVL is the AVL assigned to a child as part of his/her initial placement. The Initial Beginning AVL is the same for all stories/chapters for a given child, however, experiences in Stories and subsequent changes to the Beginning AVL are story/chapter specific.

Beginning AVL: the Beginning AVL specifies what information is available when a Trial is first presented. The Beginning AVL for each story/chapter will be one of the 7 Comprehension AVLs.

Progression Rules or teacher manipulation can change a child's Beginning AVL (see progression rule section).

Beginning AVLs are story/chapter specific, meaning that any alterations to a Beginning AVL are specific to the story/chapter in which the alterations are made.

Ending AVL: the Ending AVL is the last AVL presented in a Trial before the child is taken to the next Trial or finishes the Comprehension Task. Most of the time, the Ending AVL is the AVL at which the child successfully answered the question. The only exception is if the child fails at AVL 1. In this case the Ending AVL is AVL1, even though the child never answered the question correctly.

Comprehension History: a History will be kept of the child's experiences in each Comprehension Story Curriculum. The History is story/chapter specific and cumulative; it will traverse multiple Comprehension Tasks and multiple passes through the Story's Curriculum. Report information about the Comprehension Activity will draw primarily on this History.

The History is also referred to by Progression rules. The entire History is important to keep a record for Reports, however, the Progression Rules will ignore certain parts of the total History. To clarify the parts of the History that the Progression Rules will interact with, the following distinctions have been made:

Consecutive Trial History—the Consecutive Trial History provides the Beginning and Ending AVLs and the Trial Success or Failure for recent Trials. The Consecutive Trial History is used to determine Changes Based on Trial Evaluation in the Progression Rules. When Changes Based on Trial Evaluation are invoked, the Consecutive Trial History will be reset (i.e. previous Consecutive Trial History will be ignored for the purpose of Progression Rules only).

Note that Consecutive Trials can cross Comprehension Tasks and/or Curriculum traversals.

Curriculum History—the Curriculum History provides the Beginning and Ending AVLs and the Trial Success or Failure for the most recent traversal of the Comprehension Story Curriculum. The Curriculum History is used to determine Changes Based on Curriculum Recycling in the Progression Rules. When Changes Based on Curriculum Recycling are invoked, the Curriculum History will be ‘reset’ (i.e. previous Curriculum History will be ignored for the purpose of Progression Rules only).

Comprehension Story Curriculum: each story/chapter has a ‘comprehension curriculum’ . . . a set number of comprehension questions about that particular story/chapter. The total number of questions varies per book/chapter. The number of questions is between 0-100.

If a book/chapter has zero comprehension questions in it (i.e. no curriculum), then the Comprehension Activity will never be available for that book/chapter.

Comprehension Questions have a designated order in which they will be presented to the child until ‘Curriculum Recycling’ is invoked through the Progression Rules. At this time, the order of the Comprehension Questions will be altered to reflect what is least difficult and most difficult for the individual child.

See the Progression Rules, infra.

Hint Sources: The Hint Source determines what picture is shown in the Hint Reference thought bubble. Comprehension Hints can come from a variety of sources, the default being the associated Story Book. Other possible Hint Sources are a dictionary, encyclopedia or atlas.

5.2 Performance Requirements

Performance requirements for all areas of the Child Application must keep the following in mind:

Children's attention spans can be very short. The speed at which screens display and functionality responds to a child's initiatives (i.e. mouse clicks) is very important. Audio responses to clicks on text or buttons should be nearly instantaneous. The same should be true for screens where the child makes a selection but remains on the same screen (e.g. selecting an entry on the Preview screen). Screen changes should be as quick as possible, with a nearly instantaneous indication that something has happened (e.g. a button flashes to InUse) so that the child doesn't spend time re-clicking buttons because s/he thinks the program didn't register his/her last request.

Timing of audio messages can be tricky. At times we may need to shorten or lengthen the pauses between audio files. Examples are: the time between ‘sentences’ in Help messages, the time between the whole and the first part in Preview, the time between the parts in Preview, the time between sentences read in a book. Making these timing variables flexible to future alterations will save us work in the long run.

Timing between visual presentations can be tricky, e.g. the timing between each Comprehension answer being displayed on the screen. Making these timing variables flexible to future alterations will save us work in the long run.

5.3 Navigation Screens

5.3.1 Overview

[See flowchart of FIG. 2.1].

5.3.2 Activity Selection Screen

5.3.2.1 How Is the Story Activity Selected?

To select the Story Activity, the child must select the Story area from the Activity Selection screen. The Activity Selection screen will vary depending on the ActualGrade of the child.

5.3.2.2 Activity Selection Screen

The SecondGradeClassroom screen is shown as an example of an Activity Selection screen.

[See FIG. 2.2].

5.3.3 Theme Selection Screen

[See FIG. 2.3]. Note the following regarding this figure:

Theme Categories (0-4)

Theme Labels (1-16)

Theme Selection (one per Theme Label)

Featured Book

Book Title Audio button

Book Selection

Featured Book Label

Help Button

Go Back Button

5.3.4 Book Selection Screen

[See FIG. 2.4]. Note the following regarding this figure:

Theme Label

Books (1-8 displayed at a time, up to 32 in a theme)

Book Title Audio button

Selection

Scroll buttons (only if there are more than 8 books in the theme)

Help button

Go Back button

Featured Book (only if the Featured Book assigned in Enroll belongs to the theme being displayed. When the Featured Book appears on top, it will also appear within the book cart itself—so there is no empty spot.)

Book Title Audio button

Featured Book Label

5.3.5 Story Menu Screen

[See FIG. 2.51.] Note the following regarding this figure:

Book Cover

Book Description

Help

Activity Buttons

Listen button

Answer Questions button

Tell button

Activity Button Audio button (one per Activity Button)

Go Back button

Backpack button

Child's name

Vocabulary button

Reward button

5.3.6 Story Choice Dialog

[See FIG. 2.61.] Note the following regarding this figure:

Background Graphic

Dialog Text

2 to 3 choices (sneak preview, beginning, bookmark) each consisting of:

Selection button

Audio button

5.4 Preview

[See FIG. 2.71.] Note the following regarding this figure:

Target Whole Frame containing:

Target Whole Audio button

Target Whole Text

Preserve space for future Target Picture (won't be used now)

Target Parts Frame containing Target Parts

Word List containing:

1-8 Selection symbols

1-8 Whole Text

Focus Dialog button

Record button

Playback button

Help button

Go On button

Child's Name

### Focus Dialog

Up to five Focus Choices will be visible on the Focus Dialog at any time. Each Choice is identified by a text label and has a corresponding audio button. Selecting the audio button will cause the associated FocusAudio to play. Selecting the text label selects the focus:

Sentences—a button containing the text ‘Sentences’

Syllables—a button containing the text ‘Syllables’

Onset/Rime—a button containing the text ‘Beginning Sounds’

Sounds—a button containing the text ‘All Sounds’

High Frequency—a button containing the text ‘Common Words’

[see FIG. 2.8].

5.4.1 How is a Word List defined?

Each book/chapter will have 0-5 Word Lists assigned for the Story Preview task. Each Word List will have 0-8 entries assigned to it, which contain words or sentences/phrases from the book/chapter. The Word Lists will be divided into 5 categories depending on the Focus of the entries: Sentences, Syllables, Onset and Rime, Sounds, and High Frequency. If there are 0 entries assigned to one of the categories, that Word List will not be available for the Preview task.

There will be a minimum of 1 entry in each Word List.

There will be a maximum of 8 entries in each Word List.

There will be a maximum of 8 parts to any entry in a Wordlist, with no more than 40 total characters (including spaces and periods) and no more than 20 total characters per line (2 lines total). No single part can be more than 20 characters.

Line breaks will be automatically assigned (based on standard word processing rules) unless the assets contain specific line break information.

5.4.2 Determination of the Preview Focus

When the teacher turns on the Story Preview task (in Enroll), s/he will need to select a Focus Determiner. The Focus Determiner she selects will determine the exact Focus of the Word List(s) available. The Focus Determiner selected will be universal for all books/chapters for a given child:

TeacherSelectsFocus—if this option is enabled, the teacher must also select a specific Focus from one of the following options:

Sentences—this option causes only Sentence Word Lists to appear in the Story Preview task.

Syllables—this option causes only Syllable Word Lists to appear in the Story Preview task.

Onset and Rime—this option causes only Onset/Rime Word Lists to appear in the Story Preview task.

Sounds—this option causes only Sounds Word Lists to appear in the Story Preview task.

High Frequency—this option causes only High Frequency Word Lists to appear in the Story Preview task.

ProgramSelectsFocus—if this option is enabled, the program will dynamically pick the Focus for the Preview task. The program will present the focus that matches the child's current Language Unit in Explore Words. Note: the High Frequency list will never be displayed under this option as it is not a Language Unit.

ChildSelectsFocus—if this option is enabled, the Focus Choices will appear in the Focus Dialog and the child will determine the Focus by selecting one of the Choices. The child will be able to choose between each available Wordlist for the story/chapter.

The Target Parts are determined by the Focus. See the following chart and examples:

| Focus | Rules | Audio |
|---|---|---|
| Sentences | Whole = whole phrase or sentence | Voice |
| | Parts = whole words for Compound | Story |
| | Stimuli | Speaker's |
| | | Voice |
| Syllables and | Whole = whole word | Story |
| High Frequency | | Speaker's |
| | | Voice |
| | Parts = syllables for multi-syllabic | Voice |
| | words (visually divided by bullets) | |
| | Part = whole word for single syllable | Voice |
| | words | |
| Onset/Rime | Whole = whole word | Story |
| (one syllable | | Speaker's |
| words only) | | Voice |
| | Parts = initial token is separated | Voice |
| | from remaining sounds | |
| Sounds | Whole = whole word | Story |
| | | Speaker's |
| | | Voice |
| | Parts = individual tokens | Voice |

[See also FIG. 2.9].

5.5 Story Screens

5.5.1 What is Displayed on a Story Screen?

Tell mode is displayed:

[See FIG. 2.10]. Note the following regarding this figure:

Book Display

Text made up of Sentence(s) and Word(s)

Sentence Marker(s)

Image(s)

Page Number

Look Closer button(s)

Up and/or Down scroll arrow(s)

Go Back button

Status Bar

1Child's Name

Whole Audio button

Previous Page button

Next Page Button

Help button

Story Icon

Record button

Playback button

5.6 Comprehension

5.6.1 Where and When Does the Comprehension Activity Occur?

The Comprehension Activity becomes accessible on a book-by-book or chapter-by-chapter basis from the Story Menu automatically after the NumberofTimesRead value for the Current Book reaches a specified number.

The NumberofTimesRead value required to enable the Comprehension Activity is dependent on the child's AssessedGrade.

A teacher can modify the NumberofTimesRead value to between 0-50 times for all books, or for all books with Chapter function value books without Chapter functionality. Additionally, the Comprehension Activity can be turned on or off for all books, or for individual books.

If a conflict occurs where the change would disable Comprehension after it has already been enabled, Enroll will alert the teacher to this conflict for resolution.

5.6.2 What Will be Displayed on the Comprehension Screen?

[See FIG. 2.11]. Note the following regarding this figure:

Question Box

Question audio button

Question text

Answer Box (4)

Answer picture

Answer audio button

Answer text

Answer response bubble

Hint area

Hint Reference

Hint Picture

Hint Picture button

Hint Audio button

Hint Text

Hint Text button

Background

Child's Name

Elephant

Trial Counter

Help button

Note that the current AVL will determine which elements of the screen are available at any given time.

5.6.3 What is the Initial Functionality of the Comprehension Screen?

Background

The background (including the child's name and elephant) and the trial counter will appear. An image for each trial will appear in the trial counter.

The number of trials matches the number of Trials/Questions that will be presented in the Comprehension Task. This number is determined by the NumberofComprehensionTrials formula listed at the end of this section. The trial counter is designed to let the child know how many Trials/Questions will occur in the Comprehension Task. For each Trial/Question, there will be a corresponding image in the trial counter. Images on the trial counter will appear empty until the corresponding Trial is complete.

As each Trial is completed during the Comprehension Task, the corresponding image on the trial counter will fill in. Images will fill in sequentially from left to right. Fill color will vary based on whether the Trial was Successful or Failed (see Progression Rules).

After the question is asked, the leftmost empty trial will highlight.

Succeeding or Failing Help Message

If the child's Beginning AVL has just been increased, the SucceedingHelp message will play after the background and trial counter have been fully displayed.

If the child's Beginning AVL has just been reduced, the FailingHelp message will play after the background and trial counter have been fully displayed.

Question

The Question will be displayed after the background has been fully displayed unless the SucceedingHelp message has been invoked. In this case, the Question will appear after the SucceedingHelp message has completed.

Visual components: the Question Box will be displayed, including the Question Text for the current question and the Story Icon for the associated Story. The Question Audio button will also appear unless the QuestionAudioAVL is set to Never.

Auditory components: after the visual question components have been displayed, the associated QuestionAudio will play if the QuestionAVL is set to Initial. Otherwise, the QuestionAudio will not play.

the Question Text will highlight and the Question Audio button will visually change from Available to InUse for the duration of the QuestionAudio, at the end of which it will return to Available.

The QuestionAudio cannot be interrupted: mouse clicks made during the audio will be disregarded.

Text: the Question Text will be no longer than 125* characters (including spaces and punctuation) with no more than 25 characters per line and 5 lines. The Fulton font will be used. The font will be no smaller than 18 point. The Text may have Font styling (bold, italics, size, etc) depending on the information in the Assets. Additionally, Sentence Markers may be assigned to appear for some multi-sentence questions. This information will be conveyed in the Assets, but a Sentence Marker should never appear before a single sentence question.

*Note: 125 is the length we've targeted to ensure that all characters will fit in the designated space. There are a few exceptions where the length is longer, but all characters still fit, which is acceptable to us.

Answers

The Answers will be displayed after the Question components have been completely displayed/played.

Visual components: each Answer box will appear one at a time with a slight pause (¼- ½ second) in between each presentation in the following sequence:

1. upper left

2. upper right

3. lower left

4. lower right

If the child's Beginning AVL=AVL 1, only the first two answer boxes will appear. They will contain the CorrectAnswer and the LeastLikelyAnswer. Answers will be randomly assigned to the 2 or 4 answer locations with the following constraints:

Answers will always appear in the same place during a Trial, regardless of how many AVLs are displayed before the Trial is complete.

Each answer box will always include the Answer Text and Answer Response bubble. In addition:

the Answer Audio button will also appear unless the AnswerAudioAVL is set to Never

the Answer Picture will also appear unless the AnswerPictureAVL is set to Never.

the Answer Picture will be the associated AnswerGraphic if the AnswerPictureAVL is set to Initial.

the Answer Picture will be the generic LookCloserGraphic if the AnswerPictureAVL is set to On Demand.

Answer Text will be no more than 40 characters (including spaces and punctuation) with a 2 line maximum and no more than 20 characters per line.

Line breaks will be automatically assigned (based on standard word processing rules) unless the assets contain specific line break information. Text will be centered if it is one line or left justified if it is two lines. The Fulton font will be used and will be no smaller than 18 point.

Hint

The Hint will be displayed after all the Answer components have been completely displayed unless all HintAVLs (HintPicture, HintAudio, HintText) are set to Never. If this is the case, the Comprehension Initial Functionality will be complete after the presentation of the Answer components.

Visual Components:

Hint Reference—the Hint reference will be displayed unless all HintAVLs (HintPicture, HintAudio, HintText) are set to Never.

The image in the Hint Reference thought bubble will be determined by the HintSource. The default HintSource is the Book Cover of the

Current Story. Other possible HintSources are a dictionary, encyclopedia or atlas (images are the cover of each).

Hint Picture—the Hint Picture will only appear if the HintPictureAVL is set to Initial.

Hint Picture button—the Hint Picture button will only appear if the HintPictureAVL is set to On Demand.

Hint Audio button—the Hint Audio button will appear unless the HintAudioAVL is set to Never.

Hint Text—the Hint Text will only appear if the HintTextAVL is set to Initial.

The Hint Text will be no longer than 240 characters (including spaces and punctuation) with no more than 40 characters per line and no more than 6 lines.

The Hint font can be as small as 16 point.

If the HintSource is the Current Story, the Hint Text will be as similar as possible to the text in the Book Display from which it is drawn. This includes features such as sentence markers, punctuation, font color, font size and font styling.

Modifications will be made only when needed to ensure that the text will fit in the Hint Text space or if the selected text requires a punctuation modification (e.g. quotes).

Non-consecutive sentences will appear on the same line, unless a line break is specified.

Additionally, the audio for the hint will be the same as the Story audio for the displayed text. The Hint Text will always contain complete sentences or phrases from the story to ensure that the Story audio can be used in its entirety, although displayed sentences may not be consecutive sentences in the book.

If the HintSource is not the Current Story, the Hint Text styling will be specified in the Assets. The program will automatically assign line breaks in a manner typical to a word processing program.

Hint Text button—the Hint Text button will only appear if the HintTextAVL is set to On Demand.

Font Size Note—the font size for the Question, Answer and Audio text will be dynamic, allowing the largest possible font size while still adhering to the guidelines above (e.g. fits inside designated hint area, matches the story layout). Note that for a given question, the font for each of Answer Text needs to be in the same Font Size. The minimum font size is 18 point.

5.6.4 What is the Normal Functionality for the Comprehension Screen?

Background graphic—the background graphic is inactive; selecting any part of the background graphic will cause no change.

Trial Counter—the trial counter and trial images are inactive; selecting any part of the trial counter will cause no change.

Question Audio button—selecting the Question Audio button causes the QuestionAudio to play.

The Question Text will highlight and the Question Audio button will visually change from Available to InUse for the duration of the QuestionAudio, after which it will return to Available.

The QuestionAudio is not interruptible and mouse clicks made during the audio will be disregarded.

Question Text—selecting any part of the Question Text will cause the same behavior as selecting the Question Audio button (see above) unless the QuestionAudioAVL is set to Never. In this case, selecting the Question Text will cause no change.

Answer Audio button—selecting an Answer Audio button causes the associated AnswerAudio to play. The Answer Text will highlight and the Answer Audio button will change from Available to InUse for the duration of the AnswerAudio, after which it will return to Available. The AnswerAudio is not interruptible and mouse clicks made during the audio will be disregarded.

Answer Text—selecting any part of the Answer Text will cause the same behavior as selecting the Answer Audio button (see above) unless the AnswerAudioAVL is set to Never. In this case, selecting the Answer Text will cause no change.

Answer Picture—

Selecting the Answer Picture when it displays the LookCloserGraphic will cause the associated AnswerGraphic to replace the generic LookCloserGraphic.

Otherwise, selecting the Answer Picture will cause the same behavior as selecting the Answer Audio button (see above) unless the AnswerAudioAVL is set to Never. In this case, selecting the AnswerPicture will not cause the AnswerAudio to play.

Answer Response Bubble

On mouse-over, the response bubble will visually change from Available to Highlighted (Pencil graphic appearing next to the bubble). Selecting the response bubble will change the appearance from Highlighted to InUse and play the SelectionMadeAudio (a ‘click’ or ‘pencil scratch’ sound). The corresponding answer will be submitted with the following behavior:

Correct Answer—if the selected answer was the Correct Answer, the Trial is complete:

The highlighted trial counter will fill in.

If the Trial is evaluated as Successful, the corresponding trial image will fill in with the SuccessColor. A ‘Correct’ sound effect will be heard (ideally, the sound will be pulled randomly from a pool of correct sound effects)

If the Trial is evaluated as Failed, the corresponding trial image will fill in with the FailureColor.

If the Comprehension Task is not done, the next Trial will be presented with the Initial Functionality described above.

If the Comprehension Task is complete, the child will be taken to the Story Menu.

Incorrect Answer

If the selected answer was an Incorrect Answer and the child's Current AVL>1, then the Current AVL will be decreased by 1.

Any images already on the screen will remain visible in their current locations. This includes any On Demand images which have already been explored (On Demand Answer Pictures, On Demand Hint Picture, On Demand Hint Text). The only exception is if the AVL has been decreased to AVL1. In this case two of the answers will be removed. The remaining answers will be the Correct Answer and the Least Likely Answer. These answers will remain in the same screen location as they appeared for the failed AVL.

If additional graphics and/or buttons need to be available as a result of the decreased AVL, these will appear (e.g. if the Hint Picture is On Demand in the lower AVL but was Never Available in the higher AVL, the Hint Picture Button will appear on the screen).

The appropriate FailingHelp message will play followed by any newly ‘initial’ audio as a result of the AVL change (e.g. failing from AVL 5 (where Question audio is OnDemand) to AVL 4 (where Question audio is Initial).

If the selected answer was the Incorrect Answer and the child's Current AVL=AVL 1, then the Correct Answer will be chosen automatically:

The 1^{st} half of the AVL OF FailingHelp message will play followed by the AnswerAudio that corresponds to the Correct Answer. When this is done playing, the program will automatically select the Correct Answer.

The Correct Answer will remain on the screen for an additional 5 seconds after which the corresponding trial image will fill in with the color for incorrect answers.

If the Comprehension Task is not done, the 2^{nd} half of the AVL OF FailingHelp message will play followed by the presentation of the next question with the initial functionality described above.

e.g. ‘The correct answer is Red.’ (correct answer is automatically selected). ‘Let's try another question.’

Where: ‘The correct answer is’=the 1^{st} half of the failing help message ‘Red’=the Correct Answer audio

‘Let's try another question’ =the 2^{nd} half of the failing help message.

If the Comprehension Task is complete, the 2^{nd} half of the AVL 0F FailingHelp message will NOT play, and the child will be taken to the Story Menu.

Hint Reference—the Hint Reference is inactive, selecting it causes no change.

Hint Audio button—selecting the Hint Audio button will cause the entire HintAudio to play.

The Hint Audio button will visually change from Available to InUse for the duration of the HintAudio, after which it will return to Available.

The Hint Audio is not interruptible and mouse clicks made during the audio will be disregarded

If the Hint Text is also displayed, it will highlight sentence by sentence in time with the Hint Audio with the final sentence remaining highlighted until another active area is selected.

Hint Picture button—selecting the Hint Picture button will cause the Hint Picture to be displayed and replace the Hint Picture button. The Hint Picture will remain on the screen until a new Trial is presented.

Hint Picture—selecting the Hint Picture will cause the same behavior as selecting the Hint Audio button unless the HintAudioAVL is set to Never. In this case, selecting the Hint Picture will cause no change.

Hint Text button—selecting the Hint Text button will cause the Hint Text to be displayed and replace the Hint Text button. The Hint Text will remain on the screen until a new Trial is presented.

Hint Text—selecting the words in the Hint Text will cause the selected SentenceAudio to play. The corresponding sentence will highlight for the duration of the SentenceAudio and remain highlighted until another active area is selected.

Help button—selecting the Help button will cause the ComprehensionHelp audio/tutorial to play.

The Help button will visually change from Available to InUse for the duration of the audio, returning to Available when the audio is complete.

If the Help button is selected while InUse, the help audio/tutorial will be interrupted and the button will return to Available.

5.6.5 How Many Comprehension Questions Will There Be Per Book?

The number of total comprehension questions per book will depend on the Comprehension Story Curriculum. The number for a book will be between 0-100 questions.

A book with 0 comprehension questions will never have the Comprehension Activity enabled.

5.6.6 How Many Trials Will There Be in a Comprehension Task?

The number of trials in a Comprehension task will be determined by the NumberofComprehensionTrials formula. This formula is as follows:

Each child will have a numberoftrialspercomprehensiontask value which will currently be determined by the product in use, but in the future will be determined by his/her initial placement results.

This number will give us the top number of trials the child should see in a Task.

For the second grade product, this value is 6. For the first grade product, this value will be 5 . . .etc . . .

The formula is: divide the number of Comprehension Questions in a Story by the numberoftrialspercomrehensiontask value for the child. The resulting number should be increased by 1 if there is a remainder. This will provide the number of Tasks to complete one curriculum cycle. Then distribute the number of questions as evenly as possible across the cycles. e.g.

The Little Yellow Chicken has 14 Comprehension questions.

A child using the second grade product has a numberoftrialspercomprehensiontask value of 6.

14 divided by 6 gives 2 with a remainder. This means it will take 3 Tasks to complete 1 cycle of the Comprehension Curriculum for The Little Yellow Chicken.

The most even distribution of 14 over 3 Tasks is to have 5 questions/trials in each of 2 of the Tasks, and 4 questions/trials in 1 of the Tasks.

Cycle 1: Task 1: Trials 1-4, Questions 1-4

Cycle 1: Task 2: Trials 1-5, Questions 5-9

Cycle 1: Task 3: Trials 1-5, Questions 10-14

5.6.7 The Progression Rules for the Comprehension Questions

Also see the Comprehension Progression Flow Chart, FIG. 2.14.

1) Trial will always begin at the child's Beginning AVL for the Current Story. Trials will continue to be presented until the Comprehension Task is complete.

2) Movement Within a Trial.

a) If the correct answer is selected, the Trial will be complete.

b) If the incorrect answer is selected and the current AVL>AVL1, the Trial will continue. The current AVL will be lowered by 1 (e.g. if incorrect at AVL3, the AVL will be reduced to AVL2) and the child will be able to choose again.

c) If the incorrect answer is selected and the current AVL=AVL1, the Trial will be complete.

3) T rial Evaluation—once a Trial is complete, it will be evaluated:

a) If the Ending AVL<the Beginning AVL, then the Trial is Failed.

b) If the Ending AVL=the Beginning AVL for all AVLs other than AVL1, then the Trial is Successful.

i) If the Beginning AVL=AVL1 and the incorrect answer was selected, the Trial is Failed.

ii) If the Beginning AVL=AVL1 and the correct answer was selected, the Trial is Successful.

4) Change Based on Trial Evaluation

a) If 3 of 3 or 3 of 4 Consecutive Trials are Successful, the program will attempt to increase the child's Beginning AVL by 1.

i) If the child's Beginning AVL=AVL7 then the Beginning AVL cannot be increased. In this case, no change will be made.

ii) If a change is made to the Beginning AVL, the Consecutive Trial History will be reset.

b) If 2 out of 2 or 2 out of 3 Consecutive Trials are Failed, the program will attempt to decrease the child's Beginning AVL to the highest Ending AVL from the 2 Failed Trials.

i) If the child's Beginning AVL=AVL1 then the Beginning AVL cannot be decreased. In this case, no change will be made.

ii) If a change is made to the Beginning AVL, the Consecutive Trial History will be reset.

Consecutive Trials can include questions from the current story from a previous Task or session in the Comprehension Activity.

5) Movement Between Trials—at the completion of a Trial, the next Trial will be presented if the Comprehension Task is not complete. The questions will have a set order for each book, and Trials will progress sequentially through this order.

6) Curriculum Recycling

a) Once the child completes the Trial that presents the final comprehension question in a Story's Curriculum, then Curriculum Recycling will be invoked.

i) The program will compare the child's current Beginning AVL to the highest Ending AVL during the most recent traversal of the Story's Curriculum. The new Beginning AVL will become the higher of the two AVLs. The new Beginning AVL will never be lowered as a result of a change due to the Curriculum.

ii) If Curriculum Recycling is invoked at the same time as a Change Based on Trial Evaluation, both rules will be evaluated and the child's new Beginning AVL will become the higher of the two AVLs.

iii) If a change is made to the Beginning AVL, the Curriculum History will be reset.

b) The Story Curriculum will begin again—the next Trial will present Question 1 at the appropriate Beginning AVL.

5.6.7.1 Progression Rules Example

For a child who starts with Beginning AVL 4 in a curriculum with 10 questions per story:

| | Current | Correct/ | |
|---|---|---|---|
| Trial | AVL | Incorrect | |
| 1 | 4 | + | |
| 2 | 4 | + | |
| 3 | 4 | + | |
| | | | The Beginning AVL is increased by 1 because 3 |
| | | → | of 3 Consecutive Trials were answered correctly. |
| | | | History is ‘cleared’. |
| 4 | 5 | + | |
| 5 | 5 | + | |
| 6 | 5 | − | |
| ″ | 4 | − | |
| ″ | 3 | + | |
| 7 | 5 | + | |
| | | | The Beginning AVL is increased by 1 because 3 of |
| | | → | 4 Consecutive Trials were answered correctly. |
| | | | History is ‘cleared’. |
| 8 | 6 | − | |
| ″ | 5 | + | |
| 9 | 6 | − | |
| ″ | 5 | − | |
| ″ | 4 | + | |
| | | | The Beginning AVL is reduced to AVL5 because 2 |
| | | → | Consecutive Trials were answered incorrectly at the |
| | | | Beginning AVL, and the highest Ending AVL was AVL 5 |
| | | | (trial #8). History is ‘cleared’. |
| 10 | 5 | + | |
| | | | Final question—Curriculum Recycling is Invoked. |
| | | | The Beginning AVL remains at AVL5 because that is |
| | | → | the highest Ending AVL the child reached when |
| | | | answering questions 1-10. Because no change is |
| | | | made, the History is not ‘cleared’. |
| 1 | 5 | − | |
| ″ | 4 | − | |
| ″ | 3 | − | |
| ″ | 2 | − | |
| ″ | 1 | − | |
| | | → | Correct answer is given. |
| 2 | 5 | − | |
| Etc . . . | | | |

5.7 Vocabulary

There are two kinds of Vocabulary Tasks: Assessment and Instructional.

Depending on the choices the teacher makes, the child will either have the Instructional Vocabulary task available for books at any time, or the child will have the Vocabulary task tied to the Featured book schedule. In this setting, the Assessment Vocabulary task is given to the child when a book is first made the Featured book. After this ‘pre-test’ is complete, the Instructional Vocabulary task becomes available to the child for that book. After a set time period, the child will once again be given the Assessment Vocabulary task for the book as a ‘post-test’. The Instructional Vocabulary task continues to be available.

5.7.1 Instructional Vocabulary Task (Instructional)

5.7.1.1 What is Displayed on the Vocabulary Screen?

[See FIG. 2.12]. Note the following regarding this figure:

| | |
|---|---|
| Target Text | 2-4 Responses each with: |
| Target Audio button | Response Bubble |
| Target Context Icon | Response Audio button |
| Target Context Text | Response Text |
| Target Context Audio button | Response Definition Icon |
| Help button | Response Definition |
| Lesson Information | Child's Name |
| Trial Counter with 4 or 8 Trial Symbols | |

5.7.1.2 What is the Initial Functionality of the Instructional Vocabulary Task?

Background

The background (including the Target box, Elephant, Lesson Information and Child's Name) and the Trial Counter will appear. An image for each trial will appear in the Trial Counter.

The number of Trials will be either 4 or 8 and will be determined by the child's

NumberofTrials value.

The Trial Counter is designed to let the child know how many Trials will occur in the VocabularyTask. For each Trial there will be a corresponding image in the Trial Counter. Images on the Trial Counter will appear empty or highlighted until the corresponding Trial is complete.

At the beginning of each Trial, the leftmost empty trial-will highlight.

As each Trial is completed during the Vocabulary Task, the corresponding image on the Trial Counter will fill in. Images will fill in sequentially from left to right. Fill color will vary based on whether the Trial was Successful or Failed.

Target

Visual Components—depending on the current AVL, the following Target Elements can appear:

Target Audio button—the Target Audio button will appear unless the TargetAudioAVL is set to Never.

Target text—the Target text will appear unless the TargetAVL is set to Never. The text will appear in the Fulton font at 24 point size with a limit of 12-15 characters.

Target Context icon—the Target Context icon will appear if the TargetContextAVL is set to OnDemand.

Audio Components—after the visual components have been displayed:

Any appropriate SucceedingHelp message will play (see the SucceedingHelp messages later in the document).

The associated InitialVocabulary audio will play depending on the type of question being asked (e.g. ‘Which word means the same as’ or ‘Which word means the opposite of’). The TargetAudio will follow if the TargetAudioAVL is set to Initial (e.g. ‘buy’).

The Target Audio button will change from Available to InUse for the duration of the TargetAudio. The Target Audio button will remain InUse until any other Initial TargetAudio has finished playing, at which time it will return to Available.

The Target text will highlight as the TargetAudio is played, returning to an unhighlighted state at the conclusion of the audio.

This audio is not interruptible and mouse clicks made during this time will be disregarded.

Responses

Visual Components—any of the following elements can appear for each of the 2 or 4 available Responses:

Response Text—the Response Text will appear unless the ResponseAVL is set to Never. The text will appear in the Fulton font at 24 point size with a limit of 12 characters.

Response Audio button—The Response Audio button will appear unless the ResponseAudioAVL is set to Never.

Response Definition Icon—the Response Definition Icon will appear if the ResponseDefinitionAVL is set to OnDemand.

Response Bubble—a Response Bubble will appear next to each of the two or four Responses.

5.7.1.3 What is the Normal Functionality of the Instructional Vocabulary Task?

Target—selecting part of the Target box other than those listed below will cause no change.

Target Audio button—selecting the Target Audio button causes the InitialVocabulary audio to play, followed by the TargetAudio.

The Target text will highlight for the duration of any TargetAudio, after which it will return to an unhighlighted state.

The Target Audio button will visually change from Available to InUse for the duration of the TargetAudio, after which it will return to Available.

The TargetAudio is not interruptible and mouse clicks made during the audio will be disregarded.

Target text—selecting the Target text will cause the TargetAudio to play unless the TargetAudioAVL is set to Never. In this case, selecting the Target text will not cause the TargetAudio to play. The Target Text will always be a single word from the associated story. Target text will appear in Fulton Font at 24 point size.

Target Context Icon—selecting the Target Context Icon will cause the following:

the Target Context Icon will change briefly from Available to InUse and then will become NotVisible.

the Target Context Text and Audio button will appear as Available.

the TargetContextAudio will play unless the TargetContextAudioAVL is Never (in which case nothing more will happen).

the Target Context Audio button will visually change from Available to InUse for the duration of the audio, after which it will return to Available.

the Target Context Text will highlight for the duration of the audio, after which it will return to an unhighlighted state.

The TargetContextAudio is not interruptible and mouse clicks made during the audio will be disregarded.

Target Context Audio button—selecting the Target Context Audio button will cause the following:

the TargetContextAudio will play.

the Target Context Audio button will visually change from Available to InUse for the duration of the audio, after which it will return to Available.

the Target Context Text will highlight for the duration of the audio, after which it will return to an unhighlighted state.

The TargetContextAudio is not interruptible and mouse clicks made during the audio will be disregarded.

Target Context Text—selecting the Target Context Text will cause the same effect as selecting the Target Context Audio button (see above) unless the TargetContextAudioAVL is Never. In this case, selecting the text will cause no change. The Target Context Text will appear in the Fulton font at 18 point size. No more than 6 lines with 20 characters a line will appear. The Target word in the Target Context Text will appear bolded/italicized.

Responses—selecting any part of the Responses not listed below will cause no change.

Response Audio button—selecting the Response Audio button causes the ResponseAudio to play.

The Response text will highlight for the duration of any ResponseAudio, after which it will return to an unhighlighted state.

The Response Audio button will visually change from Available to InUse for the duration of the ResponseAudio, after which it will return to Available.

The ResponseAudio is not interruptible.

Response bubble—selecting the Response bubble will submit the associated Response as the answer.

The Response bubble will briefly change from Available to InUse once it has been selected.

Response text—selecting the Response text will cause the same behavior as selecting the Response Audio button (see above) unless the ResponseAudioAVL is set to Never. In this case, selecting the Response Whole text will not cause the ResponseAudio to play.

Response Definition Icon—selecting a Response Definition Icon will cause the following:

the Response Definition Icon will change briefly from Available to InUse and then will become NotVisible.

the Response Definition will appear.

the ResponseAudio followed by the ResponseDefinitionAudio will play if the ResponseDefinitionAudioAVL is not Never (in which case nothing more will happen).

the ResponseText will highlight for the duration of the ResponseAudio, after which it will return to unhighlighted state.

the ResponseDefinitionText will highlight for the duration of the ResponseDefinitionAudio, after which it will return to an unhighlighted state.

the Response Audio button will change from Available to InUse for the duration of all Response and ResponseDefinition audio, after which it will return to Available.

This audio is not interruptible, and mouse clicks made during the audio play will be disregarded.

Response Definition Text—selecting the Response Definition text causes the following unless the ResponseDefinitionAudioAVL is Never (in which case nothing will happen):

the ResponseAudio followed by the ResponseDefinitionAudio will play.

the ResponseText will highlight for the duration of the ResponseAudio, after which it will return to unhighlighted state.

the ResponseDefinitionText will highlight for the duration of the ResponseDefinitionAudio, after which it will return to an unhighlighted state.

the Response Audio button will change from Available to InUse for the duration of all Response and ResponseDefinition audio, after which it will return to Available.

this audio is not interruptible, and mouse clicks made during the audio play will be disregarded.

the Response Text will appear in the Fulton font at 16 pt size. A maximum of 3 lines can appear containing 30 characters per line.

Help button—selecting the Help button will cause the appropriate VocabularyHelp audio/tutorial to play.

The VocabularyHelp audio/tutorial may change based on whether the current trial is a synonym or antonym question.

The Help button will visually change from Available to InUse for the duration of the audio, returning to Available when the audio is complete.

If the Help button is selected while InUse, the help audio/tutorial will be interrupted and the button will return to Available.

5.7.1.4 What Happens When an Answer is Submitted?

When an answer is submitted, it will be evaluated for correctness, and subsequent actions will occur as listed below:

Correct Answer—if the submitted answer was the Correct Answer, the Trial is complete:

The highlighted trial counter will fill in.

If the Trial is evaluated as Successful, the corresponding trial image will fill in with the SuccessColor. A ‘Correct’ sound effect will be heard.

If the Trial is evaluated as Failed, the corresponding trial image will fill in with the FailureColor.

If the Vocabulary Task is not complete, the next Trial will be presented with the Initial Functionality described above.

If the Vocabulary Task is complete, the child will be taken to the Story Menu screen.

See the Progression rules for how to determine if a Trial was Successful or Failed.

Incorrect Answer

If the submitted answer was an Incorrect Answer and the child's Current AVL>1 then the Current AVL will be decreased by 1.

Any images already on the screen will remain visible in their current locations. This includes any On Demand images that have already been explored Note: the only exception to this is if the child's AVL is reduced to AVL 1, the number of Responses will be reduced to two.

If additional graphics and/or buttons need to be available as a result of the decreased AVL, these will appear.

The appropriate FailingHelp message will play.

See the FailingHelp section later in this document.

If the submitted answer was the Incorrect Answer and the child's Current AVL=AVL 1, then the Correct Answer will be chosen automatically:

The 1^{st} half of the AVL1 FailingHelp message will play followed by the ResponseAudio that corresponds to the Correct Response. When this is done playing, the program will automatically select the Correct

Response. The Correct Response will remain on the screen for an additional 5 seconds after which the corresponding trial image will fill in with the color for incorrect answers.

If the Vocabulary Task is not complete, the 2^{nd} half of the AVL1 FailingHelp message will play followed by the presentation of the next question with the initial functionality described above.

e.g. ‘The correct answer is purchase.’ (correct answer is automatically selected). ‘Let's try another question.’

Where: ‘The correct answer is’ the 1^{st} half of the failing help message ‘Purchase’=the Correct Answer audio ‘Let's try another question’=the 2^{nd} half of the failing help message.

If the Vocabulary Task is complete, the 2^{nd} half of the AVL1 FailingHelp message will NOT play and the child will be taken to the Story Menu screen.

5.7.1.5 How are Questions Ordered?

Each book/chapter will have a Vocabulary curriculum consisting of eight questions. These Questions will each be presented once in a random order for a Task with eight Trials. If a Task only has four Trials, the questions will be presented randomly in groups of four, making sure that all 8 questions are cycled through before any are repeated.

5.7.1.6 How are the Responses Ordered?

Each question will have four responses. Depending on the AVL, the child will either see two of these responses, or all four. The responses will be ordered randomly on the screen. When only two are displayed, they will be the correct response and the least-likely response.

5.7.1.7 How are the Vocabulary Instructions Determined?

Each Vocabulary Question will have a QuestionType. This will either be Synonym or Antonym. The QuestionType determines which Instructions are used.

QuestionType=Synonym. Instructions ‘Find the word that means the same as’

QuestionType=Antonym. Instructions=‘Find the word that means the opposite of’

5.7.1.8 Which Audio Files are Used?

The Audio files for the Target word and Target Context will come from the Story Speaker. The specific files will be designated in the Vocabulary Assets.

The Audio files for the Response words and Response Definitions will be the Elephant Speaker (Karen). The specific files will be designated in the Vocabulary Assets.

Progression Rules

1) A Trial will always begin at the child's Beginning AVL for the Current Story. Trials will continue to be presented until the Vocabulary Task is complete.

2) Movement within a Trial.

a. If the correct answer is selected, the Trial will be complete.

b. If the incorrect answer is selected and the current AVL>AVL1, the Trial will continue. The current AVL will be lowered by 1 (e.g. if incorrect at AV3, the AVL will be reduced to AVL2) and the child will be able to choose again.

c. If the incorrect answer is selected and the current AVL=AVL1, then the Trial is complete.

3) Trial Evaluation—once a Trial is complete, it will be evaluated:

a. If the Ending AVL<the Beginning AVL, then the Trial is Failed.

b. If the Ending AVL=the Beginning AVL for all AVLs other than AVL1, then the Trial is Successful.

i. If the Beginning AVL=AVL1 and the incorrect answer was selected, the Trial is Failed.

ii. If the Beginning AVL=AVL1 and the correct answer was selected, the Trial is Successful.

4) Change Based on Trial Evaluation

a. If 3 of 3 or 3 of 4 Consecutive Trials are Successful, the program will attempt to increase the child's Beginning AVL by 1.

i. If the Child's Beginning AVL=AVL4 then the Beginning AVL cannot be increased. In this case, no change will be made.

ii. If a change is made to the Beginning AVL, the Consecutive Trial History will be reset.

b. If 2 out of 2 or 2 out of 3 Consecutive Trials are Failed, the program will attempt to decrease the child's Beginning AVL to the highest Ending AVL from the 2 Failed Trials.

i. If the child's Beginning AVL=AVL1 then the Beginning AVL cannot be decreased. In this case, no change will be made.

ii. If a change is made to the Beginning AVL, the Consecutive Trial History will be reset. Consecutive Trials can include questions from the current book/chapter from a previous Task or Session in the Vocabulary Sub-Activity.

5) Movement Between Trials—at the completion of a Trial, the next Trial will be presented if the Vocabulary Task is not Complete.

6) Movement Between Tasks—at the completion of a Task, the child will be returned to the Story Menu.

What are the Instructional Vocabulary AVLs?

Instructional Vocabulary AVL 1

| | | Target | | Response |
|---|---|---|---|---|
| | Target | Context | Response | Definition |
| Text | Initial | OnDemand | Initial | OnDemand |
| Audio | Initial | OnDemand | OnDemand | OnDemand |

Note: at AVL 1, only two responses will be presented.

Instructional Vocabulary AVL 2

| | | Target | | Response |
|---|---|---|---|---|
| | Target | Context | Response | Definition |
| Text | Initial | OnDemand | Initial | OnDemand |
| Audio | Initial | OnDemand | OnDemand | OnDemand |

Note: at AVLs 2-4, four responses will be presented.

Instructional Vocabulary AVL 3

| | | Target | | Response |
|---|---|---|---|---|
| | Target | Context | Response | Definition |
| Text | Initial | OnDemand | Initial | OnDemand |
| Audio | Never | OnDemand | Never | OnDemand |

Note: at AVLs 2-4, four responses will be presented.

Instructional Vocabulary AVL 4

| | | Target | | Response |
|---|---|---|---|---|
| | Target | Context | Response | Definition |
| Text | Initial | OnDemand | Initial | OnDemand |
| Audio | Never | Never | Never | Never |

Note: at AVLs 2-4, four responses will be presented.

5.7.2 Instructional Vocabulary Task (Assessment)

The Assessment Vocabulary Task differs from the Instructional Task in the following ways:

Instead of having four AVL levels, there will only be two AVL levels. These will be AVL2 and AVL4 from the Instructional Vocabulary Task.

The child's Pre-Test will be given at AVL2 (Audio) UNLESS the teacher has altered this setting through Enroll to AVL 4 (Print).

The AVL will remain constant for an entire test (8 trials).

The child's score on the Pre-Test will determine the AVL to be used for the Post-Test for the same book:

If the Pre-test is given at AVL2 (Audio) and

the child gets between X %-100% correct, the Post-Test will be at AVL4 (Print).

the child gets less than or equal to X % correct, the Post-Test will be at AVL2 (Audio).

If the Pre-test is given at AVL4 (Print) and

the child gets between X %-100% correct, the Post-Test will not be given automatically.

the child gets between X %-Y % correct, the Post-Test will be at AVL4 (Print).

the child gets less than or equal to Y % correct, the Post-Test will be at AVL2 (Audio).

The teacher may also be allowed to schedule a Follow-Up test (one that would occur after the Post-Test). The AVL for the Follow-Up Test will either be determined by the teacher at the time she schedules the Follow-Up Test, or will be automatically determined using the same rules described above except that the rules will be based on the results of the Post-Test rather than the Pre-Test.

The child will not get any feedback that would indicate if s/he has selected the correct answer. This means the trial counter symbols will fill in with either a neutral color or the same color, there will be no failing help messages, and there will be no success sound effects. Additionally, if the child gets the wrong answer at AVL2 (Audio), the program will NOT provide the correct answer.

5.8 Miscellaneous: Variations for Different Products Present and Future

Currently, we have 4 different products: Pre-K, Kindergarten, 1^{st} Grade, and 2^{nd} Grade (being developed). These products share many similarities, with a few differences in User Interface and automatic settings. Our goal is to design the code to allow us to build each of these separate products with as little re-writing as possible, and at the same time, prepare for a future product which is actually a combination of all our current grade levels.

This spec refers to the AssessedGrade and ActualGrade of an individual child. Currently each of these values can be determined by the Grade Level of the product in use. However, the distinction between these values will become important when we combine products into one large product that spans grades. The following list summarizes the features detailed in this specification that involve either the ActualGrade or AssessedGrade of a child.

Features that will depend on the ActualGrade of the child

note: currently, the ActualGrade of the child is determined by the product the child is using (e.g. if the child is using the 2^{nd} Grade Product, the child's ActualGrade=2^{nd} Grade). In the future, this value will be determined by a setting in Enroll reflecting the child's physical grade.

User Interface for Entry screens (Color Selection, Name Selection)

User Interface for Activity Selection screen

User Interface for Theme Selection screen

User Interface for Book Selection screen

Backgrounds for Story Menu, Preview, Story Pages and Comprehension screens Features that will depend on the AssessedGrade of the child

note: currently, the AssessedGrade of the child is determined by the product the child is using (e.g. if the child is using the 2^{nd} Grade Product, the child's AssessedGrade=2^{nd} Grade). In the future, this value will be determined by a setting in Enroll reflecting the grade level at which the child is performing or perceiving.

Initial and Whole audio interruptability

Bookmarking

NumberofTimesRead default value to automatically enable the Tell mode.

NumberofTimesRead default value to automatically enable the Comprehension activity.

Number of Questions in a Comprehension Task (range is 1-20) Initial Beginning AVL for Comprehension.

Core Books vs. Resource Books

Another note for the future: in a combined product, we will want to introduce the notion of ‘core books’ for each grade level. These will be some portion of the current books assigned to each grade level. This number would ideally be around 36 books. The remainder of the books from each grade level, as well as all the books from the other grade level products, would be available as resource or supplementary books. Books will be assigned levels so that we can systematically offer children additional books at appropriate levels of difficulty.

5.8.1 Comprehension AVLs

[See FIG. 2.13].

5.8.2 Comprehension Succeeding and Failing Help Messages

Succeeding Help Messages

AVL 2S (Beginning AVL has just been increased to AVL2):

Great job. Now you get to see more choices.

AVL 3S (Beginning AVL has just been increased to AVL3):

Excellent work. You can still press the hints if you need help.

AVL 4S (Beginning AVL has just been increased to AVL4):

You're doing such a great job, you don't need so many hints.

AVL 5S (Beginning AVL has just been increased to AVL5):

Wonderful work. Try to read the answer first. Press the words if you need to hear them.

AVL 6S (Beginning AVL has just been increased to AVL6):

Great job reading. Press the question if you need to hear it again.

AVL 7S (Beginning AVL has just been increased to AVL7):

Congratulations. You're reading and thinking so well. Maybe you don't need any more clues.

Failing Help Messages

AVL 0F (AVL1 was just failed and AVL is re-presented):

1^{st} Half. The correct answer is . . .

2^{nd} Half. Let's try another question.

AVL 1F (AVL2 was failed and AVL1 is presented OR Beginning AVL has just been reduced to AVL1):

Listen to the question. look at the two answers. Listen to each one. Choose the best one.

AVL 2F (AVL3 was failed and AVL2 is presented OR Beginning AVL has just been reduced to AVL2):

Look at the words in the hint box. Look at the words in the answer boxes. Press these words to hear them spoken.

AVL 3F (AVL4 was failed and AVL3 is presented OR Beginning AVL has just been reduced to AVL3):

Press the Hint buttons for to hear some clues.

AVL 4F (AVL5 was failed and AVL4 is presented OR Beginning AVL has just been reduced to AVL4):

Press the picture box to see some clues.

AVL 5F (AVL6 was failed and AVL5 is presented OR Beginning AVL has just been reduced to AVL5):

Press the answers to hear them spoken.

AVL 6F (AVL7 was failed and AVL6 is presented OR Beginning AVL has just been reduced to AVL6):

Press the question box to hear the question.

5.8.3 Comprehension Progression Flow Chart

[See FIG. 2.14].

6 SPEC B: Explore Words, Spelling Activity Specification

6.1 Structural Activities Overview

Structural Activities—the Explore Words Activity and all of the Alphabet sub-activities are considered Structural Activities. There are 5 of these Structural Activities in the BTL program: Explore Words, Alphabet: Alphabet Recognition, Alphabet: Listen to Sounds, Alphabet: Spelling: Auto Curriculum, Alphabet: Spelling: Free Choice.

Each Structural Activity has it's own combination of Skills, Progression Rules, and separate Curricula.

Each Structural Activity is made up of several Skills, which can be categorized by one of the four Lesson Tasks.

Structural
Activities

| Activity: | | Preparation | | Performance | |
|---|---|---|---|---|---|
| Subactivity: | | Lesson Tasks | | Lesson Tasks | |
| Mode | Skill | Practice | Selection | Matching | Sequencing |
| Explore | Practice | X | | | |
| Words | | | | | |
| Explore | Listen | | | X | |
| Words | | | | | |
| Explore | Blend | | | X | |
| Words | | | | | |
| Explore | Segment | | | X | |
| Words | | | | | |
| Explore | Identify | | | X | |
| Words | | | | | |
| Explore | Order | | | | X |
| Words | | | | | |
| Explore | Word | | | X | |
| Words | Rec | | | | |
| Alphabet: | Letter | | X | | |
| Alphabet | Selection | | | | |
| Recognition | | | | | |
| Alphabet: | Dynamic | | | X | |
| Alphabet | Lesson | | | | |
| Recognition | | | | | |
| Alphabet: | Practice | X | | | |
| Listen to | | | | | |
| Sounds | | | | | |
| Alphabet: | Listen to | | | X | |
| Listen to | Sounds | | | | |
| Sounds | | | | | |
| Alphabet: | Practice | X | | X | |
| Spelling | | | | | |
| Auto | | | | | |
| Curriculum | | | | | |
| Alphabet: | Identify | | | X | |
| Spelling | | | | | |
| Auto | | | | | |
| Curriculum | | | | | |
| Alphabet: | Spelling | | | | X |
| Spelling | | | | | |
| Auto | | | | | |
| Curriculum | | | | | |
| Alphabet: | Word | | X | | |
| Spelling | Selection | | | | |
| Free Choice | | | | | |
| Alphabet: | Spelling | | | | X |
| Spelling | | | | | |
| Free Choice | | | | | |
| Alphabet: | Word | | | X | |
| Spelling | Rec | | | | |
| Free Choice | | | | | |

Skills—a Skill is a descriptor for the specific kind of structural concept a child is working on. Each Skill falls under one of the four Lesson Task groupings, which describe common behavior/functionality across the similar Skills. A Skill represents one task the child must do and usually contains several trials.

Lesson Tasks—there are four kinds of Lesson Tasks: Practice, Selection, Matching and Sequencing. Each of these can be described as either Preparation or Performance Tasks. Each of the four represent a different kind of general task the child must perform in the Structural Activities. Each Skill is categorized as one of the Lesson Task types.

Preparation Tasks—there are two Preparation Tasks: Practice and Selection. Both share in common the fact that the child's actions are not judged.

Practice Task—a Practice task gives the child a chance to preview each of the coming stimuli without being judged (though behavior is recorded). The child can explore the stimuli whole, parts and/or make or replay recordings. Practice Tasks in Explore Words and Alphabet Activities are made up of 4 or 8 Trials.

Selection Task—a Selection task allows a child to practice with many stimuli, as well as choose a select number of stimuli to be used in the upcoming lesson. As with the Practice task, Selection tasks are not judged (though behavior is recorded). The child can explore stimuli and/or make and replay recordings. Selection Tasks are not made up of Trials. However, in order to go on to a subsequent Performance Task, the child must select 4 or 8 stimuli from a Selection Task.

Note: Selection tasks only occur in the Alphabet Activity.

Performance Tasks—there are two Performance Tasks: Matching and Sequencing. These tasks share in common the fact that the child's responses are judged and the resulting actions of the program are based on the child's performance.

Matching—Matching is a perceptual activity which requires the student to match a Target stimulus to a Response stimulus. The format of this task provides the child with a single Target and several Responses. The child's selections are judged, and his/her level of success determines which Progression Rules will be invoked. Matching Tasks are made up of 4 or 8 Trials.

Sequencing—Sequencing is a production activity which requires the student to assemble or construct the Parts of a stimulus to re-create the Target. The format for this task provides the child with a single Target, and then parts from both the Target and other stimuli from which to create the correctly ordered Target. The child's selections are judged, and his/her level of success determines which Progression Rules will be invoked. Sequencing Tasks are made up of 4 or 8 Trials.

Trials—a Trial is a sub-portion of a Task (except the Selection Task). In the Practice Task, a Trial begins when a stimulus is presented and ends when a new stimulus is selected (or the Practice screen is exited). In either of the Performance Tasks, a Trial begins when a Target stimulus is presented, and ends when the correct response is submitted (by the child or the program). Note that in Performance Tasks, a single Trial can traverse several AVLs.

Lessons—a Lesson is the name for the combination of a Wordlist, Language Unit, AVL Set and Available Skills (all determined by elements in the Curriculum or manipulations by the Teacher) and the Enabled Skills, numberofresponses and numberoftrials values (all determined by the child's settings and Progression Rules). A Lesson always begins with a Preparation Task, which is followed by one or more Performance Tasks.

Curriculum—Structural Activities containing Selection tasks do not have a set curriculum (instead, curriculum is dynamically generated—see the Alphabet Spec). All other Structural Activities, however, have unique, linearly designed Curricula. The Curriculum for each contains Wordlists. These may be grouped into Objectives, which in turn may be further grouped into Concepts, Developmental Level Sections and Developmental Levels.

Curriculum Structure

[See diagram of FIG. 3.1]

Developmental Level—a Developmental Level is a group of 4 Developmental Level Sections. A Developmental Level exists for each of the grades covered by the product. Currently there are four: A, B, C and D (which roughly correspond to the grades Pre-K, Kindergarten, First and Second). Developmental Levels only apply to the Explore Words Curriculum.

Developmental Level Sections—a Developmental Level Section is a grouping of Concepts containing language concepts appropriate for a particular developmental level (or grade) during a portion of the school year. Developmental Level Sections only apply to the Explore Words Curriculum.

Concept—a concept is a group of Objectives which share a similar level of difficulty.

Objective—an Objective is a group of Wordlists that share a similar language focus or learning objective. Objectives are assigned a Language Unit, AVL Set and Available Skills . These provide additional information about how the Wordlist content will be displayed. Objectives will also have associated Descriptions which will help identify to the teacher what the child is working on for each Objective.

Wordlists—a Wordlist is a group of stimuli that provide the content for a Lesson. Wordlists have the following structure:

| | | | Contrast Set A | Contrast Set B |
|---|---|---|---|---|
| | | Contrast pair 1: | stimulus 1a | stimulus 1b |
| 1^{st} Wordlist ½ | {open oversize brace} | | | |
| | | Contrast pair 2: | stimulus 2a | stimulus 2b |
| | | Contrast Pair 3: | stimulus 3a | stimulus 3b |
| 2^{nd} Wordlist ½ | {open oversize brace} | | | |
| | | Contrast Pair 4: | stimulus 4a | stimulus 4b |

There are wordlist rules which dictate how to the program interacts with this structure (see page 8).

Stimulus: a stimulus refers to a word, sentence or phrase (e.g. ‘cat’, ‘Pet the cat.’, ‘white cat’). ‘Atomic Stimuli’ is our identifier for single words. ‘Compound Stimuli’ is our identifier for sentences or phrases.

Each atomic stimulus has a phonemic text string and native text string associated with it. These strings provide pronunciation information as well as map letters with tokens (sounds). See Spec A.

Each stimulus can be displayed as a whole: compound stimuli will be sentences or phrases while atomic stimuli will be words.

Each stimulus can be displayed as parts: compound stimuli can be broken into words, while atomic stimuli can be broken into syllables, onset/rimes, tokens and letters.

There can be audio and graphic files associated with each stimulus whole, and audio files associated with each of the stimulus parts. In addition, phonemes each have their own associated graphic file (Mouthpostures), which are called for in special cases.

Token: tokens are found in a word's Phonemic Text. A token most often contains a single phoneme (sound) that corresponds to one or more letters in a word. Sometimes, however, a token will contain several phonemes (sounds) which must be grouped together either because a single letter requires two sounds (e.g. ‘x’) or because a spelling convention reverses the order of letters compared to the corresponding sounds in the word's pronunciation (e.g. ‘iron’). e.g.

Native Text: b_o_x

Phonemic Text: b_ah_k,s

The tokens=‘b’, ‘ah’, and ‘k,s’ where the tokens ‘b’ and ‘ah’ consist of single

phonemes and the token ‘k,s’ consists of two phonemes ‘k’ and ‘s’.

Phoneme: phonemes represent individual, unique sounds used in our language. Phonemes can be grouped together into tokens to allow a one to one match between the sounds in a word and the spelling of the word.

Mouthpostures: Mouthpostures refer to pictures of mouths representing the articulatory positions required to make sounds. Mouthpostures are used primarily in Alphabet, but will occasionally appear in Explore Words. There is one Mouthposture for each phoneme.

Native Text: the Native Text is a means for representing the standard spelling of a word while noting breaks between sounds, syllables and syllabic stress. There must be a one to one match between the groups of letters in the Native Text and the Tokens in the Phonemic Text. See Spec A.

Phonemic Text: the Phonemic Text is a means for representing the pronunciation of a word. The Phonemic Text is comprised of Tokens which are made of Phonemes. There must be a one to one match between the Tokens in the Phonemic Text and the groups of letters in the Native Text. See Spec A. e.g.

| | |
|---|---|
| Word: | Shades |
| Native Text: | Sh_a_de_s |
| Phonemic Text: | sh_ay_d_z |

Language Unit—there are X Language Units. Each Language Unit name contains several pieces of information in the following order: Language Unit Type, Focus and Highlighting Used. Additionally, Sounds Language Units can have the distinction of being Blended.

E.g. The Language Unit ‘SentencesFinalWordHighlightingOn’ is of the Sentences Type, specifically focused on the final word in each sentence and Highlighting will be used. The Language Unit ‘SoundslnitialSecondSylHighlightingOff’ is of the SoundsInitial Type, specifically focused on the initial sound in the second syllable, Mouthpostures will be used as pictures but there is no Highlighting and no Blending.

Language Unit Types—There are 7 Language Unit Types. The Language Unit Type describes how a stimulus will be broken into parts.

See chart below.

| Language Unit | Whole | | | | | | |
|---|---|---|---|---|---|---|---|
| Type | Definition | Parts Definition | Whole example | Parts example | | | |
| Sentences | The entire | The individual words. These are | A cat is outside | A | cat | is | outside. |
| | sentence, | separated by spaces in the | See the cat. | See | the | cat. | |
| | phrase or | Compound stimulus name. | One cat | one | cat | | |
| | word. | | Cat | cat | | | |
| Syllables | The entire | The syllables. These are separated | Cat | cat | | | |
| | word. | by + signs in the atomic stimulus | Catfish | cat | fish | | |
| | | native and phonemic text strings. | Cattle | cat | tle | | |
| | | | Caterpillar | cat | Er | pil | lar |
| Onset/Rime | The entire | The Onset (sound(s) before the | Cat | c | at | | |
| | 1 syllable | vowel), and the Rhyme (the rest of | Chat | ch | at | | |
| | word. | the word). | Scratch | scr | atch | | |
| SoundsInitial * | The entire | Each token. Tokens are separated | Eye | eye | | | |
| SoundsFinal * | word. | by _ and + signs in the phonemic | Cat | c | a | t | |
| SoundsVowel * | | and native text strings. | Iron | i | ro | n | |
| | | | Scratch | s | c | r | a tch |
| Letters | The entire | Each letter as represented in the | I | I | | | |
| | word. | native text string. | Cat | c | a | t | |
| | | | Chat | c | h | a | t |
| | | | Coat | c | o | a | t |
| | | | Scratch | s | c | r | a t c h |

Note the 3 Sounds Types are all broken apart identically—the distinction between the three is important for tracking associated skill enablement.

Blending—for any of the three Sounds Language Unit Types (SoundsInitial, SoundsFinal, SoundsVowel), the characteristic Blending can be assigned. When this characteristic is assigned, the breakdown of the words changes slightly for all skills except Ordering (which remains the same as when there is no blending). Instead of separating each sound, consonants occurring in the initial or final position relative to the vowel in a syllable will be grouped. E.g.

| | Phonemic | without | with |
|---|---|---|---|
| Word | Code | Blending | Blending |
| Eye | Ai | Eye | eye |
| Cat | k_ae_t | c a t | c a t |
| Scratch | s_k_r_ae_ch | s c r a tch | scr a tch |
| Screwdriver | s_k_r_oo+ | s c r ew d r i v e r | scr ew dr i v e r |
| | d_r_ai+v_u_r | | |
| | r | | |

Language Unit Focus—There are a number of Foci for each Language Unit Type. The Language Unit Focus describes specifically what content is being focused on within the general Language Unit. Besides being a naming convention, this information is used in two specific ways:

Highlighting—when a Language Unit includes Highlighting, the Language Unit Focus provides the information for what is to be highlighted. For instance, if the Language Unit Focus is ‘SecondSyllable’ and Highlighting is being used, the second syllable of each word will be highlighted in a font color different from the other syllables in the words.

Identify Skill—when the Identify Skill is in use, the Language Unit Focus determines which part of each stimulus to use for Targets. For instance, if the Language Unit Type is ‘SoundsInitial’ and the Language Unit Focus is ‘FirstSyllable’, then the target in the Identify Skill might be ‘c’ for the word ‘catfish’, or ‘str’ for the word ‘string’.

Highlighting—the Highlighting designator indicates whether any text will appear in a different font color. The text that is highlighted is designated by the Language Unit Focus.

AVL Set—an AVL Set is a group of AVLs, plus MatchingType (Standard or Paired) and Picture information (Pictured or NotPictured). For example, the AVL set name: ExploreWordsPairedPictured indicates an AVL set used for Explore Words which is of the Paired Matching Type and does use Pictures. The AVL set name: AlphabetListenToSoundsStandardNotPictured indicates an AVL set used for the Alphabet Listen to Sounds sub-activity which is of the Standard Matching Type and does not use Pictures.

AVL/Activity Identifier—the first part of an AVL Set name is the Activity/Subactivity/Mode label for the Structural Skill it applies to.

MatchingType—the Matching type can be either Standard or Paired. The Matching type determines which set of rules should be used during Matching Tasks when choosing Targets and Responses from a Wordlist (see Wordlist Rule section).

Pictures—the final part of the AVL Set name indicates whether the Stimuli will have associated pictures or not. Different AVLs are needed depending on whether pictures are used or not.

AVL—AVL stands for audio/visual level and refers to the amount of audio, pictorial and textual information that is available for stimuli during any given Skill that is a Practice, Matching or Sequencing Task.

There are several AVLs for each of the Skills that are Performance Tasks.

There are 3 AVLs for each of the following Explore Words Performance Task Skills: Listen, Blend, Segment, Identify, Order, Word Rec

There are 3 AVLs for each of the following Alphabet Performance Task Skills: Dynamic Lessons, Identify, Word Rec

There are 6 AVLs for each of the following Alphabet Performance Task Skills: Listen to Sounds, Spelling

There is one AVL for the Practice Task.

AVLs don't apply to the Selection Task.

For an AVL to be completely defined, the audio, picture and text information must be described as Initial, On Demand or Never for all stimulus components displayed on the screen (e.g. Target Whole, Target Parts, Response Whole, etc . . . ).

Placeholders: When AVLs call for On Demand Text, the screen display will show TextPlaceholders and/or PartsPlaceholders.

TextPlaceholders are always represented by a single graphic.

PartsPlaceholders are represented by long dashes, short dashes, bullets and/or spaces depending on the current Language Unit.

e.g. Example of Language Unit assignment influence on Parts and PartsPlaceholder Display:

| Language Unit | | |
|---|---|---|
| Type | Stimuli Text Display | Placeholder Display |
| Sentences | The cat and the dog | |
| | played together. | |
| Syllables | re·frig·er·a·tor | _·_{————}·_{——}·_·_{———} |
| Onset/Rime | r at | __{——} |
| Sounds (Initial, | s n a ke | ____{——} |
| Final or Vowel) | | |
| Sounds (Initial, | sn a ke | _{——}__{——} |
| Final or Vowel) | | |
| with Blending | | |
| Letters | s n a k e | _____{—} |

Initial Settings—a child's Initial Settings are determined by a combination of teacher observations and assessment results. Initial Settings determine some of the starting points for a child, including Initial Beginning AVLs for various Activities/Sub-Activities, and the NumberofResponses and NumberofTrials values.

Beginning AVL: the Beginning AVL applies to the Performance Tasks only. It specifies what information is available when a Trial is first presented. The Beginning AVL is one of the 3 or 6 AVL levels within a Skill and is designated either by the child's Initial Placement or subsequent Progression Rules.

Initially, the Beginning AVL is determined by the child's Initial Placement settings.

Progression Rules will change a child's Beginning AVL.

In the Explore Words Activity, Beginning AVLs are specific for each unique Skill and Language Unit Type combination, meaning that the program will remember different Beginning AVLs for each child for each Skill in each of the Language Units Types. The Skill/Language Unit Type combinations are represented in the matrix below:

| | Skills | | | | | |
|---|---|---|---|---|---|---|
| Language | Listen- | Blend- | Segment- | | Order- | Word |
| Unit Type | ing | ing | ing | Identify | ing | Rec |

Sentences
Syllables
Onset/Rime
SoundsInitial
SoundsFinal
SoundsVowel

In the Alphabet Activity, Beginning AVLs are Sub-activity/skill specific, meaning that the program will remember different Beginning AVLs for each child for each Skill in each Sub-Activity:

| | |
|---|---|
| Alphabet Recognition: Dynamic | Listen to Sounds: Listen to Sounds |
| Lesson skill | skill |
| SpellingAutomaticCurriculum: | SpellingFreeChoice: Spelling skill |
| Identify Skill | |
| SpellingAutomaticCurriculum: | SpellingFreeChoice: Word Rec |
| Spelling skill | skill |

Ending AVL: the Ending AVL is the last AVL presented in a Trial before the Trial is complete. Most of the time the Ending AVL is the AVL at which the child submitted the correct response. The only exception is if the child fails at AVL 1. In this case the Ending AVL is AVL1, even though the child never submitted the correct response.

Target AVL: the target AVL is the most difficult AVL in a skill (AVL3 or AVL 6).

Pivot AVL: the pivot AVL is one AVL less than the target AVL. Progression rule determinations are based on the percentage of success the child had at the pivot and target AVLs across the 4 or 8 trials within a Skill.

NumberofTrials: each child will have a Numberofrrials value assigned that will determine the number of trials s/he sees in all Explore Words and Alphabet Tasks. This value is initially set by the child's Initial Placement and can be altered by the Teacher in Enroll or by Assessment Results.

NumberofResponses: each child will have a NumberofResponses value assigned that will determine the number of Responses between which the child must choose the correct answer. This value is initially set by the Child's Initial Placement and can be altered by Progression Rules.

Progression Rules: Progression Rules are a set of rules that determine a child's movement through the various curricula and/or settings. There are different Progression Rules for the different Activities and Sub-activities.

Wordlist Rules—Wordlist rules govern which stimuli are selected for the Targets and Responses during any Performance Task. These rules change depending on the Lesson Task type (Matching or Sequencing), and (when dealing with Matching Tasks) the Matching Type.

Target—the Target is the stimuli that the child attempts to find a match for (in Matching Tasks) or attempts to construct/order (in Sequencing Tasks). There is one Target per Trial.

Note: for the Identification Skill, the Target=a focus part of the stimuli rather than the whole stimuli (e.g. ‘c’ from the stimuli ‘cat’).

Responses—the Responses (or Response Parts) are the options the child has to choose between when either selecting the match for the Target, or when trying to re-construct the Target.

Wordlists have the following structure:

| | | | Contrast Set A | Contrast Set B |
|---|---|---|---|---|
| | | Contrast pair 1: | stimulus 1a | stimulus 1b |
| 1^{st} Wordlist ½ | {open oversize brace} | | | |
| | | Contrast pair 2: | stimulus 2a | stimulus 2b |
| | | Contrast Pair 3: | stimulus 3a | stimulus 3b |
| 2^{nd} Wordlist ½ | {open oversize brace} | | | |
| | | Contrast Pair 4: | stimulus 4a | stimulus 4b |

1) Matching Tasks

a) Standard Matching type

i) Target Targets will be presented in a random order.

(1) If NumberofTrials=8, each stimulus (or a focus part of each stimulus, as is the case for the Identification Skill) in a wordlist will be presented as the Target one time per Matching Task.

(2) If the NumberofTrials=4, then 4 Targets will be randomly selected using the following rules: each Target must come from a different Contrast Set/Wordlist combination. For example, the stimuli 1a, 2b, 3a and 4b could be a set of Targets. Likewise the stimuli 1b, 2a, 3a, 4b could be a set of Targets.

ii) Responses—Responses will appear in a random order on the screen. Between 2 and 4 Responses will be displayed on a Matching Task, depending on the Child's NumberofResponses value. The correct answer=the target.

(1) If the NumberofResponses=2, they will be the Target and the stimulus in the Target's Contrast Pair.

e.g. Target=1a

Responses=1a, 1b (1a is correct)

(2) If the NumberofResponses=3, they will be the Target, the Stimulus in the Target's Contrast Pair, and the stimulus that is in both the Target's Contrast Set and Wordlist ½.

e.g. Target=2a

Responses=2a, 2b, 1 a (2a is correct)

(3) If the NumberofResponses=4, they will be all four stimuli in the Target's Wordlist ½.

e.g. Target=3a

Responses=3a, 3b, 4a, 4b (3a is correct)

b) Paired Matching Type

i) Target—Targets will be presented in a random order.

(1) If the NumberofTrials=8, each stimulus in a wordlist will be presented as the Target one time per Matching Task.

(2) If the NumberofTrials=4, then 4 Targets will be randomly selected using the following rules: each Target must come from a different Contrast Set/Wordlist ½ combination. For example, the stimuli 1a, 2b, 3a and 4b could be a set of Targets. Likewise the stimuli 1b, 2a, 3a, 4b could be a set of Targets.

ii) Responses—Responses will appear in a random order on the screen. Between 2 and 4 Responses will be displayed on a Matching Task, depending on the Child's NumberofResponses value. Responses will always come from the Contrast Set that DOES NOT contain the Target. The correct answer will=the stimuli in the Target's contrast pair.

(1) If the NumberofResponses=2, they will be the two stimuli in the Target's Wordlist ½ but NOT the Target's Contrast Set.

e.g. Target=1a

Responses=1b, 2b, Correct Response=1b

(2) If the Number of Responses=3, all of the responses will come from the Contrast Set that does NOT contain the Target. Two responses will come from the Target's Wordlist ½. If the Target is in an even numbered Contrast Pair, the 3^{rd} response will be from the other even numbered Contrast Pair. If the Target is in an odd numbered Contrast Pair, the 3^{rd} response will be from the other odd numbered Contrast Pair.

e.g. Target=2b

Responses=2a, 1a, 4a Correct Response=2a.

(3) If the NumberofResponses=3, they will be the four stimuli in the Contrast Set which does not contain the Target.

e.g. Target=3a

Responses=3b, 4b, 1b, 2b Correct Response=3b

2) Sequencing Tasks

a) Target—Targets will be presented in a random order.

i) If NumberofTrials=8, each stimulus in a wordlist will be presented as the Target one time per Matching Task.

ii) If the NumberofTrials=4, then 4 Targets will be randomly selected using the following rules: each Target must come from a different Contrast Set/Wordlist ½ combination. For example, the stimuli 1a, 2b, 3a and 4b could be a set of Targets. Likewise the stimuli 1b, 2a, 3a, 4b could be a set of Targets.

b) Response Parts—between 2 and 16 Response Parts will be displayed in a Sequencing Task, depending on the Child's NumberofResponses value and the number of parts in the Stimuli.

i) The parts for the Target will always be displayed as Response Parts.

ii) If the NumberofResponses≧2, parts from the stimulus in the Target's Contrast Pair will also appear. Parts will be taken from this stimulus from left to right in the native text until either all of the stimulus' parts have been used, or the maximum 16 parts have been displayed.

iii) If the NumberofResponses≧3 AND the maximum 16 parts have not yet been reached, additional parts will be taken from the stimulus which is in both the Target's Contrast Set AND Wordlist ½. Parts will be taken from this stimulus from left to right in the native text until either all the stimulus' parts have been used, or the maximum 16 parts have been displayed. See example below.

iv) If the NumberofResponses=4 AND the maximum 16 parts have not yet been reached, additional parts will be taken from the stimulus which is in the Target's Wordlist ½ BUT not in the Target's Contrast Set OR Contrast Pair. Parts will be taken from this stimulus from left to right in the native text until either all of the stimulus' parts have been used, or the maximum of 16 parts have been displayed. See example below:

e.g.

Contrast Pair 1=cat, caterpillar

Contrast Pair 2=rat, rattlesnake

Contrast Pair 3=chick, chicken

Contrast Pair 4=duck, duckling

NumberofResponses=2, Target=cat in a sounds lesson: Responses Parts=c, a, t, c, a, t, e, r, p, i, l, l, a, r in a syllable lesson: Response Parts=cat, cat, er, pil, lar

NumberofResponses=3, Target=rat in a sounds lesson: Response Parts=r, a, t, r, a, t, t, le, s, n, a, ke, c, a, t in a syllable lesson: Response Parts=rat, rat, le, snake, cat

NumberofResponses=4, Target=chick in a sounds lesson: Response Parts=ch, i, ck, ch, i, ck, e, n, d, u, ck, d, u,ck,l,i

Note the max number of 16 parts had been used, so the remaining parts of the stimulus ‘duckling’ could not be included as Response Parts. in a syllable lesson: Response Parts=chick, chick, en, duck, duck, ling

6.2 Explore Words Specific Definitions

Explore Words Activity: the Explore Words Activity is a section of the Child Application. This activity centers around a large curriculum, which the child experiences as Lessons. Depending on the child's settings, s/he will work on various Skills within each Lesson allowing him/her to practice, match and sequence various sentences, phrases and words (Stimuli).

Explore Words History: a History will be kept of the child's experiences throughout the Explore Words Curriculum. The History is Skill/Language Unit Type specific and cumulative; it will traverse multiple Objectives, Lessons, Tasks and Sessions. Report information about the Explore Words activity will draw primarily on this History.

The History is also referred to by the Progression Rules. The entire History is important to keep a record for Reports, however, the Progression Rules will ignore certain parts of the total History. To clarify the parts of the History that the Progression Rules will interact with, we've made the following distinctions:

Consecutive Trial History—the Consecutive Trial History provides the Beginning and Ending AVLs and the Trial Success or Failure for recent Trials. The Consecutive Trial History is used to determine changes to the Beginning AVL by the Progression Rules. When changes to the Beginning AVL are invoked, the Consecutive Trial History will be reset (i.e. previous Consecutive Trial History will be ignored for the purpose of Progression Rules only).

Note that Consecutive Trials are Skill/Language Unit Type specific. Consecutive Trials include trials from any previous lessons that were traversed with the same Skill/Language Unit Type combination.

Consecutive Lesson History—the Consecutive Lesson History provides the Lesson Success, Neutrality or Failure for recent Lessons. The Consecutive Lesson History is used to determine Changes based on Lesson Evaluation in the Progression Rules. When Changes based on Lesson Evaluation are invoked, the Consecutive Lesson History will be reset (i.e. previous Consecutive Lesson History will be ignored for the purpose of Progression Rules only).

Note that Consecutive Lessons include completed Lessons from any previous Objectives, Concepts and/or Developmental Levels traversed during the same or previous Sessions.

Explore Words Skills:

In Explore Words there is one skill that is a Preparation Task: Practice. In Explore Words there are six skills that are Performance Tasks: Listen, Blend, Segment, Identify, Order and Word Recognition. Each of these Skills is a Matching Task except for Ordering, which is a Sequencing Task.

Available Skills: refers to the Performance Task Skills only. Different skills will be Available based on where the child is placed in the Curriculum and will be assigned at the Objective Level. Additionally, the Teacher may alter the Available skills through Enroll. Any of the 6 performance task Skills that have not been turned off by either the location in the Curriculum or by the Teacher are considered Available Skills.

Least Difficult Available Skills: the Least Difficult Available Skills will change depending on the current Available Skills. The Least Difficult Available Skills will be the easiest two skills that are also Available. e.g. if Blending, Ordering and Word Rec are the Available Skills, the Least Difficult Available Skills are Blending and Ordering.

Most Difficult Available Skills: the Most Difficult Available Skills will change depending on the current Available Skills. The Most Difficult Available Skills will be the hardest two skills that are also Available. e.g. if Listening, Segmenting and Identification are the Available Skills, the Most Difficult Available Skills are Segmenting and Identification.

Note: if 3 or fewer Skills are Available, a skill can be both one of the Least Difficult Available Skills and the Most Difficult Available Skills. See example below.

Enabled Skills: Enabled Skills are a subset of the Available Skills, and are governed by Progression Rules. Most often there are two Enabled Skills, but in the case where there is just one Available Skill, there will also be just one Enabled Skill. In the Explore Words Activity, Enabled Skills are specific to Language Unit Types, meaning that the program will remember different Enabled Skills for each child for each of the Language Unit Types. These Language Unit Types for which Enabled Skills are differentiated are: Sentences, Syllables, Onset/Rime, SoundsInitial, SoundsFinal, SoundsVowel.

Easiest Enabled Skill: the Easiest Enabled Skill is the least difficult skill of the Enabled skills.

e.g. if the Enabled skills are Segmenting and Word Rec., the Easiest Enabled Skill is Segmenting.

Hardest Enabled Skill: the Hardest Enabled Skill is the most difficult skill of the Enabled skills.

e.g. if the Enabled skills are Blending and Segmenting, the Hardest Enabled Skill is Segmenting.

| | Listen | Blend | Segment | Identify | Order | Word Rec. |
|---|---|---|---|---|---|---|
| Case 1 | Available | Available | Available | Available | Available | Available |
| | Easiest Available | Easiest Available | | | Hardest Available | Hardest Available |
| | Enabled | Enabled | | | | |
| | Easiest Enabled | Hardest Enabled | | | | |
| Case 2 | Available | Available | Available | Available | Available | Available |
| | Easiest Available | Easiest Available | | | Hardest Available | Hardest Available |
| | | | Enabled | Enabled | | |
| | | | Easiest | Hardest Enabled | | |
| | | | Enabled | | | |
| Case 3 | Available | Not Available | Available | Not Available | Available | Not Available |
| | Easiest Available | | Easiest & | | Hardest Available | |
| | | | Hardest | | | |
| | | | Available | | | |
| | Enabled | | Enabled | | | |
| | Easiest Enabled | | Hardest | | | |
| | | | Enabled | | | |
| Case 4 | Available | Not Available | Available | Available | Available | Not Available |
| | Easiest Available | | Easiest | Hardest Available | Hardest Available | |
| | | | Available | | | |
| | | | | Enabled | Enabled | |
| | | | | Easiest Enabled | Hardest Enabled | |
| Case 5 | Not Available | Not Available | Not Available | Not Available | Available | Not Available |
| | | | | | Enabled | |

The designations of ‘Enabled’, ‘Easiest Enabled’ and ‘Hardest Enabled ’ are made on a Language Unit Type basis while the designations ‘Available’, ‘Not Available ’ ‘Easiest Available ’ and ‘Hardest Available’ are made on a Curriculum and/or Teacher specified basis.

Mouthpostures—whenever a wordlist contains stimuli with no more than 5 tokens each, AND belongs to an Objective with a Sounds Language Unit, THEN Mouthpostures will be used as Target Part Pictures for the Ordering Skill. See Page 32 for details.

6.3 Explore Words

6.3.1 Overview

[See flowchart of FIG. 3.2]

6.3.2 Selection of Explore Words Activity

The child must select the Explore Words area from the Activity Selection screen in order to enter the Explore Words portion of the program.

The SecondGradeClassroom screen is shown as an example of an Activity Selection screen.

[See FIG. 3.3]

6.3.3 Explore Words Practice screen

Each Lesson in Explore Words begins with a Practice task. The Explore Words Practice screen will appear when the child is in the Explore Words section of the program AND the child is starting a new Lesson. This means that a Practice screen can appear in the following cases:

After a child selects the Explore Words area from the Activity Selection screen.

After a child selects Go On from an Explore Words Lesson Choice screen.

6.3.3.1 What is displayed on the Explore Words Practice Screen?

[See FIG. 3.4]. Note the following regarding this figure:

| Target Area containing: | Word List containing: |
|---|---|
| Target Whole Audio button | 4 or 8 Selection symbols |
| Target Whole Text | 4 or 8 Whole Text entries |
| Target Picture | Help button |
| Record button | Go On button |
| Playback button | Child's Name |
| Target Parts Frame containing Target | Lesson Information |
| Parts | |
| Trial Counter containing 4 or 8 Trial | |
| Symbols | |

6.3.3.2 Which Parts are Displayed for Each Stimulus?

The current Language Unit dictates how each stimulus will be broken into parts. See the Structural Overview.

6.3.3.3 What AVL is Used for Practice?

All Practice Tasks share the same AVL:

| | Target | | |
|---|---|---|---|
| | Whole | Target Parts | Wordlist Entries |
| Picture | I | N | N |
| Audio | I | I | OD |
| Text | I | I | I |

6.3.4 Explore Words Matching Screens

An Explore Words Matching screen appears whenever a Performance Task is called for and one of the following skills is Enabled and invoked by the Progression Rules: Listening, Blending, Segmenting or Word Recognition. Note that more than one Performance Task can be called for in a Lesson, depending on Progression Rules and Enabled Skills. Thus, more than one Matching screen can be seen in a Lesson.

This means that a Matching screen can appear in the following cases:

After a child selects the Explore Words area from the Activity Selection screen.

After a child selects Go On from an Explore Words Lesson transition screen.

6.3.4.1 What is displayed on an Explore Words Matching screen?

[See FIG. 3.5]. Note the following regarding this figure:

Target Area containing

Target Audio button

Target Picture

Target Whole

Target Parts

2-4 Responses each with:

Response Picture

Response Bubble

Response Audio button

Response Whole

Response Parts

Help button

Child's Name

Trial Counter with 4 or 8 Trial Symbols

Lesson Information

6.3.4.2 What Happens When an Answer is Submitted?

When an answer is submitted, it will be evaluated for correctness, and subsequent actions will occur as listed below:

Correct Answer—if the submitted answer was the Correct Answer, the Trial is complete:

The highlighted trial counter will fill in.

If the Trial is evaluated as Successful, the corresponding trial image will fill in with the SuccessColor. A ‘Correct’ sound effect will be heard.

If the Trial is evaluated as Failed, the corresponding trial image will fill in with the FailureColor.

If the Explore Words Matching Task is not complete, the next Trial will be presented with the Initial Functionality described above.

If the Explore Words Matching Task is complete, the child will be taken to the Lesson Choice screen.

See the Progression rules for how to determine if a Trial was Successful or Failed.

Incorrect Answer

If the submitted answer was an Incorrect Answer and the child's Current AVL>1 then the Current AVL will be decreased by 1.

Any images already on the screen will remain visible in their current locations. This includes any On Demand images that have already been explored

If additional graphics and/or buttons need to be available as a result of the decreased AVL, these will appear.

The appropriate FailingHelp message will play.

If the new AVL has the TargetAudio as initial or OnDemand, the Instructions and TargetAudio will play (e.g. ‘Which sound starts the word ‘cat’?’)

If the submitted answer was the Incorrect Answer and the child's Current AVL=AVL 1, then the Correct Answer will be chosen automatically:

The 1^{st} half of the AVL1 FailingHelp message will play followed by the AnswerAudio that corresponds to the Correct Answer. When this is done playing, the program will automatically select the Correct Answer. The Correct Answer will remain on the screen for an additional 5 seconds after which the corresponding trial image will fill in with the color for incorrect answers.

If the Explore Words Matching Task is not complete, the 2^{nd} half of the AVL1 FailingHelp message will play followed by the presentation of the next question with the initial functionality described above.

e.g. ‘The correct answer is Red.’ (correct answer is automatically selected). ‘Let's try another question.’

Where: ‘The correct answer is’=the 1^{st} half of the failing help message ‘Red’=the Correct Answer audio

‘Let's try another question’=the 2^{nd} half of the failing help message.

If the Explore Words Matching Task is complete, the 2^{nd} half of the AVL1 FailingHelp message will NOT play and the child will be taken to the Lesson Choice screen.

6.3.4.3 Which Parts are Displayed for Each Stimulus?

The current Language Unit Type dictates how each whole stimulus will be broken into parts. See the Structural Overview at the beginning of this specification.

6.3.5 Explore Words Ordering Screen

The Ordering screen appears whenever the Performance Task is called for and the Ordering skill is Enabled and invoked by the Progression rules.

This means that a Ordering screen can appear in the following cases:

After a child selects the Explore Words area from the Activity Selection screen.

After a child selects Go On from an Explore Words Lesson transition screen.

6.3.5.1 What is displayed on the Explore Words Ordering Screen?

[See FIG. 3.6]. Note the following regarding this figure:

Target Area containing

Target Audio button

Target Picture

Target Whole text

Target Parts Text

Answer Area containing

Answer parts

Response bubble

Erase button

Answer Audio button

2-16 Response Parts containing

Response Part audio button

Response Part text

Selection button

Help button

Lesson Information

Child's Name

Trial Counter containing 4 or 8 Trial Symbols

6.3.5.2 Response Parts

Response Parts—selecting any part of the Response Parts not listed below will cause no change.

Response Parts Audio Button—selecting the Response Audio button causes the ResponseAudio to play.

If the Response Parts text is Visible, it will highlight for the duration of the ResponsePartsAudio, after which they will return to an unhighlighted state.

The Response Audio button will visually change from Available to InUse for the duration of the ResponseAudio, after which it will return to Available.

The ResponseAudio is not interruptible and mouse clicks made during the audio will be disregarded.

Response Parts text—selecting a Response Part will cause the associated PartAudio to play UNLESS the ResponsePart Audio AVL is set to Never. This may be a word, syllable, onset, rime, token(s) or letter. The Response Part will highlight for the duration of the audio, after which it will return to a non-highlighted state. The Response Parts will be dynamically sized, depending on the length of the Response Parts that are displayed.

Text Note: text should be displayed in the Fulton font. The Response Parts are each limited to 20 characters in length (including spaces and punctuation). Font size will be dynamic, with the following limit: The font size for all the responses on the screen should be the same. Thus the font size should be the largest font possible that allows the longest displayed entry to fit on screen.

Selection Symbol—selecting a Selection Symbol will cause the following sequence:

1) the selected Selection Symbol will briefly change from Available to InUse.

2) the selected Selection Symbol and the associated Response Part will become Not Visible.

3) the associated Response Part text will replace the generic PartPlaceholder of the leftmost empty answer Part.

4) if the Current AVL≦VL2 AND the selected Part does not match the Target Part in the same location, then the following immediate feedback′ will happen:

a) the IncorrectSoundEffect will play followed by a 2 second pause.

b) the right-most filled Answer Part will return to the PartsPlaceholder

c) the associated Response Part and Selection Symbol will become Available in the Response Pool.

5) if all the Answer Parts are now filled, the Answer Audio button will change from NotVisible to Available.

6.3.5.3 What Happens When an Answer is Submitted?

When an answer is submitted, it will be evaluated for correctness, and subsequent actions will occur as listed below:

Correct Answer—if the child submits a correctly sequenced Answer, the answer is Correct and the Trial is complete. Note: At AVLs 1-2 ,by default all submitted answers will be correctly sequenced because of the automatic feedback. Each Trial will only consist of one AVL when the child's Beginning AVL=AVL1-2.

The highlighted trial counter will fill in.

If the Trial is evaluated as Successful, the corresponding trial image will fill in with the SuccessColor. A ‘Correct’ sound effect will play.

If the Trial is evaluated as Failed, the corresponding trial image will fill in with the FailureColor.

If the Explore Words Ordering Task is not complete, the next Trial will be presented with the Initial Functionality described above.

If the Explore Words Ordering Task is complete, the child will be taken to the Lesson Choice screen.

See the Progression rules for how to determine if a Trial was Successful or Failed.

Incorrect Answer—if the child submits an incorrectly sequenced Answer, the answer is Incorrect. Note, this scenario can only occur (by default) when the child's Beginning AVL=AVL3.

If the answer is Incorrect then the Current AVL will be decreased by 1.

The Answer Parts will ‘clear’, i.e. the PartsPlaceholders will replace any text that appeared in the Answer Parts.

All the Response Parts will be Visible in the ResponsePool.

Any other images that were already on the screen will remain visible in their current locations. This includes any On Demand images that have already been explored

If additional graphics and/or buttons need to be available as a result of the decreased AVL, these will appear.

The appropriate FailingHelp message will play.

6.3.5.4 Display of Parts for Each Stimulus

The current Language Unit dictates how each whole stimulus will be broken into parts.

Any lesson that meets the following criteria will qualify for Mouthpostures:

uses one of the Sounds Language Units (SoundsInitial, SoundsFinal, SoundsBlends)

all of the stimuli are made up of 5 tokens or less

each token is made up of one phoneme (e.g. ‘box’ wouldn't qualify because the token for the letter x is made up of two phonemes ‘k,s’)

When these criteria are met, the Ordering skill will use Target Parts Pictures depicting Mouthpostures associated with each target part:

[See FIG. 3.7].

Note: this particular example doesn't exactly match mouthpostures to tokens

One Mouthposture will appear for each token in the stimulus' native text. The Mouthposture which appears will be the mouthposture which represents the phoneme(s) in the associate Token.

Note: at this time we aren't planning to use any tokens with more than one phoneme in them, so that we avoid having to ‘blend’ or ‘overlap’ mouthpostures in a mouthposture box.

The Target Parts text that corresponds with each mouthposture should appear immediately below that picture.

6.3.6 Explore Words Progression Rules

Also see Progression Rule Flowchart, infra.

6.3.6.1 Explore Words Progression Rules Overview:

1. A lesson always begins with a Practice Task.

2. At the conclusion of the Practice Task, a Performance Task will begin for the Easiest Enabled Skill.

3. Rules for Movement Within A Skill will apply.

4. At the end of the Skill, an Evaluation of the Skill will happen.

5. The Skill Evaluation will determine if the child will do another Performance Task in the same lesson, or if the Lesson is ready to be Evaluated.

6. An Evaluation of the Lesson will happen.

7. The Lesson Evaluation will determine if changes will be made to the NumberofResponses a child sees.

8. The Lesson Evaluation will determine if changes will be made to the Enabled Skills, or to the current objective. If the former occurs, the child may need to complete a ‘Transition skill’ before starting the next lesson.

6.3.6.2 Explore Words Progression Rules Details:

1) A lesson will always begin with the Practice Task.

2) Performance tasks (Matching and/or Sequencing) will follow the Practice Task, starting with the Easiest Enabled Skill for the current Language Unit type.

3) Movement Within A Skill

a) The child will be presented with the first trial in the skill at his/her beginning AVL level for the current Skill/Language Unit Type combination.

b) If the child submits the wrong response (or an incorrectly sequenced word in the Ordering Skill) at the beginning AVL, s/he will immediately be presented with the same trial at the next lowest AVL. This adjustment will continue until the child either submits the correct response, or submits the wrong response at the lowest possible AVL. If the latter is the case, the correct response will be presented to the child automatically.

c) When the child has submitted the correct answer, or the incorrect answer at AVL 1, s/he will be presented with the next Trial.

d) The Trial is considered Successful in the following cases:

i) for the Matching Skills, if the child submits the correct answer at the beginning AVL the Trial is considered Successful.

ii) for the Ordering Skill at AVL 3, if the child submits the correctly ordered answer the Trial is considered Successful.

iii) for the Ordering Skill at AVLs 1 and 2, if the child has never selected an incorrect part at the Beginning AVL the Trial is considered Successful.

e) The Trial is considered Failed in the following cases:

i) for the Matching Skills, if the child does not submit the correct answer at the beginning AVL the Trial is considered Failed.

ii) for the Ordering Skill at AVL 3, if the child submits an incorrectly ordered answer the Trial is considered Failed.

iii) for the Ordering Skill at AVLs 1 and 2, if the child selected an incorrect part at any point before submitting the answer the Trial is considered Failed.

f) If 3 of 3 or 3 of 4 consecutive Trials are Successful AND the Beginning AVL does not equal the Target AVL, the Beginning AVL will increase by 1, and the Consecutive Trial History will be ‘cleared’.

g) If 2 of 2 or 2 of 3 consecutive Trials are Failed, AND the Beginning AVL does not equal AVL 1

i) AND the child is in a Matching skill, the Beginning AVL will decrease to the highest Ending AVL from the Failed trials and the Consecutive Trial History will be ‘cleared’.

ii) AND the child is in the Ordering Skill, the Beginning AVL will decrease by one and the Consecutive Trial History will be ‘cleared’.

Note for 3f and 3g: when examining ‘consecutive trials’, the program must look historically across Lessons for any previous experience with the same Skill/Language Unit Type combination as the child's current Skill/Language Unit Type combination.

4) Skill Evaluation (for the most recently completed skill in the Current Lesson)

a) If ≧75% of the Trials were Successful at the Pivot or Target AVLs, the Skill=Successful.

b) If ≧50% and <75% of the Trials were Successful at the Pivot or Target AVLs, the Skill Passed.

c) If <50% of the Trials were Successful at the Pivot or Target AVLs, the Skill=Failed.

5) Movement Based on Skill Evaluation

a) If the Easiest Enabled Skill was Successful, the child will go to the Hardest Enabled Skill in the same Lesson. The Lesson will continue based on Rules 3 and 4. If there is only one Enabled Skill, the Lesson is complete.

b) If the Easiest Enabled Skill was Failed, the child will repeat the Easiest Enabled skill in the same Lesson. The Lesson will continue based on Rules 3 and 4.

i) When the repeated Easiest Enabled skill is complete, the Lessons will be complete and ready for evaluation.

c) If the Easiest Enabled Skill was Successful, but the Hardest Enabled Skill was Failed, the child will repeat the Hardest Enabled skill in the same Lesson. The Lesson will continue based on Rules 3 and 4.

When the repeated Hardest Enabled skill is complete, the Lesson will be complete and ready for evaluation.

d) In all other cases the Lesson is ready to be evaluated.

6) Evaluation of Lesson and Normal Movement

a) Evaluation—the evaluation of a Lesson is based on how the child did at each traversed skill.

i)Easiest Enabled skill=Passed, Lesson is Neutral

ii) Easiest Enabled skill=Failed (the first time), Lesson is Failed (regardless of performance during the Repeated Easiest Enabled skill).

iii) Easiest Enabled skill=Successful, Hardest Enabled Skill=Successful, Lesson is Successful

iv) Easiest Enabled skill=Successful, Hardest Enabled Skill=Passed, Lesson is Neutral

v) Easiest Enabled skill=Successful, only one Skill Enabled, Lesson is Successful

vi) Easiest Enabled skill=Successful, Hardest Enabled Skill=Failed (the first time), Lesson is Neutral (regardless of performance during the Repeated Hardest Enabled skill).

b) Normal Movement—in most cases, the child will go on to the next Lesson in the same Objective. However, if the child has just finished the final lesson in the current objective, s/he will go to the first lesson in the next sequential objective. Furthermore, the invocation of Rule 8ai4 or 8ii (below) will delay the Normal Movement.

7) Changes to NumberofResponses based on Lesson Evaluation

Once either rule 7a or 7b have been invoked, no further changes will be made to the NumberofResponses until at least two more consecutive Lessons have been successful or failed.

a) If 2 out of 2 or 2 out of 3 consecutive Lessons have been successful AND the current NumberofResonses <4, the NumberofResonses will be increased by

b) If 2 out of 2 or 2 out of 3 consecutive Lessons have been Failed, AND the current NumberofResponses >2, the NumberofResponses will be decreased by one.

8) Changes to Enabled Skills and Curriculum placement based on Lesson Evaluation

Once one of the following rules are invoked, the Consecutive Lesson History will be ‘cleared’

a) If 3 out of 3 or 3 out of 4 consecutive Lessons within the same Language Unit Type have been successful, the following will be evaluated in order, until a rule is invoked:

i) If the current Enabled Skills are not the Most Difficult Available Skills, then the Enabled Skills will be increased in difficulty for the Current Language Unit Type:

(1) the Easiest Enabled Skill will be disabled

(2) the Hardest Enabled Skill will become the Easiest Enabled Skill

(3) the next most difficult available Skill will become the Hardest Enabled Skill.

(4) the child will traverse the new Hardest Enabled Skill using the current wordlist. At the completion of this skill, the child will go to the next Lesson, regardless of his/her performance at this ‘Transition’ skill.

ii) If the Enabled Skills are the Most Difficult Available Skills, the child will go on to the first Lesson in the next Objective.

iii) If the child has triggered rule 8aii three times out of the last 9-12 consecutive lessons, AND the child has not had a Progression Rule prompted Assessment in the last week AND the child is currently placed before the X part of the curriculum, then an Assessment will be scheduled for the child's next Session to assess Skill and Language Unit ability. Adjustments to placement may take place as a result. An update will be sent to the teacher informing her of the Assessment, and/or placement change.

b) If 2 out of 2 or 2 out of 3 consecutive Lessons have been Failed, the following will be evaluated in order until a rule is invoked:

i) If the current Enabled Skills are not the Least Difficult Available Skills, then the Enabled Skills will be decreased in difficulty for the Current Language Unit Type:

(1) the Hardest Enabled Skill will be disabled.

(2) the Easiest Enabled Skill will become the Hardest Enabled Skill

(3) the next least difficult available Skill will become the Easiest Enabled Skill

ii) If the currently Enabled Skills are the Least Difficult Available Skills AND the child has not had a Progression Rule prompted Assessment in the last week, then an Assessment will be scheduled for the child's next Session to assess Skill and Language Unit ability. An adjustment to placement may occur as a result. An update will be sent to the Teacher informing her of the Assessment and/or placement change.

Note: if the Progression Rules would take the child past the last available Objective or Wordlist, the following will happen:

The program will automatically place the child at Developmental Level D, Section 1, in the first Concept, Objective and Wordlist.

The program will continue using the placements the child has achieved for Beginning AVLs and Enabled Skills for each of the Language Unit Type/Skill combinations.

The Consecutive Trial and Consecutive Lesson Histories will be cleared. A message will be sent to the teacher via the Teacher application informing her of the change.

6.3.6.3 How is a child's Initial Placement Determined?

A child's Initial Placement is determined by Teacher observations and assessment results at the time when the child is first enrolled. The results will determine the following settings in Explore Words:

Initial Beginning AVL

Initial NumberofResponses

Initial NumberofTrials

Enabled and Available Skills

Curriculum Placement

6.3.6.4 Progression Rules Examples

[See FIGS. 3.8.1, 3.8.2, and 3.8.3]

Language Units, Associated Foci and Characteristics

For each Language Unit, one option from each of the first 3 columns (type, focus,highlighting) can be selected to make many combinations of specific Language Unit (eg.SoundInitialFirstSylInitialHighlightingOn).

The Focus determines which part of the Stimuli will be Highlighted and/or which part is separated in the Identification Skill. The final 3 columns displays the question that will be asked for the Preview and Identification tasks. Note that the Identification question is based on the Focus, while the Preview Instructions are based on the Language Unit Type.

| | | | Associated Instructions/Questions for: | |
|---|---|---|---|---|
| Type | Foci | Highlighting | Preview | Identification |
| Sentences | Carrier Phrase | HighlightingOn | Explore the Words in | Which answer begins with the words . . . |
| | | | these Sentences. | |
| | First Word | HighlightingOff | | Which answer begins with the word . . . |
| | Second Word | | | Which answer contains the word . . . |
| | Third Word | | | Which answer contains the word . . . |
| | Fourth Word | | | Which answer contains the word . . . |
| | Fifth Word | | | Which answer contains the word . . . |
| | Final Word | | | Which answer ends with the word . . . |
| Syllables | First Syllable | HighlightingOn | Explore the Syllables | Which word begins with the syllable . . . |
| | Second Syllable | HighlightingOff | in these Words. | |
| | Third Syllable | | | Which word contains the syllable . . . |
| | Fourth Syllable | | | Which word contains the syllable . . . |
| | Fifth Syllable | | | Which word contains the syllable . . . |
| | Final Syllable | | | Which word contains the syllable . . . |
| | Prefix | | | Which word ends with the syllable . . . |
| | Suffix | | | Which word starts witht the prefix . . . |
| Onset Rime | Onset | HighlightingOn | Explore the Sounds in | Which word starts with . . . |
| | | | these Words. | |
| | Rime | HighlightingOff | | Which word ends with (the sounds?) . . . |
| | Rime Vowel ? | | | Which word contains the vowel . . . |
| | Rime Final ? | | | Which word ends with the sound . . . |
| Sounds Initial | First Syl Initial | HighlightingOn | Explore the Sounds in | Which word starts with the sound . . . |
| | | | these Words. | |
| | Second Syl | HighlightingOff | | Which word has the sound . . . ??? |
| | Initial | | | |
| | Third Syl | | | Which word has the sound . . . ??? |
| | Initial | | | |
| | Fourth Syl | | | Which word has the sound . . . ??? |
| | Initial | | | |
| Sounds Final | Final Syl Final | HighlightingOn | Explore the Sounds in | Which word ends with the sound . . . |
| | | | these Words. | |
| | First Syl Final | HighlightingOff | | Which word has the sound . . . ??? |
| | Second Syl | | | Which word has the sound . . . ??? |
| | Final | | | |
| | Third Syl Final | | | Which word has the sound . . . ??? |
| | Fourth Syl | | | Which word ends with the sound . . . ??? |
| | Final | | | |
| Sounds Vowel | First Syl | HighlightingOn | Explore the Sounds in | Which word has the vowel sound . . . ??? |
| | Vowel | | these Words. | |
| | Second Syl | HighlightingOff | | Which word has the vowel sound . . . ??? |
| | Vowel | | | |
| | Third Syl | | | Which word has the vowel sound . . . ??? |
| | Vowel | | | |
| | Fourth Syl | | | Which word has the vowel sound . . . ??? |
| | Vowel | | | |

Explore Words AVL Sets

See table below.

Key:

I=Initially available

OD=available On Demand

N=Never available

yellow highlighting =where highlighting occurs when lesson has Highlighting

| | | Explore Words Standard Pictured | | | | Explore Words Standard Not Pictured | | | |
|---|---|---|---|---|---|---|---|---|---|
| AVL SET NAME: | | T. Whole | T. Parts | R. Whole | R. Parts | T. Whole | T. Parts | R. Whole | R. Parts |
| Listen 1 | Picture | OD | N | I | N | N | N | N | N |
| | Audio | I | N | OD | N | I | N | OD | N |
| | Text | I | N | I | N | I | N | I | N |
| Listen 2 | Picture | N | N | I | N | N | N | N | N |
| | Audio | I | N | OD | N | I | N | OD | N |
| | Text | N | N | I | N | OD | N | I | N |
| Listen 3 | Picture | N | N | I | N | N | N | N | N |
| | Audio | I | N | N | N | I | N | OD | N |
| | Text | N | N | I | N | N | N | I | N |
| Blend 1 | Picture | I | N | I | N | N | N | N | N |
| | Audio | N | I | OD | OD | N | I | OD | N |
| | Text | N | I | I | OD | N | I | I | N |
| Blend 2 | Picture | OD | N | I | N | N | N | N | N |
| | Audio | N | I | OD | N | N | I | OD | N |
| | Text | N | OD | I | N | N | OD | I | N |
| Blend 3 | Picture | N | N | I | N | N | N | N | N |
| | Audio | N | I | OD | N | N | I | OD | N |
| | Text | N | N | OD | N | N | N | I | N |
| Segment 1 | Picture | OD | N | I | N | N | N | N | N |
| | Audio | I | N | OD | OD | I | N | N | OD |
| | Text | OD | N | OD | I | OD | N | N | I |
| Segment 2 | Picture | N | N | OD | N | N | N | N | N |
| | Audio | I | N | N | OD | I | N | N | OD |
| | Text | N | N | N | I | N | N | N | I |
| Segment 3 | Picture | OD | N | N | N | N | N | N | N |
| | Audio | I | N | N | OD | I | N | N | OD |
| | Text | N | N | N | I | N | N | N | OD |
| Identify 1* | Picture | I | | OD | N | N | | N | N |
| | Audio | I | | OD | OD | I | | OD | OD |
| | Text | OD | | OD | I | OD | | OD | I |
| Identify 2* | Picture | OD | | N | N | N | | N | N |
| | Audio | I | | N | OD | I | | N | OD |
| | Text | OD | | N | I | OD | | N | I |
| Identify 3* | Picture | OD | | N | N | N | | N | N |
| | Audio | I | | N | OD | I | | N | OD |
| | Text | N | | N | I | N | | N | I |
| Order 1 | Picture | I | N | N | I** | N | N | N | N |
| | Audio | I | OD | N | OD | I | OD | N | OD |
| | Text | I** | I | N | I | I | I | N | I |
| Order 2 | Picture | I | N | N | OD** | N | N | N | N |
| | Audio | I | OD | N | OD | I | OD | N | OD |
| | Text | OD** | OD | N | I | OD | OD | N | I |
| Order 3 | Picture | OD | N | N | N | N | N | N | N |
| | Audio | I | OD | N | N | I | OD | N | N |
| | Text | N | N | N | I | N | N | N | I |
| Word Rec 1 | Picture | N | N | I | N | N | N | N | N |
| | Audio | OD | N | OD | N | N | I | OD | N |
| | Text | I | N | N | N | N | OD | I | N |
| Word Rec 2 | Picture | N | N | I | N | N | N | N | N |
| | Audio | OD | N | N | N | I | N | OD | N |
| | Text | I | N | N | N | OD | N | I | N |
| Word Rec 3 | Picture | N | N | I | N | N | N | N | N |
| | Audio | N | N | N | N | I | N | N | N |
| | Text | I | N | N | N | N | N | I | N |

*For the Identify Skill:
the Target = Focus Part of the stimuli (appears in the Whole positions in the target box)
the Responses = entire Stimuli.
**In the Ordering Skill, either the Target Whole Text will appear, or (in the same location) the Target Parts Pictures will appear. The Target Parts Pictures will appear if the Lesson qualifies for Mouthpostures. In all other cases, the Target Whole will appear instead.

| | | Explore Words Paired Pictured | | | | Explore Words Paired Not Pictured | | | |
|---|---|---|---|---|---|---|---|---|---|
| | | Target | Target | Response | Response | Target | Target | Response | Response |
| AVL SET NAME: | | Whole | Parts | Whole | Parts | Whole | Parts | Whole | Parts |
| Listen 1 | Picture | I | N | I | N | N | N | N | N |
| | Audio | I | N | OD | N | I | N | OD | N |
| | Text | I | N | I | N | OD | N | I | N |
| Listen 2 | Picture | OD | N | OD | N | N | N | N | N |
| | Audio | I | N | OD | N | I | N | OD | N |
| | Text | I | N | I | N | OD | N | I | N |
| Listen 3 | Picture | OD | N | N | N | N | N | N | N |
| | Audio | I | N | OD | N | I | N | OD | N |
| | Text | I | N | I | N | N | N | I | N |
| Work Rec 1 | Picture | N | N | N | N | N | N | N | N |
| | Audio | I | N | OD | N | I | N | OD | N |
| | Text | I | N | I | N | I | N | I | N |
| Work Rec 2 | Picture | N | N | N | N | N | N | N | N |
| | Audio | OD | N | OD | N | I | N | OD | N |
| | Text | I | N | I | N | OD | N | I | N |
| Work Rec 3 | Picture | N | N | N | N | N | N | N | N |
| | Audio | N | N | N | N | I | N | N | N |
| | Text | I | N | I | N | N | N | I | N |

6.3.7 Progression Rules Diagram

[see FIGS. 3.9.1 and 3.9.21]

7 SPEC C: Alphabet Specification

7.1 Structural Activities Overview

There are two kinds categories of Activities which incorporate Curriculum: Structural Activities and Meaning Activities.

Structural Activities focus on the structure of language and words.

Meaning Activities focus on the meaning of language and words.

Structural Activities—the Explore Words Activity and all of the Alphabet sub-activities are considered Structural Activities. There 6 of these Structural Activities in the BTL program: Explore Words, Alphabet: Alphabet Recognition, Alphabet: Listen to Sounds, Alphabet: Find Sounds, Alphabet: Spelling: Auto Curriculum, Alphabet: Spelling: Free Choice.

Each Structural Activity has it's own combination of Skills, Progression Rules, and separate Curricula.

Each Structural Activity is made up of several Skills, which can be categorized by one of the four Lesson Tasks.

| Structural | | Lesson Tasks | | | |
|---|---|---|---|---|---|
| Activities | | | | Performance | |
| Activity/Subac- | | Preparation | | Match- | Sequenc- |
| tivity/Mode | Skill | Practice | Selection | ing | ing |
| Explore Words | Practice * | X | | | |
| Explore Words | Listen | | | X | |
| Explore Words | Blend | | | X | |
| Explore Words | Segment | | | X | |
| Explore Words | Ordering | | | | X |
| Explore Words | Word Rec | | | Xx | |
| | ** | | | | |
| Alphabet: | Letter | | X | | |
| Alphabet | Selection | | | | |
| Recognition | | | | | |
| Alphabet: | Dynamic | | | X | |
| Alphabet | Lesson | | | | |
| Recognition | | | | | |
| Alphabet: Listen | Practice * | X | | | |
| to Sounds | | | | | |
| Alphabet: Listen | Listen to | | | X | |
| to Sounds | Sounds | | | | |
| Alphabet: Find | Practice * | X | | | |
| Sounds | | | | | |
| Alphabet: Find | Find the | | | X | |
| Sounds | word | | | | |
| Alphabet: Find | Find the | | | X | |
| Sounds | sound | | | | |
| Alphabet: | Practice * | X | | | |
| Spelling Auto | | | | | |
| Curriculum | | | | | |
| Alphabet: | Spelling | | | | X |
| Spelling Auto | *** | | | | |
| Curriculum | | | | | |
| Alphabet: | Word Rec | | | X | |
| Spelling Auto | ** | | | | |
| Curriculum | | | | | |
| Alphabet: | Word | | X | | |
| Spelling Free | Selection | | | | |
| Choice | | | | | |
| Alphabet: | Spelling | | | | X |
| Spelling Free | *** | | | | |
| Choice | | | | | |
| Alphabet: | Word Rec | | | X | |
| Spelling Free | ** | | | | |
| Choice | | | | | |

* The AVLs for these Practice Skills are identical.
** The AVLs for these Word Recognition Skills are identical.
*** The AVLs for these Spelling Skills are identical.

Skills—a Skill is a descriptor for the specific kind of concept a child is working on. Each Skill falls under one of the four Lesson Task groupings, which describe common behavior/functionality across the similar Skills. A Skill represents one ‘screen’ or ‘Task’ usually containing several ‘trials’.

Lesson Tasks—there are four kinds of Lesson Tasks: Practice, Selection, Matching and Sequencing. Each of these can be described as either Preparation or Performance Tasks. Each of the four represent a different kind of general task the child must perform in the Structural Activities. Each Skill is categorized as one of the Lesson Task types.

Preparation Tasks—there are two Preparation Tasks: Practice and Selection. Both share in common the fact that the child's actions are not judged.

Practice Task—a Practice task gives the child a chance to preview each of the coming stimuli without being judged (though behavior is recorded). The child can explore the stimuli whole, parts and/or make recordings. Practice Tasks in Explore Words and Alphabet Activities are made up of 4 or 8 Trials. The Practice Task (Preview) in the Story Activity can contain 1-8 Trials.

Selection Task—a Selection task allows a child to practice with many stimuli, as well as chose a select number of stimuli to be used in the upcoming lesson. As with the Practice task, Selection tasks are not judged (though behavior is recorded). The child can explore stimuli and/or make recordings. Selection Tasks are not made up of Trials.

However, in order to go on to a subsequent Performance Task, the child must select 4 or 8 stimuli from a Selection Task.

Performance Tasks—there are two Performance Tasks: Matching and Sequencing. These tasks share in common the fact that the child's responses are judged and the resulting actions of the program are based on the child's performance.

Matching—a Matching task requires the student to match a Target stimulus with a Response stimulus. The format of this task provides the child with a single Target and several Responses. The child's selections are judged, and his/her level of success determines which Progression Rules will be invoked. Matching Tasks are made up of 4 or 8 Trials.

Sequencing—a Sequencing task requires the student to assemble the Parts of a stimulus to create the Whole Target stimulus. The format for this task provides the child with a single Target whole, and then parts from both the Target and other stimuli from which to create the correctly ordered, whole Target. The child's selections are judged, and his/her level of success determines which Progression Rules will be invoked. Sequencing Tasks are made up of 4 or 8 Trials.

Trials—a Trial is a sub-portion of a Task (except the Selection Task). In the Practice Task, a Trial begins when a stimulus is presented and ends when a new stimulus is selected (or the Practice screen is exited). In either of the Performance Tasks, a Trial begins when a Target stimulus is presented, and ends when the correct response is submitted (by the child or the program). Note that in Performance Tasks, a single Trial can traverse several AVLs.

Lessons—a Lesson is the name for the combination of a Wordlist, Language Unit, AVL Set (all determined by elements in the Curriculum) and the Skills, number of responses and number of trials values (all determined by the child's settings and Progression Rules). A Lesson always begins with a Preparation Task which is followed by one or more Performance Tasks.

Curriculum—Structural Activities containing Selection tasks do not have a set curriculum (instead, curriculum is dynamically generated—creating wordlists on the fly). All other Structural Activities, however, have unique, linearly designed Curricula. The Curriculum for each contains Wordlists. These may be grouped into Objectives, which in turn may be further grouped into Developmental Level Sections and Developmental Levels.

Wordlists—a Wordlist is a group of stimuli that provide the content for a Lesson. Wordlists can come from two different sources. The Wordlist Source is determined by the Structural Activity. Structural Activities containing a Selection Task use Wordlists from Dynamic Selection. All other Selection Activities use Wordlists from Set Curriculum specifically for the Activity in use.

Set Curriculum—Wordlists in a Set Curriculum are static (never change) and contain 8 stimuli each.

Dynamic Selection—Wordlists that are a result of Dynamic Selection draw either 4 or 8 stimuli from a child's selections to create the content of the wordlist. These Wordlists are only preserved long enough for the child to complete the lesson.

Wordlists have the following structure:

| | | | Contrast Set A | Contrast Set B |
|---|---|---|---|---|
| | | Contrast pair 1: | stimulus 1a | stimulus 1b |
| 1^{st} Wordlist ½ | {open oversize brace} | | | |
| | | Contrast pair 2: | stimulus 2a | stimulus 2b |
| | | Contrast Pair 3: | stimulus 3a | stimulus 3b |
| 2^{nd} Wordlist ½ | {open oversize brace} | | | |
| | | Contrast Pair 4: | stimulus 4a | stimulus 4b |

Note: some Wordlists that are a result of Dynamic Selection will only have 4 stimuli. In this case, the Wordlist will only consist of what is depicted as the 1^{st} Wordlist ½ above (stimuli 1a-2b).

There are Rules that govern how Targets and Responses are selected from a Wordlist, as well as how a Dynamic Wordlist is populated. See the Wordlist Rules section.

Objective—an Objective is a group of Wordlists that share a similar language focus or learning objective. Objectives are assigned a Language Unit and AVL Set. These provide additional information about how the Wordlist content will be displayed.

Developmental Level Sections—a Developmental Level Section is a grouping of Objectives containing concepts appropriate for a particular grade level during part of the school year. Developmental Level Sections only apply to the Explore Words Curriculum.

Developmental Level—a Developmental Level is a group of 4 Developmental Level Sections. A Developmental Level exists for each of the grades covered by the product. Currently there are four: Pre-K, Kindergarten, First and Second. Developmental Levels only apply to the Explore Words Curriculum.

Stimulus: a stimulus refers to a word, sentence or phrase (e.g. ‘cat’, ‘Pet the cat.’, ‘white cat’). ‘Atomic Stimuli’ is the identifier for single words. ‘Compound Stimuli’ is the identifier for sentences or phrases.

Each atomic stimulus has a phonemic text string and native text string associated with it. These strings provide pronunciation information as well as map letters with tokens (sounds).

Atomic stimuli are most often named by the word itself (e.g. cat). Sometimes, the name of the stimulus also contains pronunciation information in the case where the same spelling renders two different pronunciations, e.g. ‘the[u]’ and ‘the[ee]’.

Each compound stimulus is named as the atomic stimuli that make up the compound stimulus, separated by underscores, e.g. ‘see_the[u]_cat’.

Each stimulus can be displayed as a whole: compound stimuli will be sentences or phrases while atomic stimuli will be words.

Each stimulus can be displayed as parts: compound stimuli can be broken into words, while atomic stimuli can be broken into syllables, onset/rimes, tokens and letters.

There can be audio and graphic files associated with each stimulus whole, and audio files associated with each of the stimulus parts. In addition, phonemes each have their own associated graphic file (Mouthpostures), which are called for in special cases.

Token: tokens are used in a stimulus' native text to match phonemes with letters. In most cases, a token contains one phoneme. In some cases more than one phoneme must be grouped together to get the correct match between phonemes and letters.

Phoneme: phonemes represent individual, unique sounds used in our language. Phonemes can be grouped together into tokens to allow a one to one match between the sounds in a word and the spelling of the word.

Mouthpostures: Mouthpostures refer to pictures of mouths representing the articulatory positions required to make sounds. Mouthpostures are used primarily in Alphabet, but will occasionally appear in Explore Words. There is one Mouthposture for each phoneme.

Curriculum Structure

[See FIG. 4.11]

Language Unit—there are X Language Units. Each Language Unit name contains several pieces of information in the following order: Language Unit Type, Language Unit Focus, Mouthpostures Used, Highlighting Used. E.g.

The Language Unit ‘SoundsInitialMouthposturesHighlighting’ is of the Sounds Type, specifically focused on the Initial sound, and it uses both Mouthpostures and Highlighting.

The Language Unit ‘SyllablesUnequal’ is of the Syllables Type, specifically focused on syllables of Unequal length and does not use either Mouthpostures or Highlighting.

Language Unit Types—There are 5 main Language Unit Types. The Language Unit Type describes how a stimulus will be broken into parts.

| Language | Whole | | | | | | |
|---|---|---|---|---|---|---|---|
| Unit Type | Definition | Parts Definition | Whole example | Parts example | | | |
| Sentences | The entire | The individual words. | A cat is outside. | a | cat | is | outside. |
| | sentence | | See the cat. | See | the | cat. | |
| | or phrase. | | one cat | one | cat | | |
| | | | Cat | cat | | | |
| Syllables | The entire | The syllables. | Cat | cat | | | |
| | word. | | Catfish | cat | fish | | |
| | | | Caterpillar | cat | er | pil | lar |
| Onset/Rime | The entire | The sound(s) before the vowel, | Cat | c | at | | |
| | word. | and the rest of the word. | Chat | ch | at | | |
| | | | Scratch | scr | atch | | |
| Sounds | The entire | Each token. | Cat | c | a | t | |
| | word. | | Chat | th | r | oa | T |
| | | | Coat | i | ro | n | |
| | | | Scratch | s | c | r | a tch |
| Letters | The entire | Each letter. | Cat | c | a | t | |
| | word. | | Chat | c | h | a | t |
| | | | Coat | c | o | a | |
| | | | Scratch | s | c | r | a t c h |

Language Unit Focus—There are a number of Foci for each Language Unit Type. The Language Unit Focus describes specifically what content is being focused on within the general Language Unit descriptor. Besides being a naming convention, this information is used in two specific ways:

Highlighting—when a Language Unit includes Highlighting, the Language Unit Focus provides the information for what is to be highlighted. For instance, if the Language Unit Focus is ‘SecondSyllable’ and Highlighting is being used, the second syllable of each word will be highlighted in a font color different from the other syllables in the words.

Focus Matching type—when the Matching type is Focus (determined by the AVL set), the Language Unit Focus determines which part of each stimulus to use when selecting Targets/Responses. For instance, if the Language Unit Focus is ‘Initial Syllable’ for a Focus Matching Type, the target might be ‘c’ for the word ‘cat’, or ‘str’ for the word ‘string’.

Mouthpostures—the Mouthpostures designator indicates whether the parts of a stimulus will display pictures of Mouthpostures. Mouthpostures only apply to the Sounds Type of Language Units and only are used in Explore Words during the Sequencing skill. Furthermore, all stimuli in an Objective with the Mouthposture designation must contain no more than 5 tokens.

Highlighting—the Highlighting designator indicates whether any text will appear in a different font color. The text that is highlighted is designated by the Language Unit Focus.

AVL Set—an AVL Set is a group of AVLs, plus MatchingType and Picture information.

AVL/Activity Identifier—the first part of an AVL Set name is the Activity/Subactivity/Mode label for the Structural Skill it applies to.

MatchingType—the Matching type can be either Standard or Focus. The Matching type determines which set of rules should be used during Matching Tasks when choosing Targets and Responses from a Wordlist (see Wordlist Rule section).

Pictureable—the final part of the AVL Set name indicates whether the Stimuli will have associated pictures or not. Different AVLs are needed depending on whether pictures are used or not.

AVL—AVL stands for audio/visual level and refers to the amount of audio, pictorial and textual information that is available for stimuli during any given Skill that is a Practice, Matching or Sequencing Task.

There are several AVLs for each of the Skills that are Performance Tasks.

There is one AVL for the Practice Task.

AVLs don't apply to the Selection Task.

For an AVL to be completely defined, the audio, picture and text information must be described as Initial, On Demand or Never for all stimulus components displayed on the screen.

Initial Settings—a child's Initial Settings are determined by a combination of teacher observations and assessment results. Initial Settings determine some of the starting points for a child, including Initial Beginning AVLs for various Activities/Sub-Activities, and the NumberofResponses and NumberofTrials values.

Initial Beginning AVL: the Initial Beginning AVLs will be determined by a child's Initial Placement. Initial Beginning AVLs apply to Performance Tasks only, and exist only until the child has some experience in each given Skill and progression rules adjust the Beginning AVL.

Beginning AVL: the Beginning AVL applies to the Performance Tasks only. It specifies what information is available when a Trial is first presented. The Beginning AVL is one of the 3-6 AVL levels within a Skill that has been designated either by the child's Initial Placement or Progression Rules.

Progression Rules can change a child's Beginning AVL.

In the Explore Words Activity, Beginning AVLs are specific for each Skill in combination with a set of Language Units, meaning that the program will remember different Beginning AVLs for each child for each Skill in each of the specified sets of Language Units. The combinations are represented in the matrix below:

| | | | | |
|---|---|---|---|---|
| | | | Sequenc- | Word |
| Listening | Blending | Segmenting | ing | Rec |

Sentences
Syllables
Onset/Rime
Sounds:
initial
consonant
Sounds:
rhyming
initial
consonant
Sounds:
final
consonant
Sounds:
vowel
Sounds:
blend

In the Alphabet Activity, Beginning AVLs are Sub-activity/skill specific, meaning that the program will remember different Beginning AVLs for each child for each Skill in each Sub-Activity.

Ending AVL: the Ending AVL is the last AVL presented in a Trial before the Trial is complete. Most of the time the Ending AVL is the AVL at which the child submitted the correct response. The only exception is if the child fails at AVL 1. In this case the Ending AVL is AVL1, even thought the child never submitted the correct response.

Target AVL: the target AVL is the most difficult AVL in a skill (AVL3 or AVL 6).

Pivot AVL: the pivot AVL is one AVL less than the target AVL. Progression rule determinations are based on the percentage of success the child had at the pivot and target AVLs across the 4 or 8 trials within a Skill.

NumberofTrials: each child will have a NumberofTrials value assigned that will determine the number of trials s/he sees in all Alphabet Tasks. This value is initially set by the child's Initial Placement and can be altered by Assessment Results.

NumberofResponses: each child will have a NumberofResponses value assigned that will determine the number of Responses between which the child must choose the correct answer. This value is initially set by the Child's Initial Placement and can be altered by Progression Rules.

Progression Rules: Progression Rules are a set of rules that determine a child's movement through the various curricula and/or settings. There are different Progression Rules for the different Activities and Sub-activities.

Wordlist Rules—Wordlist rules govern which stimuli are selected for the Targets and Responses during any Performance Task. These rules change depending on the Lesson Task type (Matching or Sequencing), and (when dealing with Matching Tasks) the Matching Type. The structure for any Wordlist is as follows:

| | | | Contrast Set A | Contrast Set B |
|---|---|---|---|---|
| | | Contrast pair 1: | stimulus 1a | stimulus 1b |
| 1^{st} Wordlist ½ | {open oversize brace} | | | |
| | | Contrast pair 2: | stimulus 2a | stimulus 2b |
| | | Contrast Pair 3: | stimulus 3a | stimulus 3b |
| 2^{nd} Wordlist ½ | {open oversize brace} | | | |
| | | Contrast Pair 4: | stimulus 4a | stimulus 4b |

1) Wordlists that are a part of a Set Curriculum

a) Matching Tasks

i) Standard Matching type

(1) Target—Targets will be presented in a random order.

(a) If NumberofTrials=8, each stimulus in a wordlist will be presented as the Target one time per Matching Task.

(b) If the NumberofTrials=4, the stimuli in the 2^{nd} Wordlist V₂ will be ignored. Thus, each stimulus in the 1^{st} Wordlist ½ will be presented as the Target one time per Matching task.

(2) Responses—Responses will appear in a random order on the screen. Between 2 and 4 Responses will be displayed on a Matching Task, depending on the Child's NumberofResponses value. The correct answer=the target.

(a) If the NumberofResponses=2, they will be the Target and the stimulus in the Target's Contrast Pair.

e.g. Target=1a

Responses=1a, 1b (1a is correct)

(b) If the NumberofResponses=3, they will be the Target, the Stimulus in the Target's Contrast Pair, and the stimulus that is in both the Target's Contrast Set and Wordlist ½.

e.g. Target=2a

Responses=2a, 2b, 1a (2a is correct)

(c) If the NumberofResponses=4, they will be all four stimuli in the Target's Wordlist ½.

e.g. Target=3a

Responses=3a, 3b, 4a, 4b (3a is correct)

(ii) Focus Matching type

(1) Target—Targets will be presented in a random order. Depending on the Skill, the Target will either be a stimulus, or a focus part from the stimulus.

(a) If NumberofTrials=8, each stimulus or the focus part of each stimulus in a wordlist will be presented as the Target one time per Matching Task.

(b) If the NumberofTrials=4, the stimuli in the 2^{nd} Wordlist ½ will be ignored. Thus, each stimulus or the focus part of each stimulus in the 1^{st} Wordlist ½ will be presented as the Target one time per Matching task.

(2) Responses—Responses will appear in a random order on the screen.

(a) If the Target is the whole Stimulus, Responses will be the focus parts of the stimuli. E.g. Target=cat, Responses=‘c’, ‘r’, ‘th’, ‘m’

(b) If the Target is the focus part of a stimulus, the Responses will be the whole stimuli. E.g. Target=‘c’, Responses=cat, rat, that, mat

(c) The correct answer is the Response that correlates to the Target. In 2a above, it would be ‘c’. In 2b above, it would be ‘cat’.

(d) The rules for determining which Stimuli to use for each NumberofResponses value are identical between both the Standard and Focus Matching types. (See above).

(b) Sequencing Tasks

i) Targets—Targets will be presented in a random order.

(1) If NumberofTrials=8, each stimulus in a wordlist will be presented as the Target one time per Matching Task.

(2) If the NumberofTrials=4, the stimuli in the 2^{nd} Wordlist ½ will be ignored. Thus, each stimulus in the 1^{st} Wordlist ½ will be presented as the Target one time per Matching task.

ii) Response Parts—between 2 and 16 Response Parts will be displayed in a Sequencing Task, depending on the Child's NumberofResponses value and the number of parts in the Stimuli.

(1) The parts for the Target will always be displayed as Response Parts.

(2) If the NumberofResponses ≧2, parts from the stimulus in the Target's Contrast Pair will also appear. Parts will be taken from this stimulus from left to right in the native text until either all of the stimulus' parts have been used, or the maximum 16 parts have been displayed.

(3) If the NumberofResponses ≧3 AND the maximum 16 parts have not yet been reached, additional parts will be taken from the stimulus which is in both the Target's Contrast Set AND Wordlist ½.

Parts will be taken from this stimulus from left to right in the native text until either all the stimulus' parts have been used, or the maximum 16 parts have been displayed.

(4) If the NumberofResponses=4 AND the maximum 16 parts have not yet been reached, additional parts will be taken from the stimulus which is in the Target's Wordlist ½ BUT not in the Target's Contrast Set OR Contrast Pair. Parts will be taken from this stimulus from left to right in the native text until either all of the stimulus' parts have been used, or the maximum of 16 parts have been displayed.

e.g. Contrast Pair 1=cat, caterpillar

Contrast Pair 2=rat, rattlesnake

Contrast Pair 3=chick, chicken

Contrast Pair 4=duck, duckling

NumberofResponses=2, Target=cat in a sounds lesson: Responses Parts=c, a, t, c, a, t, e, r, p, i, l, l, a, r

in a syllable lesson: Response Parts=cat, cat, er, pil, lar

NumberofResponses=3, Target=rat in a sounds lesson: Response Parts=r, a, t, r, a, t, t, le, s, n, a, ke, c, a, t

in a syllable lesson: Response Parts=rat, rat, le, snake, cat

NumberofResponses=4, Target=chick in a sounds lesson: Response Parts=ch, i, ck, ch, i, ck, e, n, d, u, ck, d, u, ck, l, i

in a syllable lesson: Response Parts=chick, chick, en, duck, duck, ling

2) Dynamic Wordlist Population—two of the Alphabet sub-activities do not have set curricula. Instead the curriculum is dynamically generated based on the child's selections in corresponding Selection Tasks. These sub-activities are Alphabet: Alphabet Recognition and Alphabet: Spelling: Free Choice. For both Sub-activities, wordlists are created on the fly by following these rules:

a) A Selection Task precedes any Performance task using dynamic wordlists. For the child to pass from the Selection Task to the subsequent Performance task, s/he must fill a ‘queue’.

b) The child's NumberofTrials value will determine how many entries must be filled in the queue before s/he can go on to the associated Performance task.

c) When the queue is full and the child chooses to go on to the Performance task, the Wordlist is populated based on the entries in the queue. The first entry in the queue will become the stimuli in position 1a in the Wordlist. The second entry in the queue becomes 1b in the Wordlist. The third entry in the queue becomes 2a in the Wordlist and so on.

d) If the NumberofTrials value is 4, only the first Wordlist ½ will be ‘filled’—i.e. stimuli will only be identified for 1a, 1b, 2a and 2b.

e) If the NumberofTrials value is 8, the entire Wordlist will be ‘filled.

7.2 Alphabet Specific Definitions

Alphabet Activity—the Alphabet Activity refers to the Alphabet portion of the program. It starts when a child selects the Alphabet button on the Activity Selection screen, and ends when the child is returned to the same screen. The Alphabet Activity includes several sub-activities: Alphabet Recognition, Listen to Sounds, Find Sounds and Spelling. A child, however, may not have all of these choices at any given time.

Alphabet Recognition—Alphabet Recognition is one of the Alphabet sub-activities. By default it is the first Alphabet sub-activity to be available to the child. The Curriculum for Alphabet Recognition is generated dynamically.

Letter Mode—one of two modes in the Alphabet Recognition sub-activity. Letter mode indicates that the audio associated with alphabet letters is the corresponding Letter Name.

Sound Mode—one of two modes in the Alphabet Recognition sub-activity. Sound mode indicates that the audio associated with alphabet letters is the corresponding Letter Sound.

Case—there are two settings for case: Uppercase and Lowercase. The case indicates how certain alphabet letters appear within the Dynamic sub-activity.

Listen to Sounds—Listen to Sounds is one of the Alphabet sub-activities. It is automatically enabled after a child has had experience in Alphabet Recognition. Listen to Sounds has a set curriculum through which the child traverses. Listen to Sounds helps the child focus on each sound in a word by displaying Mouthposture graphics for each part.

Spelling—Spelling is the most difficult Alphabet sub-activity. One mode of Spelling has a set curriculum. One mode of Spelling is dynamic where lessons are generated based on the child's word exploration.

Automatic Curriculum—one of two modes for the Spelling sub-activity, this one has a set curriculum.

Free Choice—one of two modes for the Spelling sub-activity, this one is dynamically generated by the child's explorations.

Alphabet History: a History will be kept of the child's experiences throughout each Alphabet sub-activity. The History is sub-activity/skill specific and cumulative; it will traverse multiple Tasks, Lessons and Sessions. Report information about the Alphabet sub-activities will draw primarily on these Histories. These Histories are also referred to by the Progression Rules. The entire History is important to keep a record for Reports, however, the Progression Rules will ignore certain parts of the total History. To clarify the parts of the History that the Progression Rules will interact with, we've made the following distinctions:

Consecutive Trial History—the Consecutive Trial History provides the Beginning and Ending AVLs and the Trial Success or Failure for recent Trials. The Consecutive Trial History is used to determine changes to the Beginning AVL by the Progression Rules. When changes to the Beginning AVL are invoked, the Consecutive Trial History will be reset (i.e. previous Consecutive Trial History will be ignored for the purpose of Progression Rules only).

Note that Consecutive Trials are sub-activity/skill specific. Consecutive Trials include trials from any previous lessons that were traversed with the same sub-activity and skill.

Consecutive Lesson History—the Consecutive Lesson History provides the Lesson Success, Neutrality or Failure for recent Lessons. The Consecutive Lesson History is used to determine Changes based on Lesson Evaluation in the Progression Rules. When Changes based on Lesson Evaluation are invoked, the Consecutive Lesson History will be reset (i.e. previous Consecutive Lesson History will be ignored for the purpose of Progression Rules only).

Note that Consecutive Lessons include completed Lessons from the same sub-activity traversed during the same or previous Sessions.

7.2.1 Screen Navigation Overview

[See flowchart of FIG. 4.2]

7.2.2 Alphabet Activity Enablement Overview

7.2.2.1 Automatic Enablement

When are the Alphabet Sub-Activities Automatically Enabled?

1) Initially a child will have Alphabet Recognition Enabled.

a) The mode that Alphabet Recognition defaults to will depend on the child's initial placement.

b) Alphabet Recognition will default to Upper case. This might change by score, too

c) The child will begin lessons with a beginning AVL AVL2.

d) The child will move through settings for Alphabet Recognition based on progression rules (e.g. changes to the beginning AVL, changes to the number of responses).

e) If Alphabet Recognition is in Letters mode, it will automatically change to Sounds mode after the child has completed 2 consecutive Alphabet Assessments at Letters with 23 or more correct.

Listen to Sounds will automatically be Enabled after the child has completed 1 hour of total Alphabet time OR 2 consecutive Alphabet Assessments at Alphabet Sounds with 23 or more correct (note that this is true even if the child has never passed two consecutive Letters Assessments).

These are default settings. The teacher can alter the Trigger(s) for the Listen to Sounds sub-activity.

e.g.

| | | |
|---|---|---|
| Initial Assessment | Letters- | 21 correct |
| Teacher Prompted | Sounds | 23 correct |
| Assessment | — | |
| Automatic Ongoing | Letters- | 26 correct |
| Assessment | | |
| Teacher Prompted | Sounds | 26 correct |
| Assessment | — | |

At this point, two consecutive Sounds Assessments have been passed even though there was a Letters Assessment in between. As a result, the Listen to Sounds sub-activity will be Enabled (even though Letters has not been passed).

2) Once the Listen to Sounds task is available, the following defaults will occur:

a) The child will start with a beginning AVL=AVL2

b) The child will move through the Listen to Sounds curriculum and settings according to progression rules. If the child reaches the final lesson in the Find Sounds curriculum, the curriculum will recycle.

c) Find Sounds [Spelling] will be automatically Enabled after the child has achieved one of the following:

i) 6 consecutive lessons are passed at ≧75% at the Pivot or Target AVL

ii) 12 lessons are completed

iii) 2 hours of total Alphabet time.

These are default settings. The teacher can alter the Trigger(s) for the Find Sounds sub-activity.

3) Once Spelling is available, the following defaults will occur:

a) The child will start within the Automatic Curriculum, with a beginning AVL=Syl2.

b) The child will move through the Automatic Curriculum lessons according to progression rules.

c) The child will pass from the Automatic Curriculum to the Free Choice spelling once s/he has achieved one of the following:

i) completed the final wordlist in the Automatic Curriculum.

ii) 4 hours of total Alphabet time

These are default settings. The teacher can alter the Trigger(s) for Free Choice Spelling.

d) Free Choice Spelling will remain available to the child indefinitely. The child will move through settings for Free Choice Spelling according to the progression rules (e.g. alterations to Beg. AVL).

7.2.2.2 Manual Interactions

How do Teacher Interactions Effect the Automatic Availability of Alphabet Activities?

Enablement of Activities

The Teacher can enable any of the Alphabet Activities at any time. Furthermore:

the Teacher can change Alphabet Recognition from Letters to Sounds or vice versa. In the case where the Teacher changes the child from Sounds to Letters:

if the Child has not passed two consecutive Letters assessments, Sounds will be re-enabled when the child meets this criterion.

if the Child has previously passed two consecutive Letters assessments, Sounds will never automatically re-enable. Note that Assessments will continue based on Assessment history NOT based on the Alphabet Activity setting.

the Teacher can change the Spelling task from Automatic Curriculum to Free Choice or vice versa. In the case where the Teacher changes the child from Free Choice to Automatic Curriculum:

the Teacher will be required to set a Re-enablement criterion for Free Choice spelling. This Criterion can be a date or a specified amount of program time.

Disablement of Activities

Alphabet Activities will never become automatically disabled, however, a Teacher can disable any of the activities with the following rules: p1 If the Teacher disables an Alphabet Activity which would be used to trigger the availability of another, not yet available Activity, Enroll will require the teacher to set either a Re-enablement criterion for the Activity that is being disabled, or an Enablement criterion for the Activity which is yet to be Enabled. Criterions can be dates or specific amounts of program time.

If the Teacher disables an Alphabet Activity which will not be used to trigger the availability of another Activity, Enroll will provide the Teacher an option to set a Re-enablement criterion for the Activity being disabled, but the Teacher may choose not to do so.

7.3 Alphabet Menu screen

The Alphabet Menu screen will allow a child to choose between the available Alphabet Activities. The Alphabet Menu screen appears after a child has selected the Alphabet area on the Activity Selection screen.

What is displayed on the Alphabet Menu screen?

[see FIG. 4.3] Note the following in the figure:

Directions

Activity buttons (up to 4)

Activity audio button (one on each Activity button)

Go Back button

Help button

Child's Name

Patterns button

Alphabet song button

Backpack button

Reward button

Patterns button

Selecting the Patterns button will bring up the Patterns screen:

[See FIG. 4.4]

Target Text

Target Text will appear in the format specified for the InUse Pattern Topic. The portion of the Target Text which matches the InUse Category will appear in a different color than the rest of the text.

For Vowels, Target Text will appear in a Sounds Language Unit layout . . . letters will be grouped together by tokens. The text which corresponds to the word's vowel token will appear in red. E.g. c a p

For Rhyming, Target Text will appear with the Onset followed by a plus sign, followed by the Rime, followed by an equals sign, followed by the whole word. The Rime and the text which corresponds to the Rime in the whole word will appear in red. E.g. b+ack=back

For R Words, Target Text will appear as the Category vowel, followed by a plus sign, followed by the letter r, followed by an equals sign, followed by the Category vowel and r grouped together. The vowel and r grouped together will appear in red. E.g. u+r=ur

For Blends, Target Text will appear as the individual letters in the blend separated by plus signs, followed by an equals sign, followed by the letters in the blend grouped together. The letters in the blend grouped together will appear in red. E.g. c+r=cr

For Diagraphs, Target Text will appear as the first letter in the digraph, followed by the plus sign, followed by the second letter in the digraph, followed by the plus sing, followed by the two digraph letters grouped together. The digraph letter combination grouped together will appear in red. E.g. s+h=sh

Selecting Target Text will cause the associated LetterSound, LetterName, Onset, Rhyme or Word audio to play. Selecting the plus (+) or equals (=) signs will cause the audio ‘plus’ or ‘equals’ to play respectively. The selected text will highlight for the duration of the audio, after which it will return to unhighlighted.

Scroll Arrows—in the Rhyming Pattern Topic, up and down Scroll Arrows will appear above and below the Onset text.

Selecting an Arrow will briefly change the Arrow to InUse, cause the Onset to change to a different letter, and the whole word in the Target to change to the corresponding new word.

Onsets will be in an ordered loop according to the Onsets in the Sample Words. Choosing the Up Scroll Arrow will move one direction through this order, and choosing the Down Scroll Arrow will move the other direction through this order. The order will be determined by the Sample Words displayed on the screen only . . . moving from top to bottom, and then left to right.

The highlighted Onset in the Sample Words will change to reflect the word displayed in the Target.

[See FIG. 4.5]

Sample Word Headings—for the Vowel Pattern Topic, two headings will appear above the Sample Words. The heading over the left column will read ‘Short Vowel=V’ where the ‘V’ is replaced by the vowel with a short vowel diacritic mark above it (smiley face). The heading over the right column will read ‘Long Vowel=V’ where the ‘V’ is replaced by the vowel with the long vowel diacritic mark above it (straight line). Selecting a Heading will cause the associated Heading audio to play (e.g. ‘Short vowel equals ShortVowelSound’ and ‘Long vowel equals LongVowelSound’).

Sample Words—a list of up to eight sample words will appear in two columns. If more than 8 Sample Words exist, one or two down scroll arrows will appear at the bottom of the Sample Word columns. The portion of each Sample Word that matches the InUse Category will appear in a different color than the rest of the text.

For Vowels, the text which corresponds to the word's vowel token will appear in red. E.g. c a t

For Rhyming, the text which corresponds to the Rime will appear in red. E.g. c at

For R Words, the vowel and r grouped together will appear in red. E.g. c ar t

For Blends, the initial or final consonants grouped together will appear in red. E.g. sc a t

For Diagraphs, the digraph letter combination grouped together will appear in red. E.g. ch a t

Additionally, for the Rhyming Pattern Topic, the Onset for the word which corresponds to the word in the Target Area will appear in white.

Selecting a Sample Word will cause the associated Word Audio to play. The box framing the sample word will highlight for the duration of the audio.

If there are fewer than 8 Sample Words, the words will fill in Left to Right, Top to Bottom.

Sample Words Selection buttons—the Vowel and Rhyming Pattern Topics will have Selection buttons next to each Sample Word. Pressing a Selection button will cause the following sequence:

The Selection button will briefly change to InUse.

For the Rhyming Pattern Topic, the Onset of the selected Sample Word will appear white. All other Sample Words will have Onsets in black.

The box around the Sample Word will appear InUse for as long as the Sample Word is displayed in the Target box.

The text which corresponds to the selected Sample Word will appear in the Target Area.

For the Vowel Pattern Topic, the Sample Word will appear divided in the Sounds language unit. E.g. c a t

For the Rhyming Pattern Topic, the Sample Word will appear divided in the Onset/Rime language unit, with a plus sign between the onset and rime, an equals sign followed by the whole word. E.g. c at

The Target Audio button will change to InUse and the Target Audio will play.

The Target text will highlight in time to the corresponding segments of the audio, returning to an unhighlighted state when each segment is complete.

The Target Audio button will change to Available at the conclusion of all

Target Audio. The Target Audio is not interruptible.

7.4 Alphabet Recognition

7.4.1 Letter Selection Screen

7.4.1.1 What is Displayed on the Letter Selection Screen?

The SecondGradeLetterSelection screen is displayed (in FIG. 4.7) as an example of the Letter Selection screen.

[See FIG. 4.6] Note the following in the figure:

26 Letter buttons

Case Toggle button

Presentation Area with space for:

LetterText

Mouthposture/Sound box

Mnemonics box

Record button

Playback button

Go On button

Lesson Queue

Help button

Erase button

Go Back button

Take A Test button

Child's Name

7.4.1.2 What is the Initial Functionality of the Letter Selection Screen?

All visual components will appear except for the Letter/Text, Mouthposture/Sound and Mnemonic boxes (i.e. the Target Area will be clear).

The InitialLetterSelection audio message will play (e.g. ‘Select Letters to hear the name and sound for each letter. After you pick several letters, you can do lessons!’). This audio is not interrupted and mouse clicks made during the audio will be disregarded.

7.4.1.3 What is the Normal Functionality of the Letter Selection Screen?

Letter buttons—selecting a Letter button will cause the Letter Presentation to occur for the letter associated with the selected button:

1. The Target Area will clear.

2. The LetterText will appear. The LetterName audio will play. The LetterText will highlight for the duration of the audio, returning to an unhighlighted state at the completion of the audio.

3. The Mouthposture/Sound box will appear containing the associated Mouthposture graphic. The associated letter will appear below the box. The LetterSound audio will play. The mouthposture letter text will highlight for the duration of the audio, returning to an unhighlighted state at the completion of the audio.

4. The Mnemonic box will appear containing the associated Mnemonic graphic. The associated mnemonic word will appear below the box. The MnemonicWord audio will play. The mnemonic word text will highlight for the duration of the audio, returning to an unhighlighted state at the completion of the audio.

5. Both the selected Letter button and the Audio button will visually change from Available to InUse for the duration of the Letter Presentation. At the conclusion of the Letter Presentation, the Letter and Audio buttons will return to Available.

6. The selected letter will appear in the Lesson Queue in the leftmost empty slot as long as there is an empty spot AND the letter does not already appear in the queue. The letter will remain in the Queue until one of the following happens:

The Letter Selection screen is exited.

The letter is erased.

Additionally, if the letter that is displayed in the Presentation Area is selected again, the audio and highlighting will behave as above, but the visual components will stay visible on screen (they will not clear and reappear).

Letter Status Checkbox—a checkbox will appear below each Letter button.

The Letter Status Checkbox will appear empty for any Letter that has not been successfully identified in the most recent Alphabet Assessment in the same Mode as Alphabet Recognition.

The Letter Status Checkbox will appear full (checked) for any Letter that has been successfully identified in the most recent Alphabet Assessment in the same Mode as Alphabet Recognition.

Target Area—selecting an empty portion of the Target Area will cause no change.

LetterText—selecting the LetterText will cause the LetterName audio to play. The LetterText will highlight and the Audio button will change to InUse for the duration of the audio, returning to an unhighlighted state and Available (respectively) at the completion of the audio.

Mouthposture/Sound box -selecting a Mouthposture/Sound box or the letter below will cause the LetterSound audio to play. The mouthposture letter text will highlight and the Audio button will change to InUse for the duration of the audio, returning to an unhighlighted state and Available (respectively) at the completion of the audio.

Mnemonic box—selecting a Mnemonic box or the word below will cause the MnemonicWord audio to play. The Mnemonic word will highlight and the Audio button will change to InUse for the duration of the audio, returning to an unhighlighted state and Available (respectively) at the completion of the audio.

Lesson Queue

The Lesson Queue area will initially contain empty slots equal to the child's NumberofTrials value (4 or 8).

Every time a Letter button is selected, the corresponding letter will appear in the leftmost empty slot of the Lesson Queue. Modifications to this behavior are:

if the selected Letter already appeared in the Lesson Queue, no change will be made to the Lesson Queue.

if all the Lesson Queue slots are filled, the newly selected letter will not appear in the Lesson Queue.

As soon as the Lesson Queue is full, the following will happen:

The LessonsAreAvailable audio noise will play.

The Go On button will change from NotVisible to Available.

The letters that appear in the Lesson Queue are preserved as long as the child remains on the Letter Selection screen. E.g., if the child exits this screen and then returns, all the slots in the Lesson Queue will be empty.

Lesson Queue Letters—letters will appear in the Queue in the current Case (upper or lower). Selecting a Letter that appears in the Lesson Queue will cause the associated LetterName audio to play. The selected Letter will highlight for the duration of the audio, after which it will return to unhighlighted.

Lesson Queue Heading—selecting the Lesson Queue Heading will cause the LessonQueueHeading audio to play (e.g. My Lesson Letters).

Erase button—selecting the Erase button will ‘erase’ the right most letter in the Lesson Queue. The Erase button itself will briefly change to InUse. If the Go On button is Available, selecting the Erase button will change the Go On button to NotVisible.

Example of Lesson Queue behavior if 4 letters are required for lessons.

| | Letters appearing in | |
|---|---|---|
| | Lesson Queue from left to | Lesson |
| Button Selected | right | Availability |
| None | Empty | None |
| Alphabet button | A | None |
| ‘A’ | | |
| Alphabet button | A P | None |
| ‘P’ | | |
| Alphabet button | A P | None |
| ‘A’ | | |
| Alphabet button | A P S | None |
| ‘S’ | | |
| Alphabet button | A P S D | Available using |
| ‘D’ | | ‘A’ ‘P’ ‘S’ ‘D’ |
| Alphabet button | A P S D | Available using |
| ‘Y’ | | ‘A’ ‘P’ ‘S’ ‘D’ |
| Erase button | A P S | None |
| selected | | |
| Alphabet button | A P S T | Available using |
| ‘T’ | | ‘A’ ‘P’ ‘S’ ‘T’ |
| Alphabet button | A P S T | Available using |
| ‘U’ | | ‘A ’ ‘P’ ‘S’ ‘T’ |
| Go back button | Empty | None |
| selected, then | | |
| Alphabet | | |
| Recognition selected | | |
| again. | | |

Record button—the record button will be NotAvailable until the Target Box contains text. Once this happens, the Record button will become Available.

Selecting the Record button when NotAvailable will cause no change.

Selecting the Record button when Available will:

record any external sounds for the designated recording time.

change the button appearance from Available to InUse for the duration of the recording.

At the end of the recording, the button will revert to Available, the Playback button will change from Unavailable to Available and the audio most recently recorded for the Current Category during the current session will be available for playback. The recording will end when one of the following happens:

the record button is selected while it is InUse.

the designated recording time is up. The designated recording time will be 8 seconds.

Playback button

The playback button will visually appear as:

Unavailable if no recording is available for playback.

Available if a recording is available for playback and the recording is not currently being played.

InUse if a recording is being played.

Selecting the button when it is Unavailable will cause no change.

Selecting the button when it is Available will cause the available Recording audio to play. The Playback button will change to InUse for the duration of the audio, after which it will return to Available.

Selecting the button when it is InUse will interrupt the Recording audio and return the button to Available.

Note: the Recording audio is whatever recording was most recently made for the current Category.

Case Toggle button

Selecting the lowercase side (bottom) of the Case toggle button does the following:

If the Alphabet Frieze and Lesson Queue currently display lowercase letters, no change is made.

If the Alphabet Frieze and Lesson Queue currently display uppercase letters, the letters will be replaced with lowercase letters.

Selecting the uppercase side (top) of the Case toggle button does the following:

If the Alphabet Frieze and Lesson Queue currently display uppercase letters, no change is made.

If the Alphabet Frieze and Lesson Queue currently display lowercase letters, the letters will be replaced with uppercase letters.

Additionally, whichever side is selected will appear InUse while the unselected side appears Available. The uppercase side (top) will default to InUse.

Take A Test button—the Take A Test button will only appear if the ChildInitiatesTest option is enabled in Enroll AND the child hasn't yet passed both Sounds and Letters assessments. Selecting the Take A Test button will initiate the Assessment Alphabet Test.

The Alphabet Test's Case (upper or lower) and Mode (sounds or letters) and NumberofLettersDisplayed (26 or 13) will be determined by the child's Alphabet Assessment settings based on historical achievement. See the Assessment Spec.

The child will be tested on the entire alphabet during this session.

The child will not be allowed to Take A Test if s/he has <3 minutes remaining before his/her time limit is reached. In this case, selecting the Take A Test button will cause the NotEnoughTime audio to play (e.g. ‘You don't have enough time today to take an alphabet test. You can take a test at the beginning of your next turn!’).

If the child reaches his/her time limit while taking the Assessment Alphabet Test, s/he will not be kicked out of the program. The time-out sequence will not begin until either the Assessment is complete, or the AssessmentInactivity Timer 2 has expired.

After the test is complete, the child will return to the Letter Selection screen.

Any new letters that the child has passed will be reflected in the Letter Status Checkboxes. Other functionality will be normal.

Go Back button—selecting the Go Back button will take the child to the Alphabet Menu.

Go On button—the Go On button will appear as NotVisible UNLESS the number of letters in the Letter Queue=the NumberofTrials value. When this value has been reached the Go On button becomes Available. Selecting the Go On button when it is Available will cause the button to highlight briefly and then take the child to Alphabet Matching.

Help button—selecting the Help button will cause the LetterSelectionHelp audio/tutorial to play.

The Help button will visually change from Available to InUse for the duration of the audio, returning to Available when the audio is complete.

If the Help button is selected while InUse, the help audio/tutorial will be interrupted and the button will return to Available.

Child's Name—the child's name is inactive, selecting the name will cause no change.

Backpack button—the Backpack button is only Available if the Rewards Activity is Enabled. Selecting the Available Backpack button will cause the Status pop-up window to appear. Normal Letter Selection/Preview screen functionality will not be available until the Status window has been closed. See the Reward Specification for details.

Inactivity—

If the child does not select an active area on the screen for 30 seconds, the LetterSelectionInactivity audio/tutorial will automatically begin to play.

If the child does not select an active area for 3 minutes after the completion of the LetterSelectionInactivity audio/tutorial, the child will be returned to the Alphabet Menu screen.

Letter Selection Inactivity Timer 1

| | |
|---|---|
| Start | Letter Selection |
| | screen appears |
| Duration | 30 seconds |
| Reset | Selection of |
| | Active Area |
| Expiration | LetterSelection/ |
| Action | Inactivity |
| | audio/tutorial |
| | commences |
| Timer | Timer Expires |
| Cancel | or screen exited |

Letter Selection Inactivity Timer 2

| | |
|---|---|
| Start | Completion of Letter |
| | Selection Inactivity Timer |
| | 1 Expiration Action. |
| Duration | 3 minutes |
| Reset | Selection of Active Area |
| Expiration | Alphabet Menu appears |
| Action | |
| Timer | Timer Expires or screen |
| Cancel | exited |

Mouse Rollover—if the cursor passes over any click-able (i.e. Available) area, that area will highlight for as long as the cursor remains over it. Buttons with text on them should have a rollover state, however Letter text should not have rollover states. Note that during audio play, many areas become non click-able, and as a result will not have mouse rollover behavior for the duration of the audio.

Background—the Background is not active. Selecting any part will cause no change.

7.4.2 Alphabet Matching Screen

The Alphabet Matching screen appears after the Go To Matching button has been selected from the Letter Selection/Practice screen.

7.4.2.1 What is displayed on the Alphabet Matching screen?

[see FIG. 4.7]. Note the following in the figure:

Target Area

Target Audio button

Target Picture

Target Whole

Response Areas (2-4)

Response Picture

Response Bubble

Response Audio button

Response Whole

Help button

Child's Name

Trial Counter

Lesson Info

7.4.2.2 What Happens When an Answer is Submitted?

When an answer is submitted, it will be evaluated for correctness, and subsequent actions will occur as listed below:

Correct Answer—if the submitted answer was the Correct Answer, the Trial is complete:

The highlighted trial counter will fill in.

If the Trial is evaluated as Successful, the corresponding trial image will fill in with the SuccessColor. A ‘Correct’ sound effect will be heard.

If the Trial is evaluated as Failed, the corresponding trial image will fill in with the FailureColor.

If the Matching Task is not complete, the next Trial will be presented with the Initial Functionality described above.

If the Matching Task is complete, the child will be taken to the Lesson Choice screen.

See the Progression rules for how to determine if a Trial was Successful or Failed.

Incorrect Answer

If the submitted answer was an Incorrect Answer and the child's Current AVL>1 then the Current AVL will be decreased by 1.

Any images already on the screen will remain visible in their current locations. This includes any On Demand images that have already been explored

If additional graphics and/or buttons need to be available as a result of the decreased AVL, these will appear.

The appropriate FailingHelp message will play.

If the submitted answer was the Incorrect Answer and the child's Current AVL=AVL 1, then the Correct Answer will be chosen automatically:

The 1^{st} half of the AVL1 FailingHelp message will play followed by the AnswerAudio that corresponds to the Correct Answer. When this is done playing, the program will automatically select the Correct Answer. The Correct Answer will remain on the screen for an additional 5 seconds after which the corresponding trial image will fill in with the color for incorrect answers.

If the Matching Task is not complete, the 2^{nd} half of the AVL1 FailingHelp message will play followed by the presentation of the next question with the initial functionality described above.

e.g. ‘The correct answer is A.’ (correct answer is automatically selected). ‘Let's try another question.’

Where: ‘The correct answer is’=the 1^{st} half of the failing help message ‘A’=the Correct Answer audio

‘Let's try another question’=the 2^{nd} half of the failing help message.

If the Matching Task is complete, the ₂nd half of the AVL1 FailingHelp message will NOT play and the child will be taken to the Lesson Choice screen.

7.4.2.3 How is the Audio Determined (Letter Names or Letter Sounds)?

The audio that plays for the Targets and Responses is determined by the Alphabet Mode. If the mode is Letters, the Letter Name audio will be associated with each letter. If the mode is Sounds, the Letter Sound audio will be associated with each letter. The progression rules automatically determine the Alphabet Mode, and the teacher can further modify it in Enroll.

7.4.2.4 How is the Wordlist Content Determined?

The content is determined by the letters the child selected for the Letter Queue on the preceding Selection screen. See the Structural Overview: Wordlist Rules for Dynamically Generated Wordlists.

7.4.2.5 What are the Dynamic Lesson Progression Rules?

1) Movement within an Alphabet Matching Task

a) The child will be presented with the first trial at his/her beginning AVL level for the current Mode.

b) If the child submits the wrong response at the beginning AVL, s/he will immediately be presented with the same trial at the next lowest AVL. This adjustment will continue until the child either submits the correct response, or submits the wrong response at the lowest possible AVL. If the latter is the case, the correct response will be presented to the child automatically.

c) When the child has submitted the correct answer, or the incorrect answer at AVL 1, s/he will be presented with the next Trial.

d) If the child submits the correct answer at the beginning AVL, the Trial is considered Successful.

e) If the child does not select the correct answer at the beginning AVL, the Trial is considered Failed.

2) Changes To the Beginning AVL

a) If 3 of 3 or 3 of 4 consecutive Trials are Successful, the Beginning AVL will increase by 1, and the Consecutive Trial History will be ‘cleared’.

b) If 2 of 2 or 2 of 3 consecutive Trials are Failed, the Beginning AVL will decrease to the highest Ending AVL from the Failed trials and the Consecutive Trial History will be ‘cleared’.

Note: when examining ‘consecutive trials”, the program must look historically across Alphabet Recognition for any previous experience with the same Mode as the child's current Mode.

3) Lesson Evaluation

a) If <50% of the Trials were Successful at the Pivot or Target AVLs, the Lesson=Failed.

b) If ≧50% and <75% of the Trials were Successful at the Pivot or Target AVLs, the Lesson=Neutral.

c) If ≧75% of the Trials were Successful at the Pivot or Target AVLs, the Lesson=Successful.

4) Movement based on Lesson Evaluation

Once any of the following rules are invoked, the Consecutive Lesson History will be ‘cleared’.

a) If 3 out of 3 or 3 out of 4 consecutive Lessons have been Successful AND the current NumberofResponses <4, then the NumberofResponses will be increased by 1.

b) If 2 out of 2 or 2 out of 3 consecutive Lessons have been Failed AND the current NumberofResponses >2, then the NumberofResponses will be decreased by 1.

7.4.2.6 Which AVL Set is Uses?

The AVL set used is AlphabetDynamicLessonsStandard

| AVL 1 | Question | Responsea |
|---|---|---|
| Audio | I | OD |
| Picture | I | I |
| Text | I | I |

| AVL 2 | Question | Response |
|---|---|---|
| Audio | I | OD |
| Picture | OD | I |
| Text | OD | I |

| AVL 3 | Question | Response |
|---|---|---|
| Audio | I | N |
| Picture | N | OD |
| Text | N | I |

7.5 Listen to Sounds

The Listen to Sounds sub-activity becomes automatically Enabled after the child has passed two consecutive Sounds Alphabet Assessments or accumulated 1 hour of total Alphabet time.

The teacher may manually Enable Listen to Sounds in Enroll.

The Listen to Sounds Practice screen will appear at the start of each new Listen to Sounds Lesson. Thus, the child may see the Listen to Sounds Practice screen after selecting the Listen to Sounds button on the Alphabet Menu, or after selecting the Go On button from the Lesson Choice screen while in the Listen to Sounds sub-activity.

7.5.1.1 What is Displayed on the Explore Words Practice Screen?

[See FIG. 4.81]

Target Area containing:
Target Whole Audio button
Target Whole Text
Target Picture
Record button
Playback button
Target Parts Frame containing
Target Parts
Word List containing:
4 or 8 Selection symbols
4 or 8 Whole Text entries
Help button
Go On button
Child's Name
Lesson Information
Trial Counter containing 4 or 8 Trial
Symbols

7.5.1.2 Listen to Sounds Matching Screen

The Listen to Sounds Matching screen will appear after the child has completed the Listen to Sounds Practice screen for a Lesson. Thus, the child may see the Listen to Sounds Matching screen after selecting the Listen to Sounds button on the Alphabet Menu, or after selecting the Go On button from the Lesson Choice screen while in the Listen to Sounds sub-activity.

7.5.1.3 What is Displayed on the Listen to Sounds Screen?

[See FIG. 4.9] Note the following in the figure:

Target Area including:
Target Audio button
Target Picture
Target Parts Mouthpostures
Target Parts Text
Record button
Playback button
Explore Response Area including:
Explore Response Audio button
Space for Explore Response Picture
Space for Explore Response Parts
Mouthpostures
Space for Explore Response Parts Text
2-4 Responses each with:
Response Picture
Selection button
Audio button
Whole text
Response button
Help button
Child's name
Trial counter with 4 or 8
symbols

7.5.1.4 What Happens when an Answer is Submitted?

When an answer is submitted it will be evaluated for correctness, and the following actions will occur:

Correct Answer—if the submitted Answer is Correct the Trial is complete:

The highlighted trial counter will fill in.

If the Trial is evaluated as Successful, the corresponding trial image will fill in with the SuccessColor. A ‘Correct’ sound effect will play.

If the Trial is evaluated as Failed, the corresponding trial image will fill in with the FailureColor.

If the Listen to Sounds Task is not complete, the next Trial will be presented with the Initial Functionality described above.

If the Listen to Sounds Task is complete, the child will be taken to the Lesson Choice screen.

See the Progression rules for how to determine if a Trial was Successful or Failed.

7.5.1.5 What are the Listen to Sounds Progression Rules?

1) Movement within a Listen to Sounds Task

a) The child will be presented with the first trial at his/her beginning AVL level.

b) If the child submits the wrong response at the beginning AVL, s/he will immediately be presented with the same trial at the next lowest AVL. This adjustment will continue until the child either submits the correct response, or submits the wrong response at the lowest possible AVL. If the later is the case, the correct response will be presented to the child automatically.

c) When the child has submitted the correct answer, or the incorrect answer at AVL 1, s/he will be presented with the next Trial.

d) If the child submits the correct answer at the beginning AVL, the Trial is considered Successful.

e) If the child does not select the correct answer at the beginning AVL, the Trial is considered Failed.

2) Changes To the Beginning AVL

a) If 3 of 3 or 3 of 4 consecutive Trials are Successful, the Beginning AVL will increase by 1, and the Consecutive Trial History will be ‘cleared’.

b) If 2 of 2 or 2 of 3 consecutive Trials are Failed, the Beginning AVL will decrease to the highest Ending AVL from the Failed trials and the Consecutive Trial History will be ‘cleared’.

Note: when examining ‘consecutive trials’, the program must look historically across Listen to Sounds Lessons for any previous experience in this activity.

3) Lesson Evaluation

a) If <50% of the Trials were Successful at the Pivot or Target AVLs, the Lesson=Failed.

b) If ≧50% and <75% of the Trials were Successful at the Pivot or Target AVLs, the Lesson=Neutral.

c) If ≧75% of the Trials were Successful at the Pivot or Target AVLs, the Lesson=Successful.

4) Movement based on Lesson Evaluation

a) Once any of the following rules are invoked, the Consecutive Lesson History will be ‘cleared’.

b) If 3 out of 3 or 3 out of 4 consecutive Lessons have been successful AND the current NumberofResponses <4, the NumberofResponses will be increased by 1.

c) If 3 out of 3 or 3 out of 4 consecutive Lessons have been successful AND the current NumberofResponses=4, the child will be taken next to the first Lesson in the Next wordlist.

d) If 2 out of 2 or 2 out of 3 consecutive Lessons have been Failed AND the current NumberofResponses >2, the number of responses will be decreased by 1.

Which AVL Set is used for Listen to Sounds?

The AlphabetListenToSoundsStandard AVL set is used for Listen to Sounds. It consists of the following AVLs:

Listen to Sounds AVL1

| | | | | Explore | Explore |
|---|---|---|---|---|---|
| | Target | Target | Response | Response | Response |
| | Whole | Parts | Whole | Whole | Parts |
| Picture | I | I | I | I | I |
| Audio | I | I | OD | OD | OD |
| Text | N | I | I | I | I |

Listen to Sounds AVL2

| | | | | | Explore |
|---|---|---|---|---|---|
| | Target | Target | Response | Explore Response | Response |
| | Whole | Parts | Whole | Whole | Parts |
| Picture | I | I | I | I | I |
| Audio | OD | I | OD | OD | OD |
| Text | N | I | I | I | I |

Listen to Sounds AVL3

| | | | | Explore | Explore |
|---|---|---|---|---|---|
| | Target | Target | Response | Response | Response |
| | Whole | Parts | Whole | Whole | Parts |
| Picture | OD | OD | OD | OD | OD |
| Audio | I | OD | OD | OD | OD |
| Text | N | OD | I | I | I |

Listen to Sounds AVL4

| | | | | Explore | Explore |
|---|---|---|---|---|---|
| | Target | Target | Response | Response | Response |
| | Whole | Parts | Whole | Whole | Parts |
| Picture | OD | OD | OD | OD | OD |
| Audio | OD | I | OD | OD | OD |
| Text | N | OD | I | I | OD |

Listen to Sounds AVL5

| | | | | Explore | Explore |
|---|---|---|---|---|---|
| | Target | Target | Response | Response | Response |
| | Whole | Parts | Whole | Whole | Parts |
| Picture | N | N | N | N | N |
| Audio | I | OD | OD | OD | OD |
| Text | N | OD | I | I | N |

Listen to Sounds AVL6

| | | | | Explore | Explore |
|---|---|---|---|---|---|
| | Target | Target | Response | Response | Response |
| | Whole | Parts | Whole | Whole | Parts |
| Picture | N | N | N | N | N |
| Audio | N | I | N | N | OD |
| Text | N | N | I | I | N |

7.6 Spelling

Spelling can be enabled with an Automatic Curriculum or as Free Choice.

Automatic Curriculum—when Spelling has an Automatic Curriculum, the child will work through the Spelling Curriculum, spelling words contained in the Spelling Wordlists. Each Spelling Lesson will begin with a Spelling Practice screen, followed by the Spelling Screen, and conclude with a Word Rec screen UNLESS the teacher has disabled Word Rec in Spelling.

Free Choice—when the Spelling curriculum is Free Choice, the child will pick which words s/he wants to spell. These words will then appear on the Spelling Screen. Each Spelling Task will begin with the Spelling Word Selection screen, followed by the Spelling screen, and conclude with a Word Rec screen UNLESS the teacher has disabled Word Rec in Spelling.

The Automatic Curriculum will be enabled automatically after the child has succeeded at 6 consecutive Find Sounds lessons OR completed 12 Find Sounds lessons OR accumulated 1 hours of total Alphabet Time after the Find Sounds activity was Enabled AND the teacher has not disabled Spelling; Automatic Curriculum.

Free Choice will be enabled automatically after the child has completed the final lesson in the Automatic Curriculum OR accumulated 2 hours of total Alphabet Time after Spelling became enabled AND the teacher has not disabled Spelling; Free Choice.

Either Automatic Curriculum or Free Choice can be enabled manually by the Teacher in Enroll.

7.6.1 Spelling Practice Screen

The Spelling Practice screen will appear only when the Automatic Curriculum is Enabled for Spelling. When this is true, each Spelling Lesson will begin with the Spelling Practice screen. This means the Spelling Practice screen can appear:

after a child selects Spelling from the Alphabet Menu.

after a child selects Go On from the Lesson Choice screen while in the Spelling

sub-activity of Alphabet.

The Spelling practice screen is identical in layout and functionality as the Alphabet Practice screen described for Listen to Sounds with only two exceptions:

selecting the Go On button will take the child directly to the Spelling screen as opposed to the Lesson Choice screen.

the Target Parts will be different: for Spelling, the Letters Language Unit will be used, meaning each part reflects a single letter in the stimulus’native text.

The result will look something like the following for the Target Parts:

[See FIG. 4.10]

7.6.2 Spelling Word Selection Screen

7.6.2.1 When does the Spelling Word Selection Screen Appear?

The Spelling Word Selection screen will appear only when Free Choice is Enabled for Spelling. When this is true, each Spelling Lesson will begin with the Spelling Word Selection screen. This means the Spelling Word Selection screen can appear:

after a child selects Spelling from the Alphabet Menu.

after a child selects Go On from the Lesson Choice screen.

7.6.2.2 What will Appear on the Spelling Word Selection Screen?

[See FIG. 4.11] Note the following in the figure:

Letter Links (26)
Active Letter
Available Words containing:
Words
Selection arrows
Scroll Arrows
Word Status Checkmarks
Go Back button
Help button
Record button
Playback button
Word List Queue containing
Selected Words
De-selection arrows
Word Status Checkmarks
Go On button
Child's Name

7.6.2.3 What is the Initial Functionality on the Spelling Word Selection Screen?

All visual components of the screen will appear except:

The Word Frame will appear empty.

The Word List Queue will appear identically to the last time the child exited the Word Selection screen (if the child has never been to the Word Selection screen before, the Word List Queue will be empty). Any words that have been spelled correctly by the child will have a checkmark next to them. See the Progression Rules for how to determine if a word has been spelled correctly.

If no words appear in the Word List Queue, the InitialWordSelectionEmptyQueue audio will play (e.g. ‘Press a letter to see a list of words. Choose words for your spelling list.’).

If one or more words appear in the Word List Queue, the InitialWordSelectionFullQueue audio will play (e.g. ‘Here is your last spelling list. Choose new words for your spelling list or go straight to Spelling).

If four or more words appear in the Word List Queue, the Go On button will be Available.

7.6.2.4 What is the Normal Functionality on the Spelling Word Selection Screen?

Letter Links—selecting one of the 26 letter links will cause the following:

the selected letter will become the Active Letter. The Active Letter text will display the selected letter.

the Word Frame will display the first 12 Available Words assigned to the Active Letter. Note: the teacher has the ability to filter the Available Words through Enroll. If a filter is on, only those words passing the filter will be displayed (e.g. the filter might by ‘1 syllable words’ in which case only one syllable words beginning with the Active Letter will be displayed.).

Available Words—

Word—selecting an Available Word will play the associate WordAudio. The Word text will highlight for the duration of the audio and return to an unhighlighted state when the audio is complete. Rolling over a Word will cause the associated Selection button to appear.

Checkmark—a checkmark will appear next to any word that has been correctly spelled the most recent time the child encountered it in the Spelling Task Selecting a Checkmark causes no change. See the Progression Rules for how to determine if a word has been correctly spelled.

Selection button—selecting a Selection button will cause the associated Word to be selected for Spelling.

The associated Word will appear in the top-most empty spot of the Word List Queue.

The associated Word in the list of Available Words will appear as NotAvailable for as long as the word appears in the Word List Queue.

Rolling over a NotAvailable word will NOT cause the selection arrow to appear.

Additionally:

if the Word List Queue now contains 4 words the Go On button will become Available.

if the Word List is now full, the following will happen:

the Word List Frame will appear empty.

the Letter Links and any Sorting Buttons will become NotAvailable.

Scroll Arrows—

the Up Scroll Arrow will be NotVisible if the first word in the Word frame list appears in the Word Frame OR no words appear in the Word Frame. Otherwise, the Up Scroll arrow will be Available.

the Down Scroll Arrow will appear NotVisible if the last word in the Word frame list appears in the Word Frame OR no words appear in the Word Frame. Otherwise, the Down Scroll arrow will be Available.

selecting a Scroll Arrow when it is Available will cause the Word frame list to scroll up or down by one line/word in the same direction as the Arrow selected.

Word List Queue—selecting any part of the Word List Queue not listed below will cause no change.

Heading—a heading will appear (e.g. ‘My Spelling List:’). Selecting the heading will cause the associated HeadingAudio to play.

Wordlist Words—any words which have been selected from the Word Frame list will appear in the Word List Queue. Selecting one of these words will cause the associated WordAudio to play. The associated text will highlight for the duration of the audio and return to unhighlighted state at the completion of the audio. Rolling Over a word list word will cause the De-selection button to appear.

Checkmark—a checkmark will appear next to any word that has been correctly spelled the most recent time the child encountered it in the Spelling Task. Selecting a Checkmark causes no change. See the Progression Rules for how to determine if a word has been correctly spelled.

De-Selection button—selecting a De-Selection button will remove the associated word from the Word List Queue.

If other Words were listed below the de-selected word, they will each move up one slot in the Word List Queue.

The associated Word will become Available in the list of Available words (note that the current list of Available Words may not show the de-selected word. In this case, there will be no change to the current list of Available Words that is displayed).

If the Word List now has <4 words in it, the Go On button will become NotVisible.

If the Word List Queue was filled, the following will happen:

the most recently displayed list of Available words will appear.

the Letter Links and Sorting buttons will become Available.

Erase button—selecting the Erase button will clear the entire Wordlist Queue. The same resulting behavior will occur as selecting a de-selection button, except that it will apply to all the words in the Wordlist Queue at once.

Record button—the record button will be NotAvailable until the Target Box contains text. Once this happens, the Record button will become Available.

Selecting the Record button when NotAvailable will cause no change.

Selecting the Record button when Available will:

record any external sounds for the designated recording time. change the button appearance from Available to InUse for the duration of the recording.

At the end of the recording, the button will revert to Available, the Playback button will change from Unavailable to Available and the audio most recently recorded for the Current Category during the current session will be available for playback. The recording will end when one of the following happens:

the record button is selected while it is InUse.

the designated recording time is up. The designated recording time will be 8 seconds.

Playback button

The playback button will visually appear as:

Unavailable if no recording is available for playback.

Available if a recording is available for playback and the recording is not currently being played.

InUse if a recording is being played.

Selecting the button when it is Unavailable will cause no change.

Selecting the button when it is Available will cause the available Recording audio to play. The Playback button will change to InUse for the duration of the audio, after which it will return to Available.

Selecting the button when it is InUse will interrupt the Recording audio and return the button to Available.

Note: the Recording audio is whatever recording was most recently made for the current Category.

Go On button—selecting the Go On button will cause the Spelling Screen to appear. The Go On button will be Available whenever 4 or more words appear in the Word List Queue. Otherwise, it will be NotVisible.

Help button—selecting the Help button will cause the WordSelectionHelp audio/tutorial to play.

The Help button will visually change from Available to InUse for the duration of the audio, returning to Available when the audio is complete.

If the Help button is selected while InUse, the help audio/tutorial will be interrupted and the button will return to Available.

Go Back button—selecting the Go Back button will take the child to the Alphabet Menu.

Child's Name—the child's name is inactive, selecting the name will cause no change.

Inactivity—If the child does not select an active area on the screen for 30 seconds, the WordSelectionInactivity audio/tutorial will automatically begin to play. If the child does not select an active area for an additional 3 minutes the child will be if returned to the Alphabet Menu screen.

Word Selection Inactivity Timer 1

| | |
|---|---|
| Start | Word Selection |
| | screen appears |
| Duration | 30 seconds |
| Reset | Selection of |
| | Active Area |
| Expiration | WordSelectionIn |
| Action | activity |
| | audio/tutorial |
| | commences |
| Timer | Timer Expires or |
| Cancel | screen exited |

Word Selection Inactivity Timer 2

| | |
|---|---|
| Start | Completion of Word Selection |
| | Inactivity Timer 1 Expiration Action. |
| Duration | 3 minutes |
| Reset | Selection of Active Area |
| Expiration Action | Alphabet Menu appears |
| Timer Cancel | Timer Expires or screen exited |

Mouse Rollover—if the cursor passes over any click-able (i.e. Available) area, that area will highlight for as long as the cursor remains over it. Buttons with text on them should have a rollover state, however Stimuli text should not have rollover states. Note that during audio play, many areas become non click-able, and as a result will not have mouse rollover behavior for the duration of the audio.

Time Out—if the child's Time Limit is reached while on the Select a Word screen, the NotEnoughTimeForSpelling audio will play (e.g. ‘You don't have enough time to spell these words today. I'll save your spelling list for next time.’) followed by the Exit Sequence.

7.6.3 Main Spelling Screen

The Spelling screen will appear in the following cases

Spelling will appear after the child selects the Go On button from the Spelling Practice screen.

Spelling will appear after the child selects the Go On button from the Word Selection screen.

Note: the spelling screen is linked to either the Practice screen (Automatic Curriculum), or the Word Selection screen (Free Choice). It will never appear during a session unless the child has previously during the same session seen the appropriate linked screen.

7.6.3.1 What is displayed on the Spelling Screen?

[see FIG. 4.12] Note the following in the figure:

| | |
|---|---|
| Target box | Answer Area |

| | |
|---|---|
| Target Audio button | Answer parts |
| Target Picture | Answer bubble |
| Target Whole | Erase button |
| Target Parts | Answer Audio button (appears |

| | |
|---|---|
| Keyboard | When answer is complete) |

| | |
|---|---|
| Letter buttons | Child's Name |
| Letter Audio buttons | Trial Counter |

| | |
|---|---|
| Lesson Information | Help button |

7.6.3.2 What Happens when an Answer is Submitted?

Correct—if the child submits a correctly spelled word, the Trial will be Complete. Note that for AVLs 1-4 by default all words will be correctly spelled when they are submitted (this is a result of the immediate feedback the program provides). Thus, each word will only be seen at one AVL when the beginning AVL is 1-4.

Incorrect—

if the child submits a word that is Incorrectly spelled, then the Current AVL will be decreased by 1 and the child will have another chance to spell the word.

Note that for spelling, this only applies to AVLs 5 and 6. At AVLs 1-4, the child (by default) cannot submit an incorrectly spelled word.

Any images or text already on the screen will remain visible in their current locations. This includes any On Demand images that have already been explored.

If additional graphics and/or text need to be available as a result of the decreased AVL, these will appear (e.g. if the TargetPicture is

OnDemand in the lowered AVL, but was Never in the failed AVL).

The appropriate FailingHelp message will play.

Any Initial audio will play.

Evaluations—once a Trial is complete, it will be evaluated:

For AVLs 1-4, the Trial will be considered Failed if the child selected any incorrect letters at any AVL.

For AVLs 1-4, the Trial will be considered Successful if the child selected only correct letters for the entire word at the Beginning AVL.

For AVLs 5-6, the Trial will be considered Failed if the child submits an incorrectly spelled word.

For AVLs 5-6, the Trial will be considered Successful if the child submits a correctly spelled word.

When a Trial is complete:

the highlighted Trial symbol will fill in with the CorrectColor if the Trial was Successful or the IncorrectColor if the Trial was Failed.

if the Task is also complete, the LessonsChoice screen will appear.

if the Task is not complete, the next Trial will be presented with Initial Functionality.

7.6.3.3 Which AVL Set is Used for Spelling?

The AlphabetSpellingStandard AVL set is used for the Spelling sub-activity. This AVL set consists of the following AVLs:

| Syllable AVL 1 | Target Whole | Target Parts |
|---|---|---|
| Audio | I | I |
| Picture | I | |
| Text | I | I |

7.6.4 Word Recognition Screen

When will the Word Recognition screen appear?

The Word Recognition screen will follow a completed Spelling screen UNLESS the teacher has disabled the Word Recognition [symbol] the Word Recognition screen can appear after the child selec [symbol] on the Alphabet menu, or the Go On button on the Lesson Choi [symbol] Spelling sub-activity, depending upon where the child is in the current Spelling Lesson.

The Word Recognition screen will appear and function identically to the Alphabet Matching screen detailed for the Alphabet Recognition sub-activity, with the following exceptions:

the Text will be the whole stimuli.

the Pictures will be the StimuliGraphics

the AVL Set is different (see below).

Which AVL set is used for Word Recognition in the Spelling sub-activity?

The AlphabetWordRecognitionStandard AVL set is used for Word Recognition in the Spelling sub-activity.

Word Recognition AVL1

| | Target | Target | Response | Response |
|---|---|---|---|---|
| | Whole | Parts | Whole | Parts |
| Picture | N | N | I | N |
| Audio | OD | N | OD | N |
| Text | I | N | N | N |

Word Recognition AVL2

| | Target | Target | Response | Response |
|---|---|---|---|---|
| | Whole | Parts | Whole | Parts |
| Picture | N | N | I | N |
| Audio | OD | N | N | N |
| Text | I | N | N | N |

Word Recognition AVL3

| | Target | Target | Response | Response |
|---|---|---|---|---|
| | Whole | Parts | Whole | Parts |
| Picture | N | N | I | N |
| Audio | N | N | N | N |
| Text | I | N | N | N |

7.6.5 What are the Progression Rules for Spelling?

1) A Spelling Lesson will always begin with Spelling Practice (Forced Curriculum) or Word Selection (Free Choice) after which the Spelling Skill will be presented.

2) Movement within the Spelling Skill

a) The child will be presented with the first trial at his/her beginning AVL.

b) If the child submits an incorrectly spelled word at the beginning AVL, s/he will immediately be presented with the same trial at the next lowest AVL. This adjustment will continue until the child submits a correctly spelled word.

c) When the child has submitted a correctly spelled word s/he will be presented with the next Trial.

d) The Trial will be considered Failed if:

i) the AVL is 1-4 and the child selected any incorrect letters at any AVL.

ii) the AVL is 5-6 and the submitted answer is incorrectly spelled.

e) The Trial will be considered Successfull if:

i) the AVL is 1-4 and the child selected only correct letters for the entire word at the Beginning AVL.

ii) the AVL is 5-6 and the submitted answer is incorrectly spelled.

Note: by default, the child will submit a correctly spelled word at AVL levels 1-4. The trial will be complete as soon as the word has been submitted, but will only be evaluated as successful if the child never selected any incorrect letters when spelling the word.

3) Changes To the Beginning AVL

(1) If 3 of 3 or 3 of 4 consecutive Trials are Successful, the Beginning AVL will increase by 1, and the Consecutive Trial History will be ‘cleared’.

(2) If 2 of 2 or 2 of 3 consecutive Trials are Failed, the Beginning AVL will decrease by one and the Consecutive Trial History will be ‘cleared’.

Note: when examining ‘consecutive trials’, the program must look across Spelling Lessons.

4) Skill Evaluation

a) If <50% of the Trials were Successful at the Pivot or Target AVLs, the Skill=Failed.

b) If >50% and <75% of the Trials were Successful at the Pivot or Target AVLs, the Skill=Passed.

c) If >75% of the Trials were Successful at the Pivot or Target AVLs, the Skill=Successful.

5) Movement to Word Recognition Skill

At the completion of the Spelling Task, the child will go on to the Word Recognition Task UNLESS Word Recognition has been disabled. The child will move through this skill as described in Rules 2 and 3 and it will be evaluated by Rule 4. After the Word Rec skill, the Lesson will be complete.

6) Evaluation of Lesson

The evaluation of a Lesson is based on how the child did on average across all the trials for both skills:

a) If <50% of the Trials were Successful at the Pivot or Target AVLs, the Lesson=Failed.

b) If >50% and <75% of the Trials were Successful at the Pivot or Target AVLs, the Lesson=Neutral.

c) If >75% of the Trials were Successful at the Pivot or Target AVLs, the Lesson=Successful.

7) Results based on Skill Evaluation

a) If 3 of 3 or 3 of 4 consecutive Lessons are traversed in which the Word Rec skill is Successful AND the NumberofResponses <4, the NumberofResponses value will be increased by 1.

b) If 2 of 2 or 2 of 3 consecutive Lessons are traversed in which the Word Rec skill is Failed AND the NumberofResopnses >2, the NumberofResponses will be decreased by 1.

8) Results based on Lesson Evaluation

a) could include a clause for skipping lessons here

b) If the child is in the Automatic Curriculum mode of Spelling, and s/he Succeeds at 6 consecutive Spelling Lessons in the [symbol] portion of the Automatic Curriculum, an Update will be sent to the Teacher advising that s/he enable Free Choice Spelling for this child.

9) Determination of Correctly Spelled Words

Any Word in a Successful Trial is considered Successfully Spelled (i.e. no wrong letters submitted).

8 SPEC D: Teacher Application—Enroll as Related to Stories

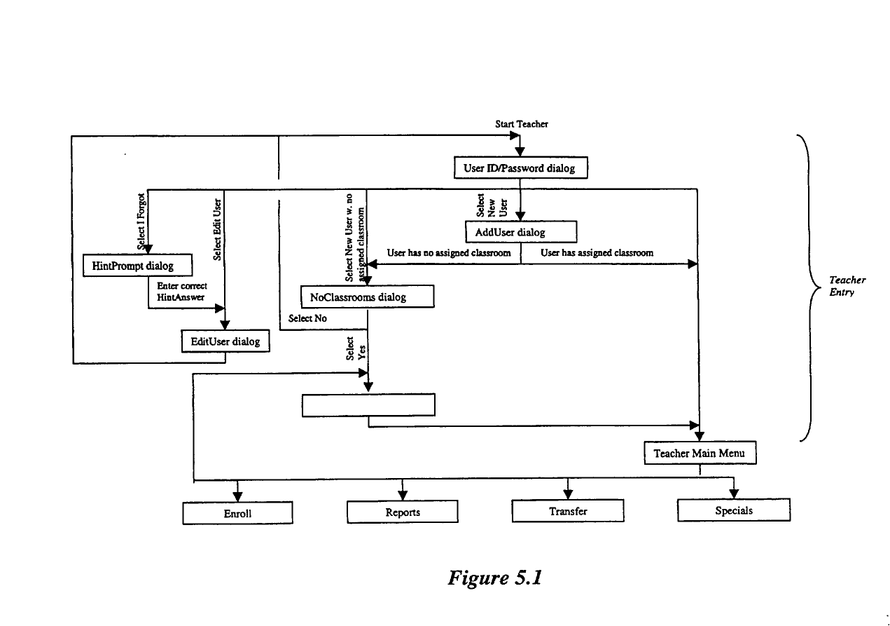

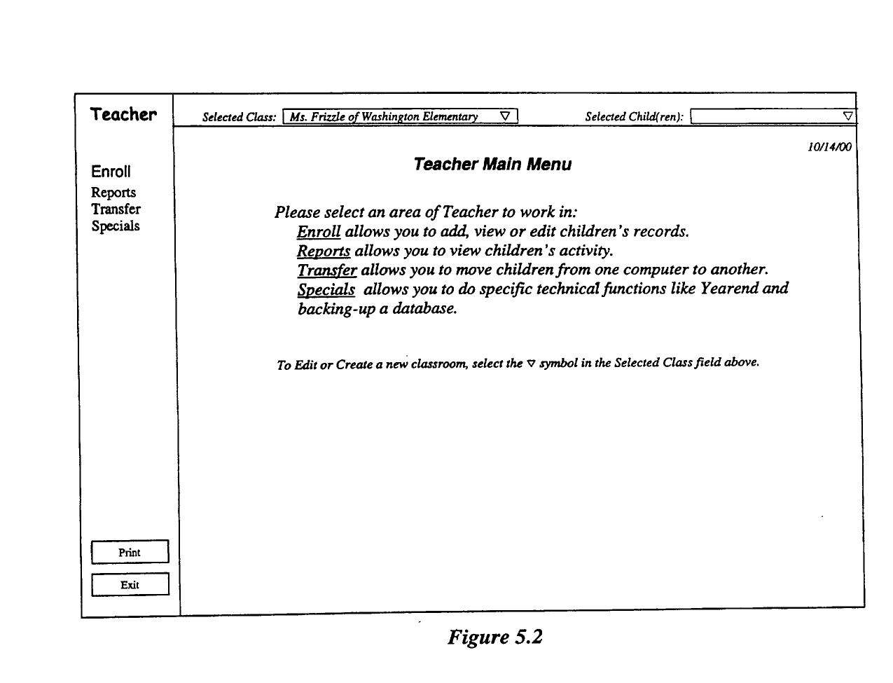

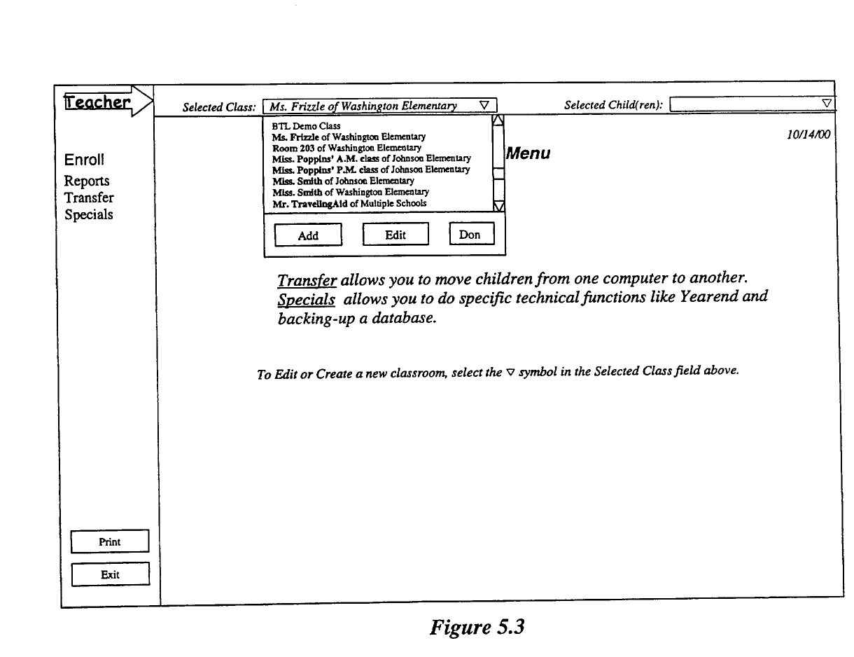

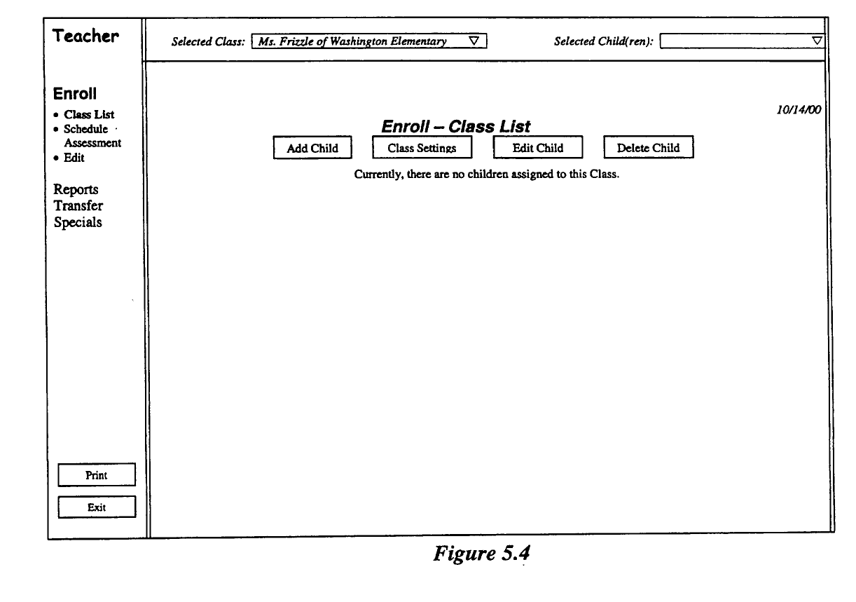

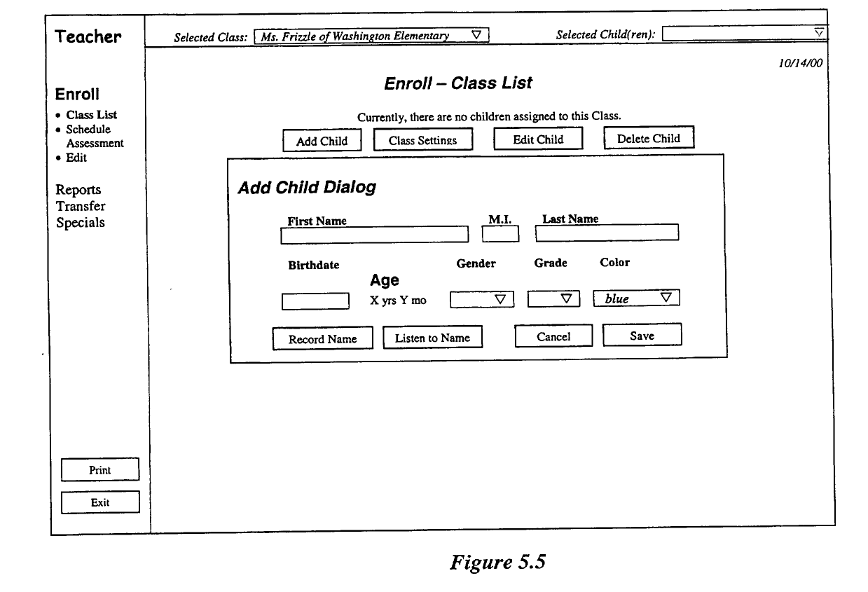

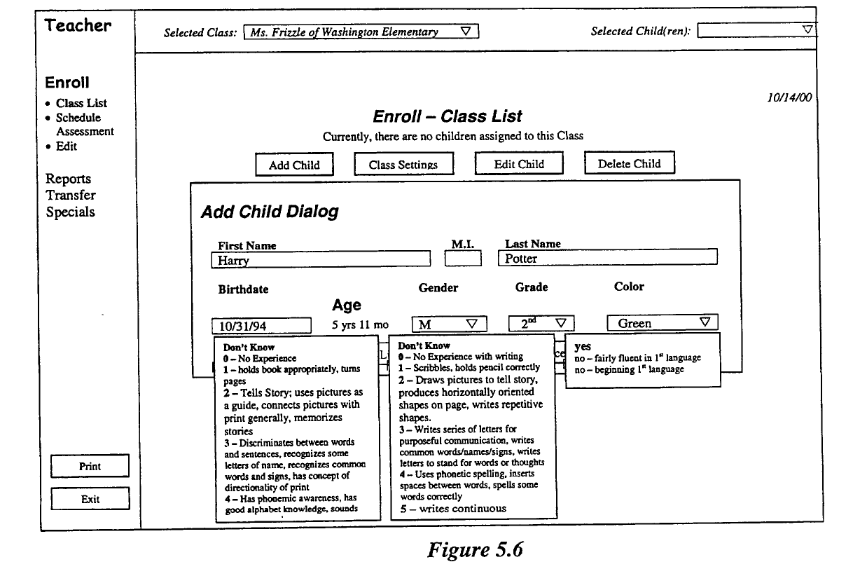

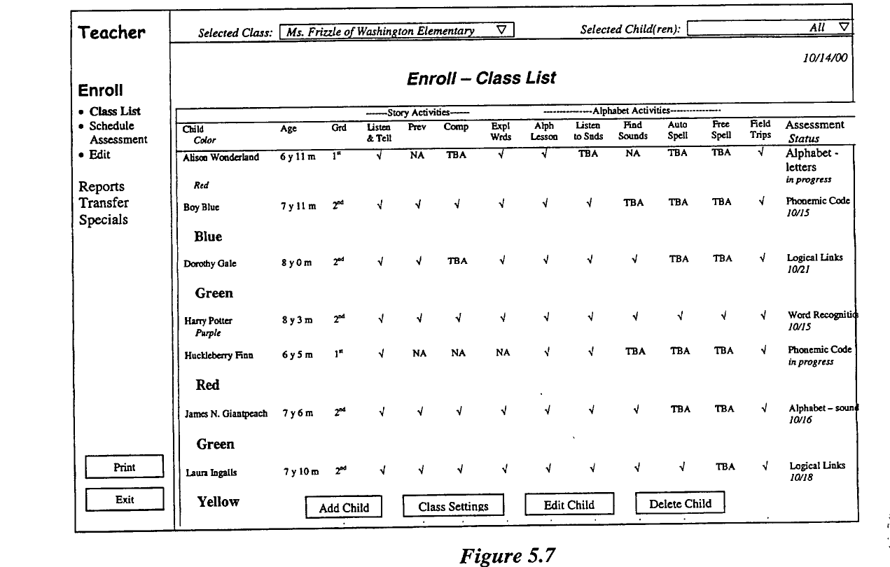

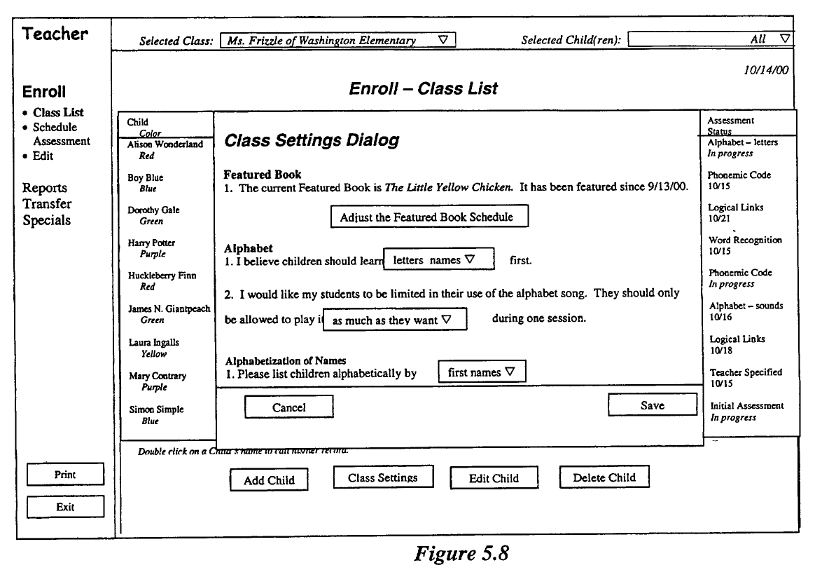

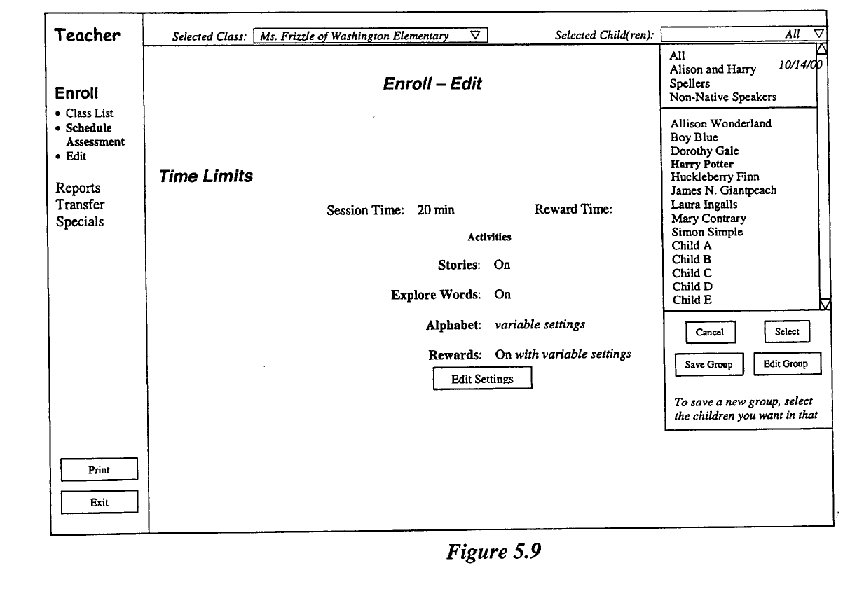

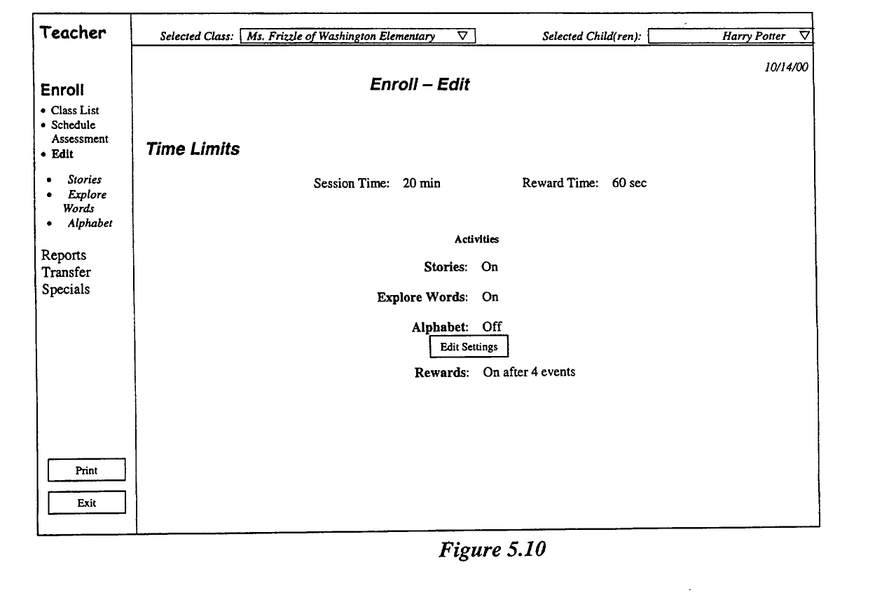

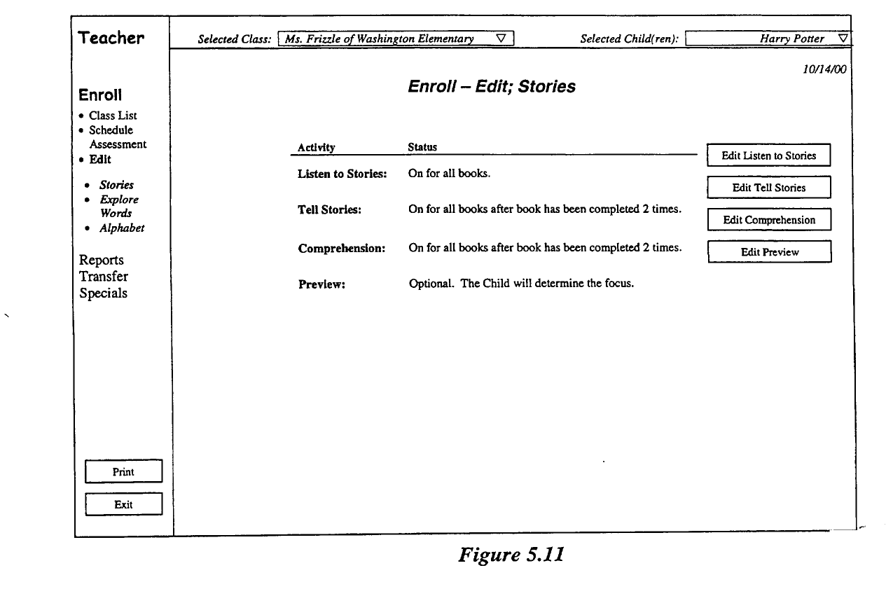

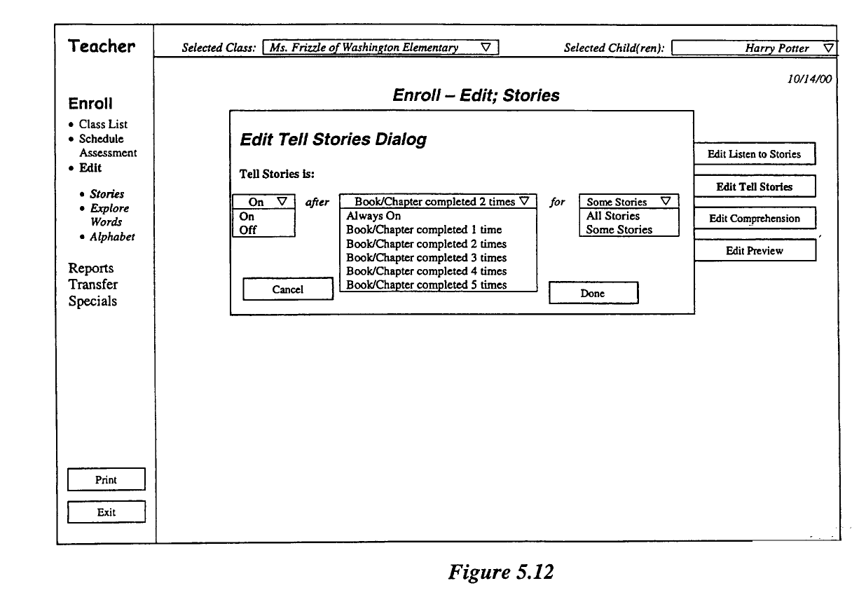

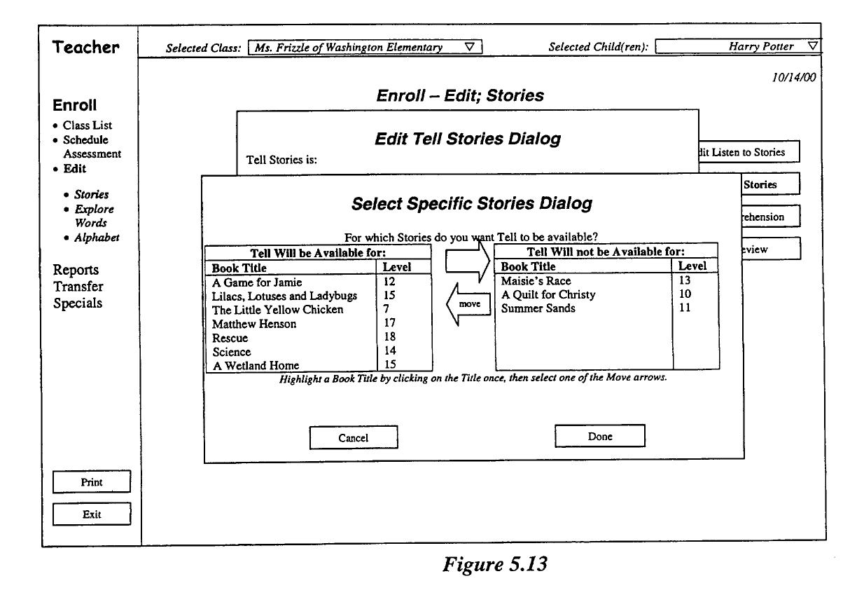

8.1 Teacher Flow Chart and Example Screen Displays

[See FIGS. 5.1 to 5.131]

9 SPEC E: Teacher Application—Reports as Related to Stories

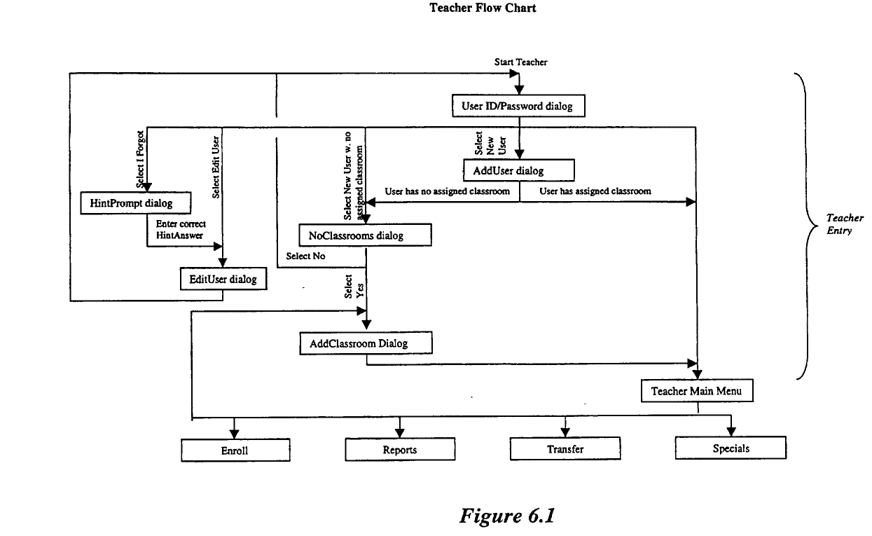

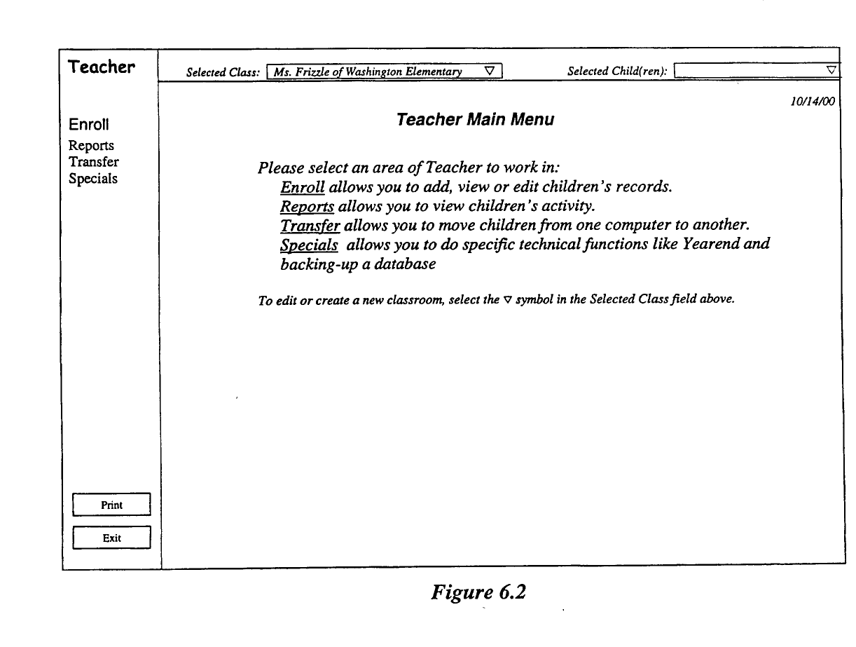

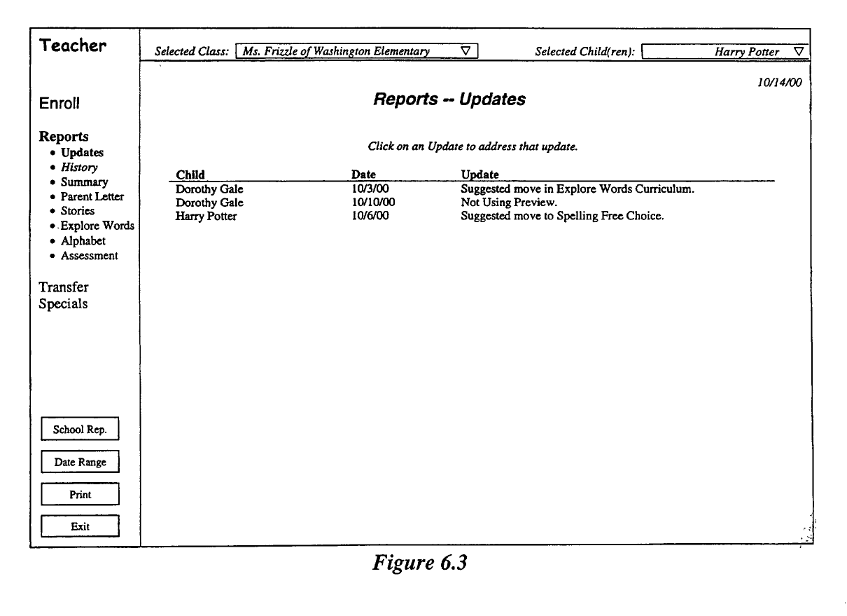

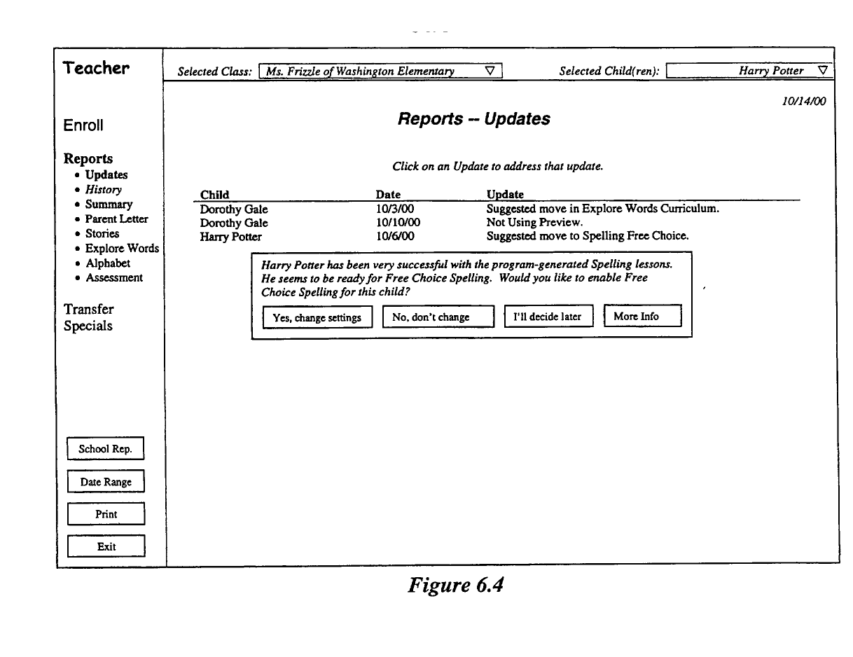

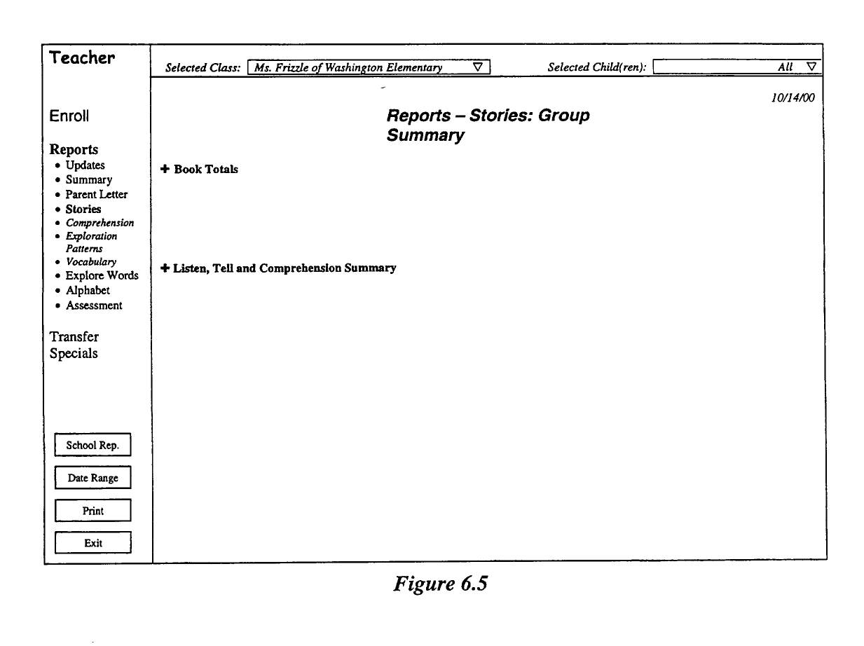

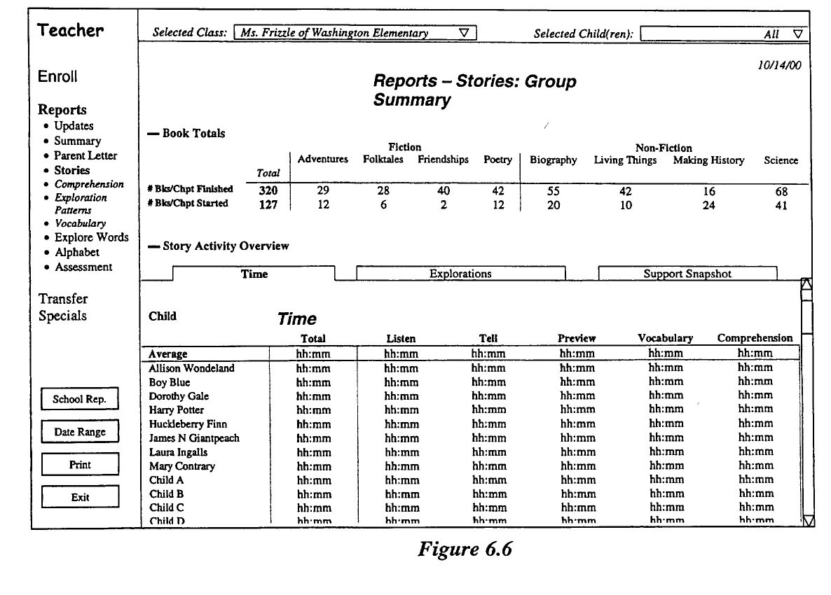

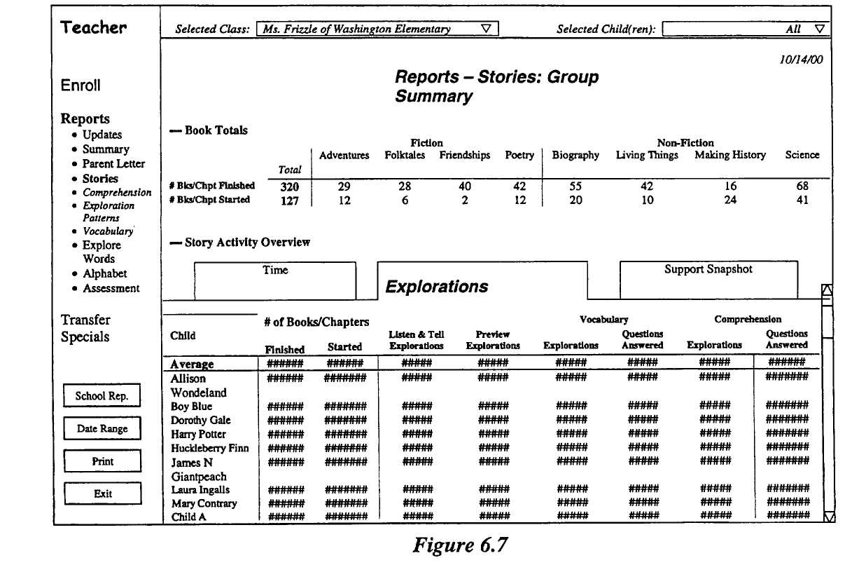

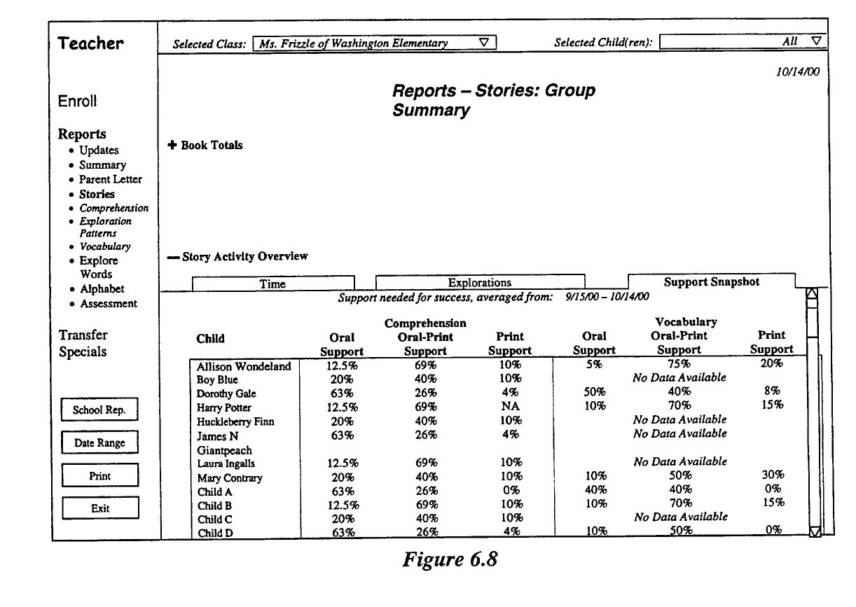

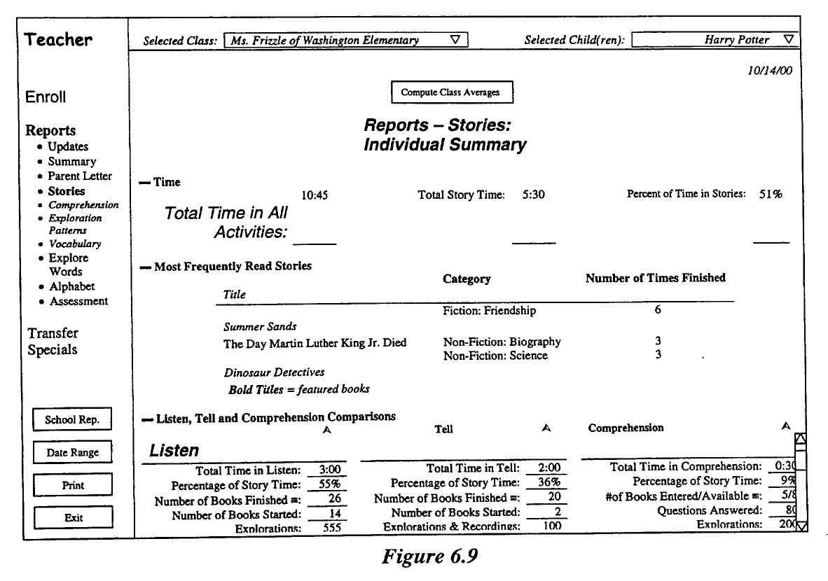

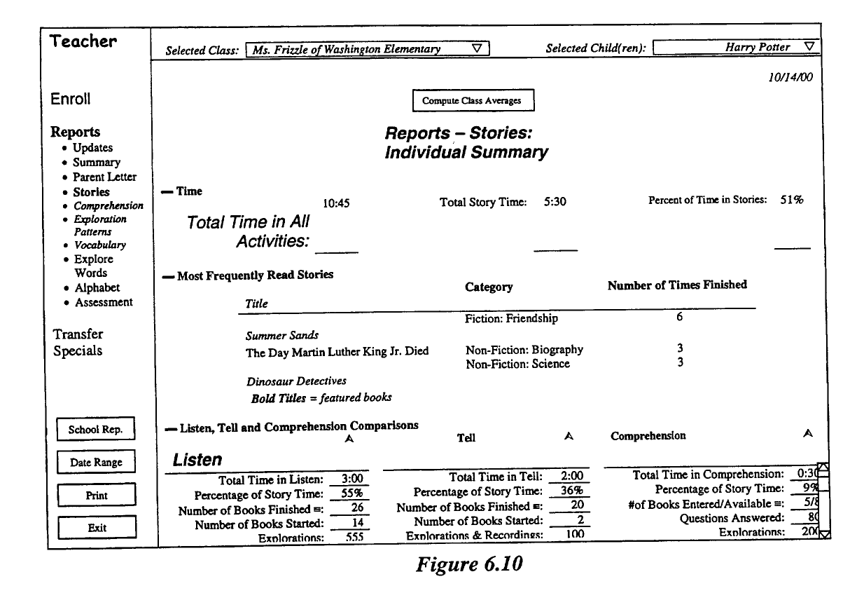

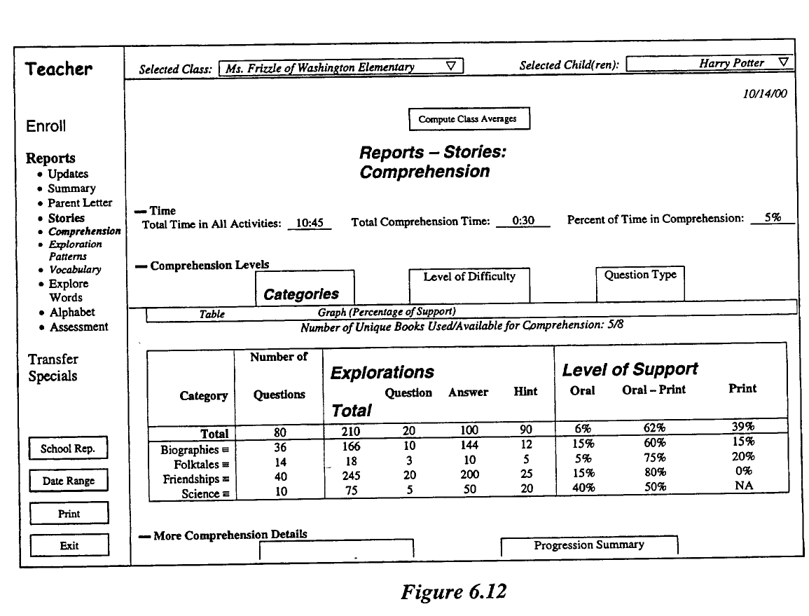

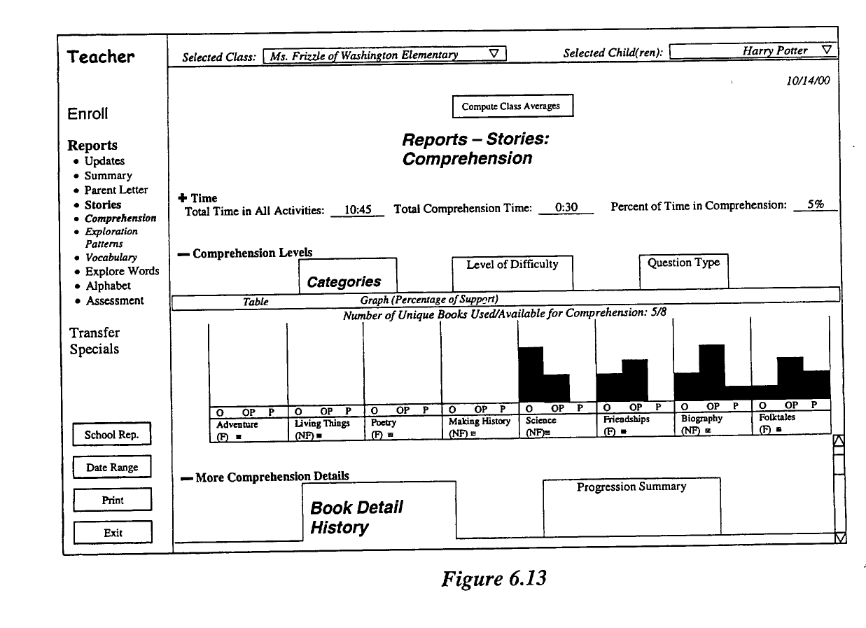

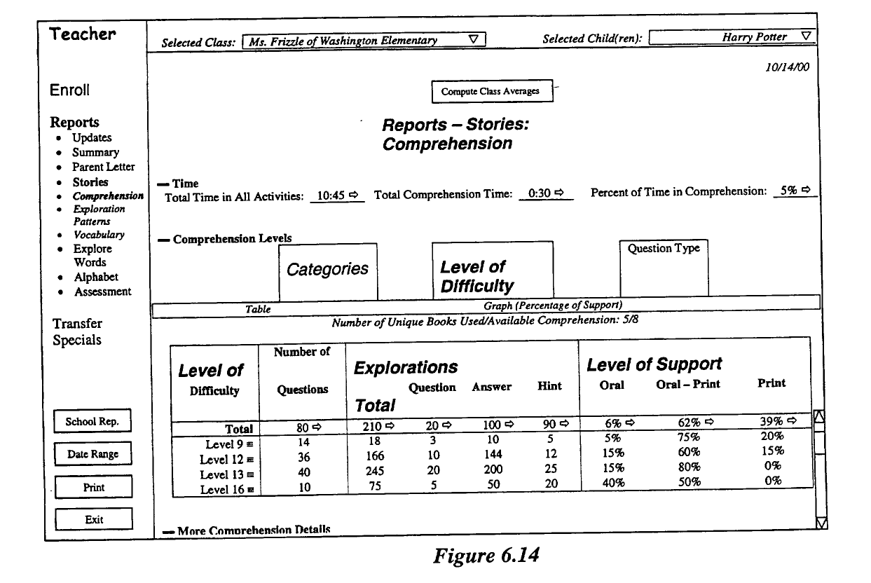

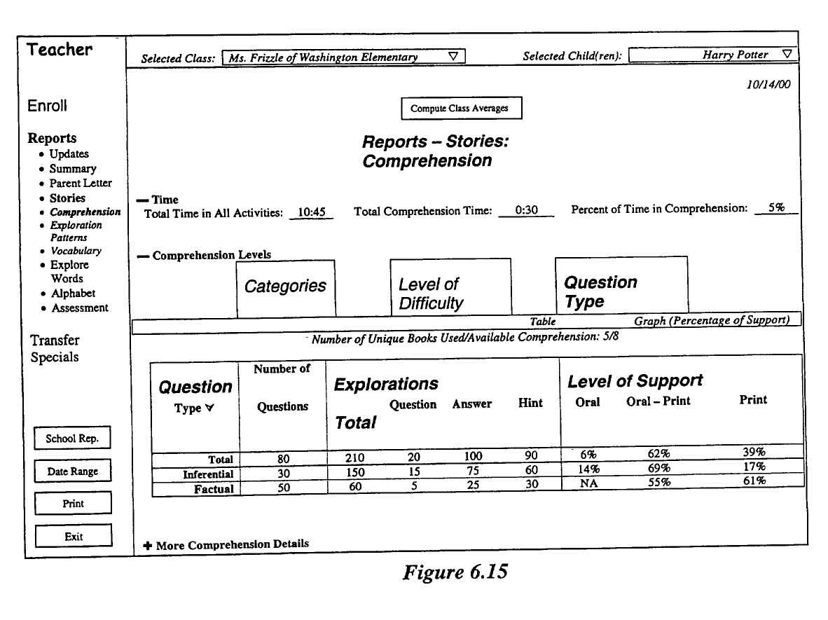

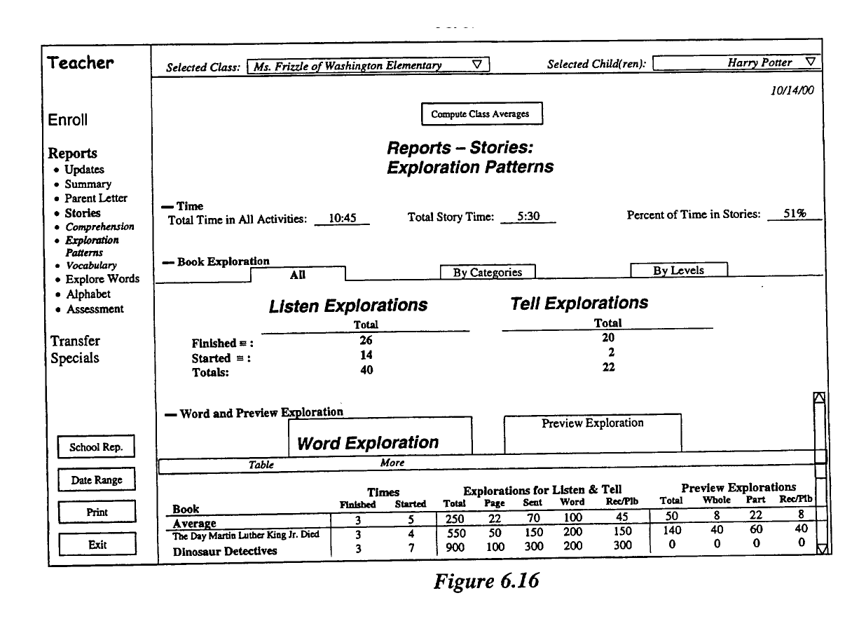

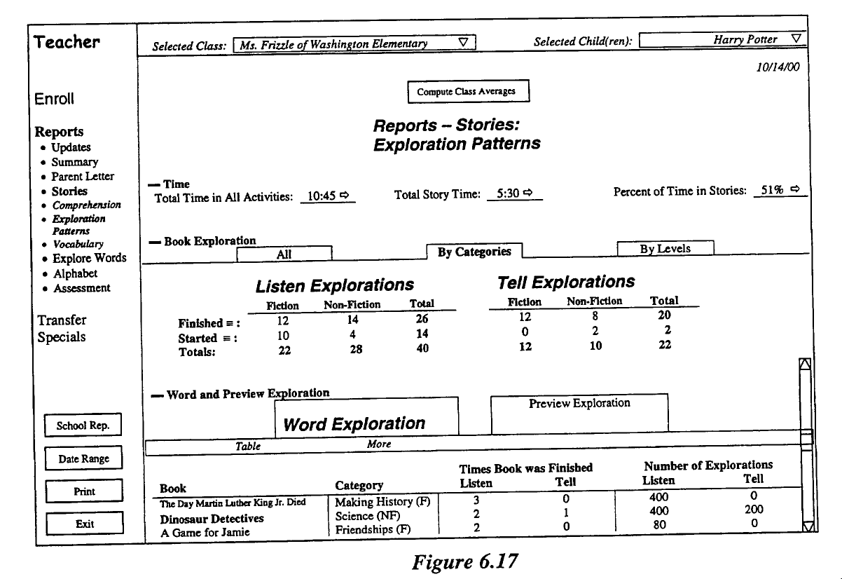

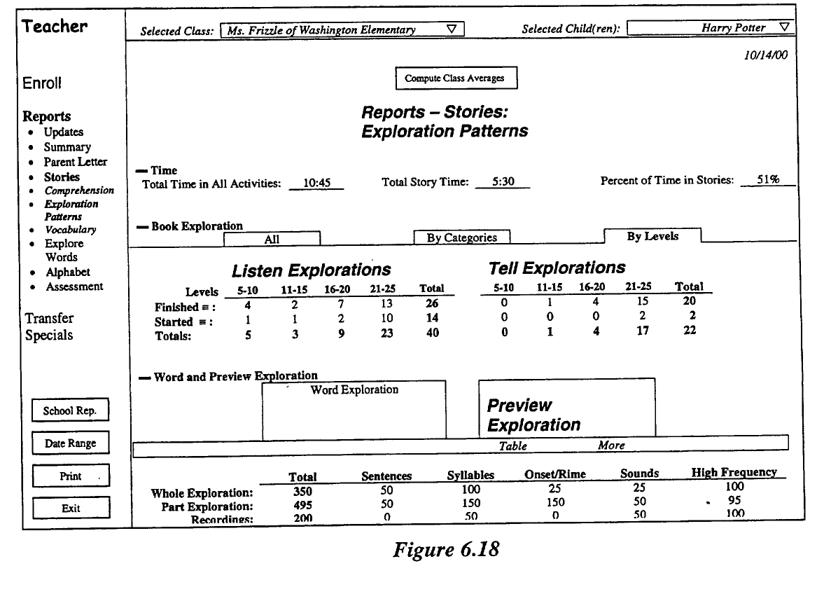

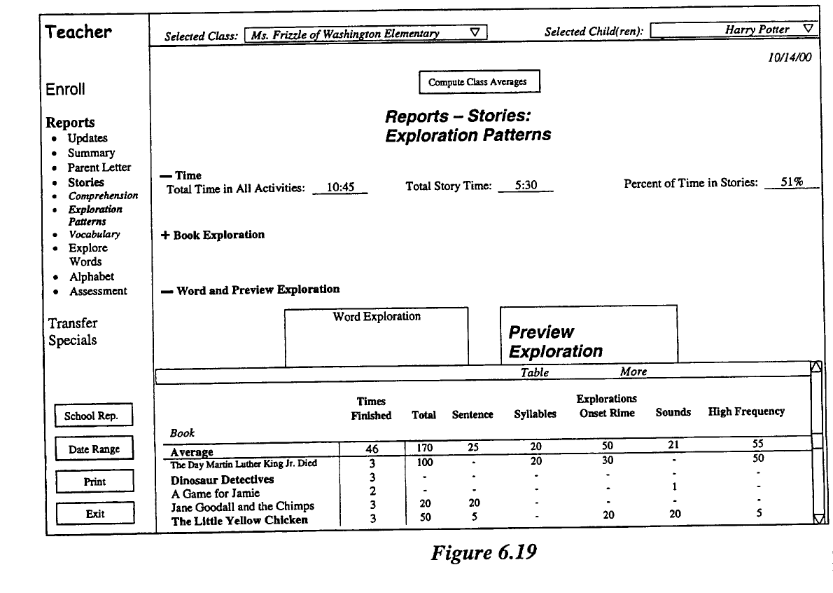

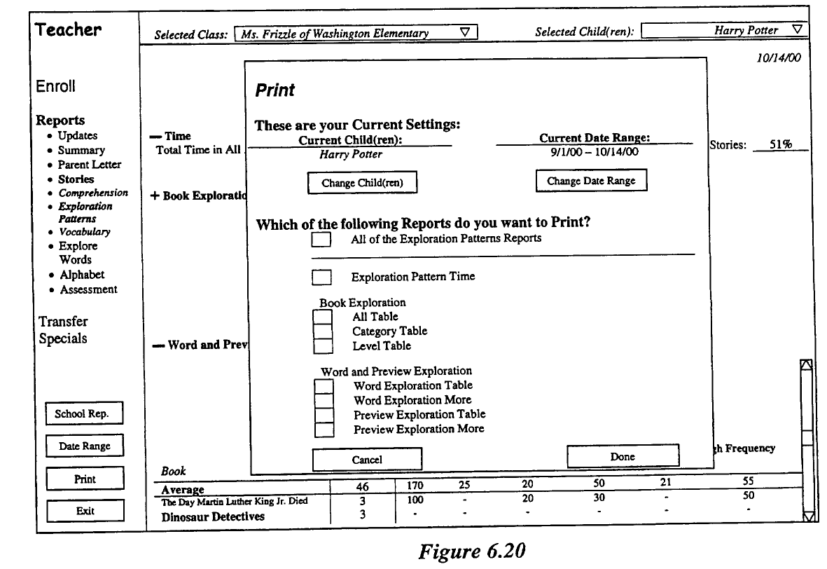

9.1 Teacher Flow Chart and Example Screeen Displays

[See FIGS. 6.1-6.20]

10 SPEC F: Entry and Exit Sequences Specification

10.1 Definitions

Entry Sequence—a series of screens which the teacher and child must navigate to start a child's Session. Screens included are the Classroom Selection screen, Color Selection screen, Name Selection screen.

Exit Sequence—a series of screens that appear at the end of a child's turn. Screens included are the Your Time Is Up window, Headphones window, So Long screen.

[see FIG. 7.1]

FIG. 7.2 illustrates an exemplary initial screen display, such as has been previously described.

10.1.1 What is the Initial Functionality of the Activity Selection Screen?

Visual Elements:

The Background and Child's Name will appear. At the same time, if any of the following Activities are Enabled, their corresponding buttons/areas will appear:

Stories (Listen, Tell and/or Comprehension)—Bookshelf is filled with books.

Explore Words—Easel appears

Alphabet—Alphabet Frieze appears

Rewards—Backpack appears

Note that Explore words will not appear even if it is enabled IF the child has NOT completed the Initial Assessment. As soon as the Initial Assessment is complete, the Explore Words area will appear if it is Enabled.

Furthermore, if the child's NumberofFieldTripsEarned tally >1 and the Rewards activity is Enabled, the Reward button will appear.

10.1.2 What is the Normal Functionality of the Activity Selection Screen?

Stories button—selecting the Stories button will briefly change the button to InUse and then take the child to the Story Theme Selection screen.

Explore Words button—selecting the Explore Words button will briefly change the button to InUse and then take the child to the appropriate Explore Words Lesson screen.

Alphabet button—selecting the Alphabet button will briefly change the button to InUse and then take the child to the Alphabet Menu screen.

Reward button—selecting the Reward button will briefly change the button to InUse and then take the child to the Reward Choice screen.

11 SPEC G—Database Example

As described earlier, FIGS. 8.1.1 to 8.4.2 illustrate an example of one database that could be used with this embodiment. Additional information about the database is set forth below.

The list below is basically organized into 5 groups, as referenced in the Database API document: Static Data, Student Settings, Student State, and Student Data. Some tables aren't listed in this document, so they appear in the most logical place below (and in FIGS. 8.1.1-8.4.2).

| Table Name | Description |
|---|---|
| Color | List of all colors (used for student |
| | backpack colors) |
| Activity | Activities students can do (Stories, |
| | Alphabet, Vocab . . . ) |
| StorySubActivity | Sub-Activities for Stories (Tell, Listen, |
| | Comp, Preview, Incomplete) |
| Clearance | Static settings for each clearance level |
| | (for users) |
| BookCategory | Adventure, Folklore, . . . There are 8 |
| | types for the 2nd grade. |
| Book | Static data for each book |
| Chapter | Indicates Chapter name, number, and to |
| | which book it belongs |
| CompQuestion | Indicates type of comp questions and to |
| | which book it belongs |
| District | District information—loaded into DB at |
| | install time? |
| School | School information—loaded into DB at |
| | install time? |
| Classroom | Classroom data as entered by teacher |
| FeaturedBookSchedule | The featured book for a classroom in a |
| | given date range |
| Group | List of all groups (grouping of students) |
| User | List of all users for the teacher application |
| ClassroomXUser | List of classrooms each user may access |
| Student | Static Setup Data for a student |
| Setting | A couple of settings for student setup |
| StudentXActivity | Activity configuration settings for a student |
| GroupXActivity | Same as above, but for a group |
| StudentXStorySubActivity | StorySubActivity configuration settings |
| | for a student |
| GroupXStorySubActivity | Same as above, but for a group |
| StudentXStorySubActivity | A list of books that a student has |
| XBook | access to for a given story sub activity— |
| | used in conjunction with the |
| | StudentXStorySubActivity table. |
| GroupXStorySubActivityX | Same as above, but for a group |
| Book | |
| StudentStateData | Progression history data for a student |
| | for each book/chapter |
| StudentXActivityData | Marks the begin and end time a student |
| | enters an activity |
| StudentXBookData | Marks the begin and end time a student |
| | enters a book/chapter |
| TellDatat | Data associated with the Tell sub-activity |
| | for a studen |
| ListenData | Data associated with the Listen sub- |
| | activity for a student |
| ComprehensionData | Data associated with the Comprehension |
| | sub-activity for a student |
| PreviewData | Data associated with the Preview sub- |
| | activity for a student |
| IncompleteData | If a student leaves a story sub-activity other |
| | than at “normal” times, an incomplete data |
| | record will record the reason for leaving |
| | along with the duration. |

12 OPTIONS AND ALTERNATIVES

It will be appreciated that the foregoing description of exemplary embodiments is for purposes of illustration only and not limitation to the invention. Those skilled in the art will appreciate how the invention can be applied in other embodiments and forms and obvious variations that can be used with the invention.

The foregoing description provides a broader overview with citations to Specs that give illustrations of specific implementations of certain aspects of a specific embodiment.

The specs include examples of specific definitions for an embodiment, including a definition of AVLs, the auditory and/or visual levels of support that can be made available for the various activities (see Specs A, B, and C). A variety of screen displays are shown to assist in an understanding of the functionality and options presented in this embodiment, including navigation around the program. Actual specific examples of AVLs for specific activities or trials are illustrated, including sets of AVLs, to illustrate how different levels of support can be built for certain specific instances. A variety of activities are illustrated to give a feel for some of the breadth of how the invention can be used. The rules of how a student progresses through activities, and how such relates to varying the AVLs depending on the student's performance are shown. Also, examples of the types of curriculum for the described embodiment and activities associated therewith are set forth. As stated earlier, this illustrates how specific learning programs can be built according the methodology and structure of the present invention.

As can be appreciated, modifications obvious to those skilled in the art are included within the invention, which is described by the appended claims. As one example, the number of trials or questions can be varied. Likewise, the number of levels of support can be varied. The numbers can be increased or decreased as deemed appropriate. In some parts of the specifications, variables such as these are noted.

As is explained, this embodiment uses the varying levels of support for different types of instructional functions. One being learning tasks, and the level of difficulty of learning tasks, e.g., the comprehension questions can be made more difficult as the student progresses. Another is the skills of the students, e.g., the types of skills presented to the student can be progressed as the student's understanding of each skill progresses. Different examples are set forth in the specifications.

Furthermore, the exemplary embodiment is focused upon language skills. As can be appreciated, the invention has applicability to other subjects or learning or instructional activities.

Rewards—Rewards optionally granted to students can consist of games (e.g. memory and ordering games). Data can be saved from the games to give other or additional intelligence about the student e.g. how the student learns or memorizes?

What is claimed is:

1. A method of instruction comprising:
(a) pre-designing a learning task and/or skill level for a student;
(b) pre-designing a set of support related to the learning task or skill level;
(c) presenting the learning task or skill level to a student;
(d) presenting to the student support from the pre-designed set of support;
(e) adjusting the support presented to the student based on responses to the learning task or skill level from the student.

2. The method of claim 1 wherein the instruction is performed on an electronic device with a user input.

3. The method of claim 2 wherein the electronic device includes a visual display.

4. The method of claim 2 wherein the electronic device includes a speaker.

5. The method of claim 2 wherein the electronic device is a computer.

6. The method of claim 1 wherein the student is a elementary school level student.

7. The method of claim 12 wherein the student is a kindergarten through second grade level student.

8. The method of claim 1 wherein the learning task or skill level is related to language.

9. The method of claim 6 wherein the learning task is related to reading.

10. The method of claim 6 wherein the learning task is related to reading comprehension.

11. The method of claim 6 wherein the skill level is related to words and parts of words.

12. The method of claim 6 wherein the learning task is related to learning spoken language.

13. The method of claim 6 wherein the learning task is related to learning written language.

14. The method of claim 1 wherein the learning task or skill level is a part of a curriculum.

15. The method of claim 14 wherein the curriculum relates to language.

16. The method of claim 15 wherein the curriculum relating to language includes one or more of written or spoken language.

17. The method of claim 16 wherein the curriculum relating to language includes one or more of reading, spelling, alphabetic, phonetic awareness, phonological awareness, phonics, vocabulary, and comprehension tasks.

18. The method of claim 1 wherein the curriculum comprises one or more activities.

19. The method of claim 18 wherein an activity comprises one or more student tasks.

20. The method of claim 19 wherein a student task comprises a question.

21. The method of claim 19 wherein the student task comprises a matching task.

22. The method of claim 19 wherein the student task comprises a recognition task.

23. The method of claim 19 wherein the student task comprises a comparison or sequential task.

24. The method of claim 1 wherein the learning task or skill level has varying levels of difficulty.

25. The method of claim 24 wherein support is pre-designed for each level of difficulty of the learning task or skill level.

26. The method of claim 1 wherein the set of support comprises sensory information.

27. The method of claim 26 wherein the sensory information is presentable in audible or visual format.

28. The method of claim 27 wherein the visual format comprises one or more of pictorial or text information.

29. The method of claim 1 wherein the set of support comprises a plurality of audio-visual (AV) levels.

30. The method of claim 29 wherein the plurality of AV levels comprises levels of differing amounts of information.

31. The method of claim 30 wherein the differing amounts of information comprise a range between more information relating to the learning task and less information.

32. The method of claim 31 wherein the plurality of AV levels comprise a hierarchy of decreasing levels of support.

33. The method of claim 1 wherein the set of support comprises multimedia formats.

34. The method of claim 33 wherein the multimedia formats comprise information adapted for presentation in auditory format, information adapted for presentation in pictorial format, and information adapted for presentation in text format.

35. The method of claim 1 wherein the set of support comprises a plurality of support options, each support option comprising one or more multimedia formats.

36. The method of claim 35 wherein the support options are one of information adapted for presentation in auditory format, information adapted for presentation in pictorial format, and information adapted for presentation in text format

37. The method of claim 1 wherein the set of support for a learning task comprises a plurality of AV levels.

38. The method of claim 37 wherein each AV level 32 wherein each option comprises an AV level.

39. The method of claim 38 wherein each set of support for each learning task or skill level comprises a set of AV levels., the step of adjusting the support adapted to promote successful completion of the learning task or skill level by the student.

40. The method of claim 32 wherein the step of adjusting changes the AV level over the range of AV levels.

41. The method of claim 40 wherein the AV level is left the same or adjusted up in the range upon the student achieving a pre-determined level of performance with responses, and is adjusted down in the range or left the same if the pre-determined level of performance with responses is not met.

42. The method of claim 41 wherein the adjusting is sequential one AV level at a time.

43. The method of claim 41 wherein the amount of adjusting in the range is adjustable.

44. The method of claim 41 wherein the AV level is adjusted up the range the more successful the student's responses are, wherein the higher up the range, the less the available support.

45. The method of claim 44 wherein the learning task is reading comprehension, the AV levels comprise audio, pictorial, and text information, and the higher up the range of AV levels comprises removing audio and/or pictorial information.

46. The method of claim 44 wherein the learning task or skill level relates to written language, the AV levels comprise audio, pictorial, and text information, and the higher up the range of AV levels comprises removing audio information.

47. The method of claim 1 wherein the adjusting is automatic.

48. The method of claim 1 further comprising storing the student responses.

49. The method of claim 1 further comprising assessing the student's performance by identifying the level of support used by the student.

50. The method of claim 47 further comprising assessing the student's performance by storing and reviewing the student's responses.

51. The method of claim 48 wherein the assessment is used to automatically set a subsequent learning task and/or skill level and/or level of support for the learning task.

52. The method of claim 48 wherein the stored responses are accessible by an instructor for evaluation.

53. The method of claim 1 further comprising creating a report from the student responses.

54. An apparatus for facilitating a learning task for a student comprising:
(a) a computer;
(b) the computer including a display, and processor, and a user input component;
(c) the computer including memory medium;
(d) software operatively installed on the memory medium;
(e) the software including a pre-designed learning task and/or skill level for a student;
(f) a database stored on the memory medium;
(g) the database including a pre-designed set of support and set of skills related to the learning task and/or skill level;
(f) the software adapted to:
(f1) present the learning task and/or skill level to a student on the display;
(f2) present on the display to the student support from the pre-designed set of support;
(f3) adjust the support presented on the display to the student based on responses to the learning task or skill level from the student;
(g) store in a database the student's responses.

55. The apparatus of claim 54 wherein the pre-designed learning task or skill level is a part of a curriculum.

56. The apparatus of claim 55 wherein the curriculum relates to language.

57. The apparatus of claim 56 wherein the curriculum relates to written and/or oral language skills.

58. The apparatus of claim 54 wherein the set of support comprises various levels of audio and/or visual information.

59. The apparatus of claim 58 wherein the support is adjusted to provide less audio and/or visual information upon the responses exceeding a pre-determined threshold.

60. The apparatus of claim 58 wherein the support is adjusted to provide more audio and/or visual information upon the responses not meeting a pre-determined threshold.

61. The apparatus of claim 60 further comprising automatically adjusting the support based on an assessment of the responses.

62. An apparatus for automated instruction of students comprising:
(a) a computerized device with a visual display;
(b) a first database comprising audio and/or visual content adapted for display to a student;
(c) a second database comprising responses of a student to learning tasks and/or skill levels;
(d) an executable program that interacts with the first and second databases, the program adapted to present a learning task or skill level in association to a variable amount of audio and/or visual support content and requiring a response from the student;
(e) the program assessing the responses in the second database and instructing which learning task or skill level and amount of support to display to the student.

63. The apparatus of claim 62 wherein the program decreases the amount of support displayed to the student if the responses exceed a pre-determined criteria.

64. A method of instructing a student comprising:
(a) presenting to a student a first learning activity or skill level;
(b) assessing performance of the student in the first learning activity or skill level based on responses to related to the first learning activity or skill level;
(c) identifying the student's level of performance relative the first learning activity or skill level;
(d) informing a second learning activity or skill level of the student's level of performance relative the first learning activity or skill level
(e) deciding if the second learning activity or skill level should be altered.

65. The method of claim 64 wherein the skill level comprises decoding of language.

66. A method of instructing comprising:
(a) presenting a learning task or skill level to a student;
(b) assessing the student's response to a task by evaluating the amount of support given the student regarding the task;
(c) progressing or regressing the student based on monitoring the level of support needed for the student to successfully complete the learning task or skill level.
